(19) United States
(12) Patent Application Publication
(10) Pub. No.: US 2011/0307242 A1
(43) Pub. Date: Dec. 15, 2011

(54) Method for realtime spoken natural language translation and apparatus therefor

(76) Inventor: Mohammad Munwar Alibaig, Ongole Andra Pradesh (IN)

(21) Appl. No.: 13/137,499

(22) Filed: Aug. 22, 2011

Related U.S. Application Data
(63) Continuation of application No. 12/128,248, filed on May 28, 2008, now abandoned.
(60) Provisional application No. 60/941,079, filed on May 31, 2007.

(51) Int. Cl. G06F 17/28

(52) U.S. Cl. 704/3

(57) ABSTRACT

A method and apparatus for performing real time automatic translation of the spoken language are provided. A spoken language input is received at one end comprising at least one source language and delivered at other end comprising at least one target language using natural language processing technology and language translation processing technology. The spoken language input comprises voice, words, sentences, accent, phrases, and pronunciation to communicate from one user to the other user. Delivered spoken language input goes through disintegration process performed by natural language disintegration technology and encoded into a digitized global source disintegrated language format at one end for target output language translation. The encoded disintegrated digitized global source language format is received by other end and decoded into integrated digitized global target language format which goes through further integration decoding process performed by natural language integration technology and translated into spoken language output comprising at least one target language at other end.

This is a Continuation of application Ser. No. 12/128,248 filed May 28, 2008, which claims the benefit of U.S. Provisional Application No. 60/941,079 filed May 31, 2007. The disclosure of the prior applications is hereby incorporated by reference herein in its entirety.

### BACKGROUND

1. Technical Field of the Invention

The present invention relates to real time automatic translation of spoken language and more particularly, to electronic communication with real time automatic translation of spoken language.

2. Background of the Invention

As is commonly appreciated, verbal communication as compared to written communication is the most natural, efficient, expressive and predominant mode of communicating information, intentions, moods and wishes between two or more users. To explain the expression “User,” throughout this disclosure a “User” shall be construed to include both an originator of verbal communication and recipient thereof regardless of whether the communication is generated or received by human and/or any other source/mean including, but not limited to, artificial sources/means. Further, regardless of the origin and/or the intended recipient, verbal communication enable originator and the recipient to quickly and efficiently communicate, provided that both users are fluent or at least well conversant in the same language/dialect.

Speakers of different languages/dialects, however, face a formidable problem in that they cannot efficiently and effectively communicate due to the language barrier. The language barrier may arise in many situations, such as trade or business negotiations with business people of foreign nationalities, or conversation with foreign nationals regarding everyday matters. Today when the world has shrunk into a Global Village, with the advent of the global economy, the World Wide Web, global telephone/mobile communication services and a lot more, the opportunity and need for persons who are fluent in different languages and dialects to communicate verbally has increased tremendously. Accordingly, the interaction among people having different language/dialect became possible with the help of human interpreters who used to be well versed with more than one language/dialect. However, it is not always cost effective for individuals to avail the services of interpreters. Moreover, language translation by human interpreters is a time consuming process.

Further, there are computer programs that can transcribe spoken languages into written language and vice versa, and computer programs that can translate from one language to another. These complex programs are, however, prone to errors. In particular, such programs are prone to failures to convey the efficient and intended meaning. The failure may be due to several factors, such as the inability to recognize homophones, words having multiple meanings, or the use of jargons or slangs.

Furthermore, there are typical language translation systems and devices which function by using natural language processing. Such natural language processing systems or devices use considerable knowledge and pre-fed limited information about the structure of the language, including what the words are, how they combine to form sentences, what the words mean, and how word meanings contribute to sentence meanings. More particularly, aforesaid systems and devices are concerned with the attempt to recognize a large pattern or sentence by disintegrating it into small sub-patterns according to grammatical and linguistic rules. Until recently, however, natural language processing systems and devices have not been accurate, quick or efficient enough to support useful applications in the field of language translation, particularly in the field of spoken language translation. For instance, with spoken input the system has to deal with uncertainty. In written language the system knows exactly what words are to be processed. With spoken language it only has a guess at what was said. In addition, spoken languages are structurally quite different than written language. In fact, sometimes a transcript of perfectly understandable speech is not comprehensive enough when read. Accordingly, the natural language processing systems and devices are infested with the problem of distortion of delivered messages at the recipient end if there is even a slight deviation of accent of speaker/originator. Moreover, the currently available spoken language translation systems and devices do not facilitate to translate complex languages/dialects like Chinese, Japanese, etc., which use diagrammatical script for textual representation and unscripted languages.

As a result, a need has arisen for a system and method for real time automatic language translation and communication which accept natural fluent speech input one language and provides simultaneously an accurate near real-time natural fluent speech in another language. Furthermore, there is a need for a communication device capable of real time automatic language translation and communication thereof.

### SUMMARY OF THE INVENTION

A method and apparatus for performing real time automatic translation of the spoken language are provided. A spoken language input is received at one end comprising at least one source language and delivered at other end comprising at least one target language using natural language processing technology and language translation processing technology. The spoken language input comprises voice, words, sentences, accent, phrases, pronunciation etc., to communicate from one user to the other user. The source spoken language input goes through disintegration process performed by natural language disintegration technology and encoded into a digitized global source disintegrated language format at one end for target output language translation. The encoded disintegrated digitized global source language format is received by other end and decoded into integrated digitized global target language format which goes through further integration decoding process performed by natural language integration technology and translated into spoken language output comprising at least one target language at other end.

It is one object of this invention to perform automatic translation of the source input spoken language into output target language.

It is another object of this invention to perform such automatic translation of the source input spoken language into output target language instantly with real-time experience of live communication.

It is yet another object of this invention to perform automatic translation of the input source spoken language into output target language by creating a common language code (Global Language Format), which is capable of translating any language of the world thereby removing altogether the language barrier having communication between different users in different languages/dialects.

It is yet another object of this invention to receive the source input language at one end and translate the same in other target output language at the other end in the natural voice of the users with the required and exact modulated accent of such users for such output language.

It is yet another object of this invention to convey the mood, emotions, and sentiments attached with the spoken speech of a user in one language from one end to the other end in the same manner and with the same effect after translating that language in other language. The objects herein for the claimed subject matter are provided to introduce a selection of concepts in a simplified form that are further described below in the detailed description. These objects are not intended to identify key features or essential features of the claimed subject matter, nor are these intended to be used as an aid in determining the scope of the claimed subject matter. The claimed subject matter is not limited to implementations that solve any or all disadvantages noted in the background.

According to the first aspect of the present invention there is provided a method for performing real time automatic translation of spoken natural language, comprising: receiving at least one speech input comprising at least one source language; recognizing at least one source expression of the at least one source language; translating the recognized at least one source expression from the at least one source language to at least one target language wherein translating comprising: processing the recognized at least one source expression through disintegration processing technology chip (Integrated Chip) at one end; disintegrating the recognized at least one source expression into at least twelve encoded language factors at one end; transferring the twelve encoded language factors to Internal Micro Processor for at least five stages internal disintegration valuation processing performed by processors of Internal Micro Processor at one end; generating the global language disintegration format at one end; performing source language translation to target language whereby global language disintegrated format converted into global language integrated format at other end; transferring the global language integrated format to Internal Micro Processor for at least five stages internal integration valuation processing performed by processors of Internal Micro Processor at other end; integrating the recognized at least one target expression into at least twelve decoded language factors at other end; processing the twelve decoded language factors of recognized at least one target expression through integration processing technology chip (Integrated Chip) at other end; synthesizing at least one speech output from the translated at least one target language; and providing the at least one speech output.

In another aspect of the present invention, there is provided an apparatus for real time automatic translation of spoken natural language, comprising: at least one Integrated Chip and an Internal Micro Processor; an input coupled to the at least one Integrated Chip, the input capable of receiving speech signal comprising at least one source language, the at least one chip configured to translate the received speech signals by, recognizing at least one source expression of the at least one source language; processing the recognized at least one source expression through disintegration processing technology chip (Integrated Chip) at one end; disintegrating the recognized at least one source expression into at least twelve encoded language factors at one end; transferring the twelve encoded language factors to Internal Micro Processor for at least five stages internal disintegration valuation processing performed by processors of Internal Micro Processor at one end; generating the global language disintegration format at one end; performing source language translation to target language whereby global language disintegrated format converted into global language integrated format at other end; transferring the global language integrated format to Internal Micro Processor for at least five stages internal integration valuation processing performed by processors of Internal Micro Processor at other end; integrating the recognized at least one target expression into at least twelve decoded language factors at other end; processing the twelve decoded language factors of recognized at least one target expression through integration processing technology chip (Integrated Chip) at other end; synthesizing at least one speech output from the translated at least one target language; and an output coupled to the at least one Integrated Chip, the output capable of providing the synthesized at least one speech output.

Embodiments of the invention comprise an apparatus for communication that performs a method for spoken language translation. One such embodiment is a cellular telephone. The apparatus for communication may be self contained or not self-contained. Self-contained apparatus for communication embodiments include hardware and software for receiving a natural spoken language input, performing translation, performing speech synthesis on the translation, and outputting translated natural spoken language.

The novel and inventive features believed characteristics of the invention are set forth in the appended claims. The invention itself, however, as well as preferred modes of use, further objects and advantages thereof, will be best understood by reference to the following detailed description of an illustrative embodiment when read in conjunction with the accompanying drawings.

### BRIEF DESCRIPTION OF DRAWINGS

The present invention is illustrated by way of example and not limitation in the figures of the accompanying drawings, in which like references indicate similar elements and wherein:

FIGS. 1 and 1A illustrates a principle block diagram depicting the spoken language translation and communication system;

FIG. 2 illustrates a block diagram of input natural language disintegration technology at one end;

FIG. 2a illustrates an explanatory diagram depicting the disintegration of input natural language into basic processing factors—‘alphabet format’ performed by language disintegration processing technology according to an illustrative embodiment of the present invention;

FIG. 2aa illustrates an explanatory diagram depicting the disintegration of basic factors of alphabets into ‘encoded alphabet format’ performed by language disintegration programming technology according to an illustrative embodiment of the present invention;

FIG. 2b illustrates an explanatory diagram depicting the disintegration of input natural language into basic processing factors—‘word format’ performed by language disintegration processing technology according to an illustrative embodiment of the present invention;

FIG. 2bb illustrates an explanatory diagram depicting the disintegration of basic factors of words into ‘encoded word format’ performed by language disintegration programming technology according to an illustrative embodiment of the present invention;

FIG. 2c illustrates an explanatory diagram depicting the disintegration of input natural language into basic processing factors—‘sentence format’ performed by language disintegration processing technology according to an illustrative embodiment of the present invention;

FIG. 2cc illustrates an explanatory diagram depicting the disintegration of basic factors of sentence into ‘encoded sentence format’ performed by language disintegration programming technology according to an illustrative embodiment of the present invention;

FIG. 2d illustrates an explanatory diagram depicting the disintegration of input natural language into basic processing factors—‘meaning format’ performed by language disintegration processing technology according to an illustrative embodiment of the present invention;

FIG. 2dd illustrates an explanatory diagram depicting the disintegration of basic factors of meaning into ‘encoded meaning format’ performed by language disintegration programming technology according to an illustrative embodiment of the present invention;

FIG. 2e illustrates an explanatory diagram depicting the disintegration of input natural language into speech processing factors—‘vocabulary format’ performed by language disintegration processing technology according to an illustrative embodiment of the present invention;

FIG. 2ee illustrates an explanatory diagram depicting the disintegration of speech factors of vocabulary into ‘encoded vocabulary format’ performed by language disintegration programming technology according to an illustrative embodiment of the present invention;

FIG. 2f illustrates an explanatory diagram depicting the disintegration of input natural language into speech processing factors—‘accent format’ performed by language disintegration processing technology according to an illustrative embodiment of the present invention;

FIG. 2ff illustrates an explanatory diagram depicting the disintegration of speech factors of accent into ‘encoded accent format’ performed by language disintegration programming technology according to an illustrative embodiment of the present invention;

FIG. 2g illustrates an explanatory diagram depicting the disintegration of input natural language into speech processing factors—‘pronunciation format’ performed by language disintegration processing technology according to an illustrative embodiment of the present invention;

FIG. 2gg illustrates an explanatory diagram depicting the disintegration of speech factors of pronunciation into ‘encoded pronunciation format’ performed by language disintegration programming technology according to an illustrative embodiment of the present invention;

FIG. 2h illustrates an explanatory diagram depicting the disintegration of input natural language into speech processing factors—‘conversation format’ performed by language disintegration processing technology according to an illustrative embodiment of the present invention;

FIG. 2hh illustrates an explanatory diagram depicting the disintegration of speech factors of conversation into ‘encoded conversation format’ performed by language disintegration programming technology according to an illustrative embodiment of the present invention;

FIG. 2i illustrates an explanatory diagram depicting the disintegration of input natural language into operating supporting processing factors—‘application format’ performed by language disintegration processing technology according to an illustrative embodiment of the present invention;

FIG. 2ii illustrates an explanatory diagram depicting the disintegration of operating supporting factors of application into ‘encoded application format’ performed by language disintegration programming technology according to an illustrative embodiment of the present invention;

FIG. 2j illustrates an explanatory diagram depicting the disintegration of input natural language into operating supporting processing factors—‘operating system format’ performed by language disintegration processing technology according to an illustrative embodiment of the present invention;

FIG. 2jj illustrates an explanatory diagram depicting the disintegration of operating supporting factors of operating system into ‘encoded operating system format’ performed by language disintegration programming technology according to an illustrative embodiment of the present invention;

FIG. 2k illustrates an explanatory diagram depicting the disintegration of input natural language into operating supporting processing factors—‘search engine format’ performed by language disintegration processing technology according to an illustrative embodiment of the present invention;

FIG. 2kk illustrates an explanatory diagram depicting the disintegration of operating supporting factors of search engine into ‘encoded search engine format’ performed by language disintegration programming technology according to an illustrative embodiment of the present invention;

FIG. 2l illustrates an explanatory diagram depicting the disintegration of input natural language into operating supporting processing factors ‘colloquial language format’ performed by language disintegration processing technology according to an illustrative embodiment of the present invention;

FIG. 2ll illustrates an explanatory diagram depicting the disintegration of operating supporting factors of colloquial language into ‘encoded colloquial language format’ performed by language disintegration programming technology according to an illustrative embodiment of the present invention;

FIG. 2m illustrates an explanatory diagram depicting the disintegration of input natural language into primary processing factors ‘language chip format’, which is processed and programmed into ‘encoded language chip format’ performed by language disintegration processing and programming technology according to an illustrative embodiment of the present invention;

FIG. 2n illustrates an explanatory diagram depicting the disintegration of input natural language into primary processing factors ‘voice recognition chip format’, which is processed and programmed into ‘encoded voice recognition chip format’ performed by language disintegration processing and programming technology according to an illustrative embodiment of the present invention;

FIG. 2o illustrates an explanatory diagram depicting the disintegration of input natural language into primary processing factors ‘translating chip format’, which is processed and programmed into ‘encoded translating chip format’ performed by language disintegration processing and programming technology according to an illustrative embodiment of the present invention;

FIG. 2p illustrates an explanatory diagram depicting the disintegration of input natural language into primary processing factors ‘type of chip and technology format’, which is processed and programmed into ‘encoded type of chip and technology format’ performed by language disintegration processing and programming technology according to an illustrative embodiment of the present invention;

FIG. 2q illustrates an explanatory diagram depicting the disintegration of input natural language into primary processing factors ‘transfer chip format’, which is processed and programmed into ‘encoded transfer chip format’ performed by language disintegration processing and programming technology according to an illustrative embodiment of the present invention;

FIG. 3 illustrates a principle block diagram depicting the input natural language disintegration performed by Internal Micro Processor (IMP) Networking System;

FIG. 3a illustrates a block diagram of Internal Micro Processor (IMP) sub tools for disintegrated language factors of source spoken language input.

CHART A details the encoded values of the Internal Micro Processor (IMP) sub-tools disintegration valuation processors identified against the encoded global language disintegrated format as listed in Table II.

FIG. 4 illustrates a block diagram depicting the five stages internal disintegration valuation processing of language translating processors of Internal Micro Processor (IMP) for internal processing of the received output of the delivered natural language disintegrated factors into global language format for requested language translation at one end;

FIG. 4a illustrates an explanatory diagram depicting the first stage internal disintegration valuation processing of the received output of delivered natural language disintegrated factors in the form of ‘encoded language format’ performed by language translating processor I (disintegration devices of ‘language format’) of Internal Micro Processor (IMP) according to an embodiment of the present invention.

FIG. 4b illustrates an explanatory diagram depicting the second stage internal disintegration valuation processing of the received output of delivered natural language disintegrated factors in the form of ‘encoded language format’ performed by language translating processor II (coding process of ‘language format’) of Internal Micro Processor (IMP) according to an embodiment of the present invention.

FIG. 4c illustrates an explanatory diagram depicting the third stage internal disintegration processing valuation of the received output of delivered natural language disintegrated factors in the form of ‘encoded language format’ performed by language translating processor III (naming process of ‘language format’) of Internal Micro Processor (IMP) according to an embodiment of the present invention.

FIG. 4d illustrates an explanatory diagram depicting the fourth stage internal disintegration processing valuation of the received output of delivered natural language disintegrated factors in the form of ‘encoded language format’ performed by language translating processor IV (inter language processing of ‘language format’) of Internal Micro Processor (IMP) according to an embodiment of the present invention.

FIG. 4e illustrates an explanatory diagram depicting the fifth stage internal disintegration processing valuation of the received output of delivered natural language disintegrated factors in the form of ‘encoded language format’ performed by language translating processor V (encoded transmission of ‘language format’) of Internal Micro Processor (IMP) according to an embodiment of the present invention.

FIG. 5 illustrates a principle block diagram depicting the target output natural language integration performed by Internal Micro Processor (IMP) Networking System;

FIG. 5a illustrates a block diagram of Internal Micro Processor (IMP) sub tools for integrated language factors of target spoken language output.

CHART B details the encoded values of the Internal Micro Processor (IMP) sub-tools integration valuation processors identified against the decoded global language disintegrated format as listed in Table IV.

FIG. 6 illustrates a block diagram depicting the five stages internal integration valuation processing of language translating processors of Internal Micro Processor (IMP) for internal processing of the received input of the global language format into target spoken natural language integrated factors for requested language translation at the other end;

FIG. 6a illustrates an explanatory diagram depicting the first stage internal integration valuation processing of the received input of the received global language integrated factors in the form of ‘decoded language format’ performed by language translating processor I (decoded reception of ‘global language format’) of Internal Micro Processor (IMP) according to an embodiment of the present invention.

FIG. 6b illustrates an explanatory diagram depicting the second stage internal integration processing valuation of the received input of the received natural language integrated factors in the form of ‘decoded language format’ performed by language translating processor II (inter language processing of ‘global language format’) of Internal Micro Processor (IMP) according to an embodiment of the present invention.

FIG. 6c illustrates an explanatory diagram depicting the third stage internal integration processing valuation of the received input of the received natural language integrated factors in the form of ‘decoded language format’ performed by language translating processor III (renaming process of ‘global language format’) of Internal Micro Processor (IMP) according to an embodiment of the present invention.

FIG. 6d illustrates an explanatory diagram depicting the fourth stage internal integration processing valuation of the received input of the received natural language integrated factors in the form of ‘decoded language format’ performed by language translating processor IV (decoding process of ‘global language format’) of Internal Micro Processor (IMP) according to an embodiment of the present invention.

FIG. 6e illustrates an explanatory diagram depicting the fifth stage internal integration processing valuation of the received input of the received natural language integrated factors in the form of ‘decoded language format’ performed by language translating processor V (integration devices of ‘global language format’) of Internal Micro Processor (IMP) according to an embodiment of the present invention.

FIG. 7 illustrates a block diagram of target output natural language integration technology at the other end;

FIG. 7a illustrates an explanatory diagram depicting the integration of basic factors of alphabets into ‘decoded alphabet format’ performed by language integration programming technology according to an illustrative embodiment of the present invention.

FIG. 7aa illustrates an explanatory diagram depicting the integration of output natural language into basic processing factors—‘alphabet format’ performed by language integration processing technology according to an illustrative embodiment of the present invention;

FIG. 7b illustrates an explanatory diagram depicting the integration of basic factors of words into ‘decoded word format’ performed by language integration programming technology according to an illustrative embodiment of the present invention;

FIG. 7bb illustrates an explanatory diagram depicting the integration of output natural language into basic processing factors—‘word format’ performed by language integration processing technology according to an illustrative embodiment of the present invention;

FIG. 7c illustrates an explanatory diagram depicting the integration of basic factors of sentence into ‘decoded sentence format’ performed by language integration programming technology according to an illustrative embodiment of the present invention;

FIG. 7cc illustrates an explanatory diagram depicting the integration of output natural language into basic processing factors—‘sentence format’ performed by language integration processing technology according to an illustrative embodiment of the present invention;

FIG. 7d illustrates an explanatory diagram depicting the integration of basic factors of meaning into ‘decoded meaning format’ performed by language integration programming technology according to an illustrative embodiment of the present invention;

FIG. 7dd illustrates an explanatory diagram depicting the integration of output natural language into basic processing factors—‘meaning format’ performed by language integration processing technology according to an illustrative embodiment of the present invention;

FIG. 7e illustrates an explanatory diagram depicting the integration of speech factors of vocabulary into ‘decoded vocabulary format’ performed by language integration programming technology according to an illustrative embodiment of the present invention;

FIG. 7ee illustrates an explanatory diagram depicting the integration of output natural language into speech processing factors—‘vocabulary format’ performed by language integration processing technology according to an illustrative embodiment of the present invention;

FIG. 7f illustrates an explanatory diagram depicting the integration of speech factors of accent into ‘decoded accent format’ performed by language integration programming technology according to an illustrative embodiment of the present invention;

FIG. 7ff illustrates an explanatory diagram depicting the integration of output natural language into speech processing factors—‘accent format’ performed by language integration processing technology according to an illustrative embodiment of the present invention;

FIG. 7g illustrates an explanatory diagram depicting the integration of speech factors of pronunciation into ‘decoded pronunciation format’ performed by language integration programming technology according to an illustrative embodiment of the present invention;

FIG. 7gg illustrates an explanatory diagram depicting the integration of output natural language into speech processing factors—‘pronunciation format’ performed by language integration processing technology according to an illustrative embodiment of the present invention;

FIG. 7h illustrates an explanatory diagram depicting the integration of speech factors of conversation into ‘decoded conversation format’ performed by language integration programming technology according to an illustrative embodiment of the present invention;

FIG. 7hh illustrates an explanatory diagram depicting the integration of output natural language into speech processing factors—‘conversation format’ performed by using language integration processing technology according to an illustrative embodiment of the present invention;

FIG. 7i illustrates an explanatory diagram depicting the integration of operating supporting factors of application into ‘decoded application format’ performed by language integration programming technology according to an illustrative embodiment of the present invention;

FIG. 7ii illustrates an explanatory diagram depicting the integration of output natural language into operating supporting processing factors—‘application format’ performed by language integration processing technology according to an illustrative embodiment of the present invention;

FIG. 7j illustrates an explanatory diagram depicting the integration of operating supporting factors of operating system into ‘decoded operating system format’ performed by language integration programming technology according to an illustrative embodiment of the present invention;

FIG. 7jj illustrates an explanatory diagram depicting the integration of output natural language into operating supporting processing factors—‘operating system format’ performed by language integration processing technology according to an illustrative embodiment of the present invention;

FIG. 7k illustrates an explanatory diagram depicting the integration of operating supporting factors of search engine into ‘decoded search engine format’ performed by language integration programming technology according to an illustrative embodiment of the present invention;

FIG. 7kk illustrates an explanatory diagram depicting the integration of output natural language into operating supporting processing factors—‘search engine format’ performed by language integration processing technology according to an illustrative embodiment of the present invention;

FIG. 7l illustrates an explanatory diagram depicting the integration of operating supporting factors of colloquial language into ‘decoded colloquial format’ performed by language integration programming technology according to an illustrative embodiment of the present invention;

FIG. 7ll illustrates an explanatory diagram depicting the integration of output natural language into operating supporting processing factors—‘colloquial language format’ performed by language integration processing technology according to an illustrative embodiment of the present invention;

FIG. 7m illustrates an explanatory diagram depicting the integration of output natural language into primary processing factors ‘reception chip format’, which is processed and programmed into ‘decoded reception chip format’ performed by language integration processing and programming technology according to an illustrative embodiment of the present invention;

FIG. 7n illustrates an explanatory diagram depicting the integration of output natural language into primary processing factors ‘type of chip and technology format’, which is processed and programmed into ‘decoded type of chip and technology format’ performed by language integration processing and programming technology according to an illustrative embodiment of the present invention;

FIG. 7o illustrates an explanatory diagram depicting the integration of output natural language into primary processing factors ‘translating chip format’, which is processed and programmed into ‘decoded translating chip format’ performed by language integration processing and programming technology according to an illustrative embodiment of the present invention;

FIG. 7p illustrates an explanatory diagram depicting the integration of output natural language into primary processing factors ‘voice recognition chip format’, which is processed and programmed into ‘decoded voice recognition chip format’ performed by language integration processing and programming technology according to an illustrative embodiment of the present invention;

FIG. 7q illustrates an explanatory diagram depicting the integration of input natural language into primary processing factors ‘language chip format’, which is processed and programmed into ‘decoded language chip format’ performed by language disintegration processing and programming technology according to an illustrative embodiment of the present invention;

FIG. 8a illustrates an explanatory diagram of a multilingual language chip configured for natural language communication with maximum of four different languages interrelated to communicate simultaneously.

FIG. 8b illustrates an explanatory diagram of a selective language chip configured for natural language communication from one main language to any three different languages, one at a time.

FIG. 8c illustrates an explanatory diagram of a bilingual language chip configured for natural language communication between any two different languages simultaneously.

FIG. 8d illustrates an explanatory diagram of a lingual language chip configured for natural language communication from any one language to a chosen other language.

### DETAILED DESCRIPTION

A method and apparatus for performing real time automatic translation of the spoken language are provided. In the following description for purposes of explanation, numerous specific details are set forth in order to provide a thorough understanding of the present invention. It will be evident, however, to one skilled in the art that the present invention may be practiced without these specific details. The structures and devices are shown in block diagram form for a better and thorough understanding of the present invention. It is noted that experiments with the method and apparatus provided herein show significant speech translation improvements when compared to typical speech translation systems.

### Mode of Operation

### Internal Micro Processor (IMP) Disintegration Technology

The source natural language splits into twelve disintegrated factors by application of Language Disintegration Technology. The twelve disintegrated factors collectively transferred to Internal Micro Processor (IMP) and further processed by application of interrelated Natural Language Processing Technology (NLPT) and Language Translating Processing Technology (LTPT) to generate encoded digitized global source language disintegrated formats at one end of Internal Micro Processor (IMP). This digitized global source language disintegrated formats further transferred to other end of Internal Micro Processor (IMP) for Inter-Language Translation.

Natural Language Processing Technology (NLPT) converts the delivered language disintegrated factors into digital voice recognition processing format. Natural Language Processing Technology (NLPT) is designed for the systematic and synchronized application of five stages of Internal Micro Processor (IMP), viz.

i) Natural Language Processing;

ii) Speech Processing;

iii) Translation Processing;

iv) Transmission Processing; and

v) Digital Output of Language Translation Processing;

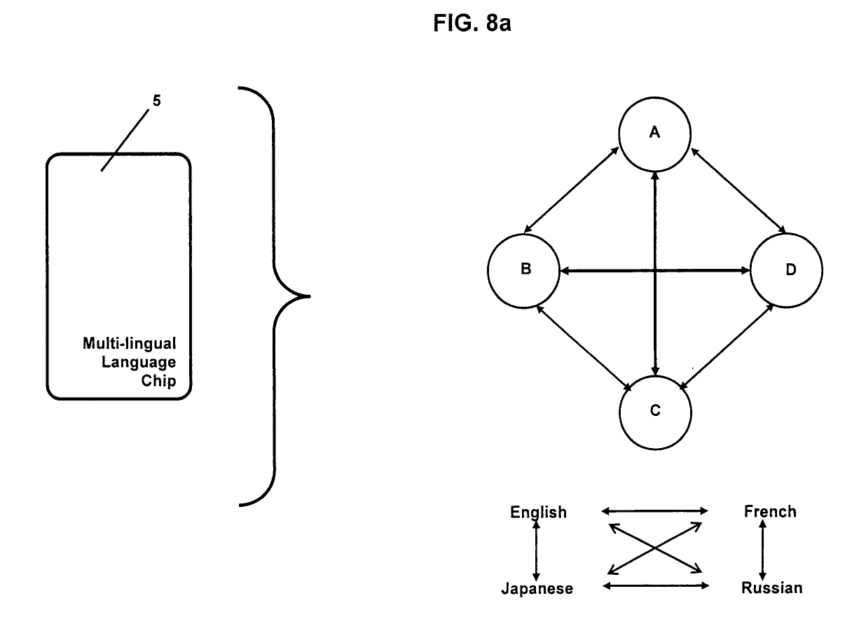

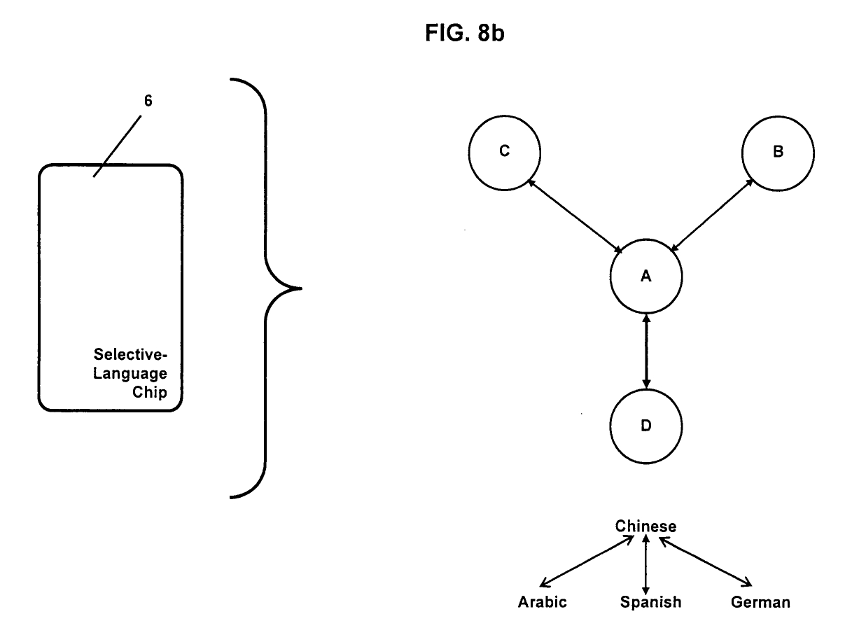

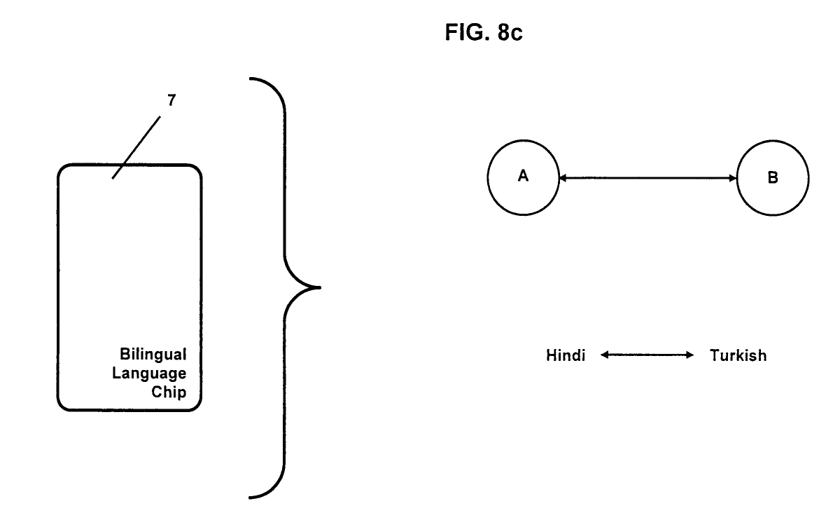

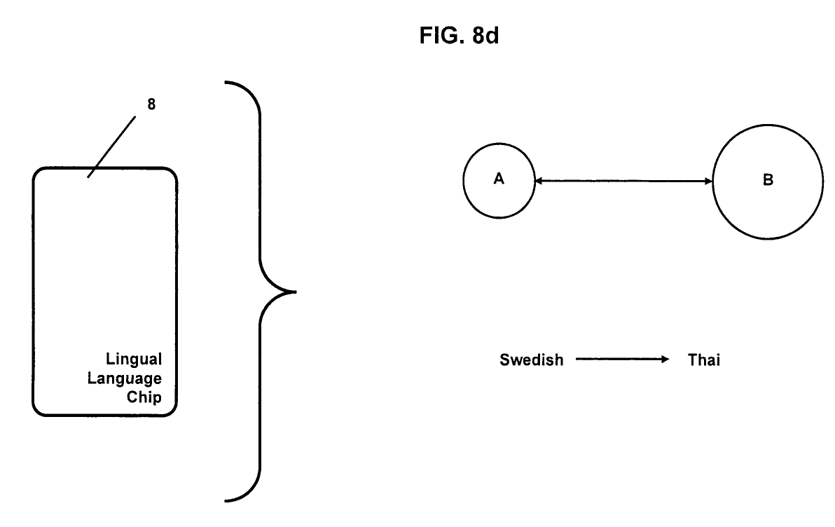

by synchronized application of different combination of Internal Micro Processor (IMP) sub-tools values.
1. NATURAL LANGUAGE PROCESSING TECHNOLOGY (NLPT): Voice Recognition System (VOS) processed through Natural Language Processing Technology (NLPT) for digital processing of language disintegration factors into language translating processors. Delivered language disintegrated factors processed through Voice Recognition System (VOS) appropriately programmed for digital Speech Processing of natural languages of the world. Language Translation Processing Technology (LTPT) consists of Digital Translation and Digital Transmission Programming formats for systematic processing of particular input source natural language translation of encoded end of Internal Micro Processor (IMP) disintegration process. The input source natural language processed through Voice Recognition System (VRS) forwarded simultaneously to Speech Processing Technology (SPT) for further commands.
2. SPEECH PROCESSING TECHNOLOGY (SPT): Disintegrated factors of input source natural language processed through Natural Language Processing Technology (NLPT) after Voice Recognition System (VRS) where natural voices of different languages programmed appropriately to the particular voice of input source natural language. The output of input natural language Voice Recognition System (VRS) absorbed by speech processing networking. The speech processing networking process the input source natural language disintegration factors into output natural language Voice Recognition System (VRS) for digital replication of speech processing technology. Further, Voice Recognition System (VRS) is processed through Speech Processing Technology. Voice Recognition System (VRS) is programmed to accommodate different voice recognition memories of Voice Processing System (VPS) and Voice Oriented Factors (VOF).
3. VOICE RECOGNITION SYSTEM: Voice Recognition System (VOS) designed into two separate systems of Voice Processing System (VPS) and Voice Oriented Factors (VOF). Voice Oriented Factors (VOF) for Voice Processing System (VPS) are namely, Voice Accuracy (VA)—Accent, Voice Recording (VR)—Pronunciation, Voice Modulation (VM)—Conversation and Module Recording (MR)—Vocabulary. Voice Oriented Factors (VOF) processed through Voice Processing System (VPS) which absorb and process the voice of input natural language and convert it into the voice of output natural language in its original form without any distortion and interpretation. Input natural language speech processing factors processed into encoded format of language translation values of Vocabulary, Accent, Pronunciation and Conversation are further processed into Module Recording, Voice Accuracy, Voice Recording and Voice Modulation of output natural language values in order to formulate the Voice Recognition System (VRS) of one language to another e.g., English to Chinese. These values assigned systematically to the protocol panel board (PPB) of Inter-Language Translation Technology to accommodate Voice Recognition System of more than hundred global natural languages. These values vary according to the application of different embodiment of language chip, i.e., bilingual, multilingual, selective lingual or lingual etc. (FIGS. 8a to 8d—Language chip embodiments). Values of global programmed natural languages designed and developed into Internal Micro Processor (IMP) sub-tools Networking System for proper and accurate application of Inter-Language Translation Technology. All voice recognition factors of Speech Processing Technology (SPT) interrelated in real time automatic application of Inter-Language Translation Technology. This process enables the user to enjoy his own Voice Integrated Factors (VOF) into another language i.e., accent, pronunciation, conversation and vocabulary.
4. DIGITAL TRANSLATING PROCESSING: The next step to digital speech processing is Digital Translation Processing where output of the Speech Processing Technology (SPT) absorbed by the Language Translation Processing Technology (LTPT) for digital translation of particular delivered language processing output into output language translation processing of encoded format for transmission. Digital Translation processing is programmed process of language translating processing technology of Internal Micro Processor (IMP). No separate configuration has been designed to run Digital Translation Processing.
5. DIGITAL TRANSMISSION PROCESSING: The concluding stage of Natural Language Processing Technology (NLPT) is Digital Transmission Processing where Language Translation Processing Technology processed through Internal Micro Processor (IMP) five stage processes for final processing and transmission of output of disintegration processing technology in encoded format for input to Internal Micro Processor (IMP) Integration Technology.

### Mode of Operation

### Internal Micro Processor (IMP) Integration Technology

The Internal Micro Processor (IMP) Integration Technology is designed internally into five stages of language translating processors to collectively process the twelve integrated language factors of output language. Such decoded global language integration format of output language further translated through these five stages of decoded formats of Internal Micro Processor (IMP), viz.

i) processor start reception;

ii) inter language translation;

iii) renaming;

iv) decoding; and

v) integration devices;

by their respective sub-tools. After going through the five stage Internal Micro Processor (IMP) integration processing, the entire digital translation output is transferred to integration programming and processing of natural language translation through micro factors.
1. PROCESSOR START RECEPTION: Reception is the first stage in Internal Micro Processor (IMP) Integration Technology where output of Internal Micro Processor (IMP) Disintegration process in twelve global language decoded format is received at protocol panel board for integration processing of language translation technology by global language integration machines (GIM). These formats are processed through five stages of Internal Micro Processor (IMP) processors of language translation technology for natural language processing, speech processing, digital translating processing, and digital transmission processing of output language integrated factors in encoded format.
2. INTER-LANGUAGE TRANSLATION: The next step to digital speech processing is Digital Translation Processing where output of the Speech Processing Technology (SPT) absorbed by the Language Translation Processing Technology (LTPT) for digital translation of decoded factors of target output language into natural language translation processing format for further transmission. Digital Translation processing is programmed process of language translating processing technology of Internal Micro Processor (IMP). No separate configuration has been designed to run Digital Translation Processing.
3. SPEECH PROCESSING TECHNOLOGY (SPT): Integrated decoded factors of output natural language processed through Natural Language Processing Technology (NLPT) after Voice Recognition System (VRS) where natural voices of different languages programmed appropriately to the particular voice of target output natural language. The intended target output natural language Voice Recognition System (VRS) absorbed by speech processing networking. The speech processing networking process the intended target output natural language integration factors into output natural language Voice Recognition System (VRS) for digital replication of speech processing technology. Further, Voice Recognition System (VRS) is processed through Speech Processing Technology. Voice Recognition System (VRS) is programmed to accommodate different voice recognition memories of Voice Processing System (VPS) and Voice Oriented Factors (VOF).
4. NATURAL LANGUAGE PROCESSING TECHNOLOGY (NLPT): Voice Recognition System (VOS) processed through Natural Language Processing Technology (NLPT) for digital processing of language integration factors into language translating processors. The intended target output natural language integrated factors processed through Voice Recognition System (VOS) appropriately programmed for digital Speech Processing of natural languages of the world. Language Translation Processing Technology (LTPT) comprises Digital Translation and Digital Transmission Programming formats for systematic processing of particular input source natural language translation of decoded end of Internal Micro Processor (IMP) integration process. The intended target output natural language processed through Voice Recognition System (VRS) forwarded simultaneously to Speech Processing Technology (SPT) for further commands.

The present embodiments represent the best ways known to the applicant of putting the invention into practice. But they are not the only ways in which this can be achieved. They are illustrated, and they will now be described, by way of examples only.

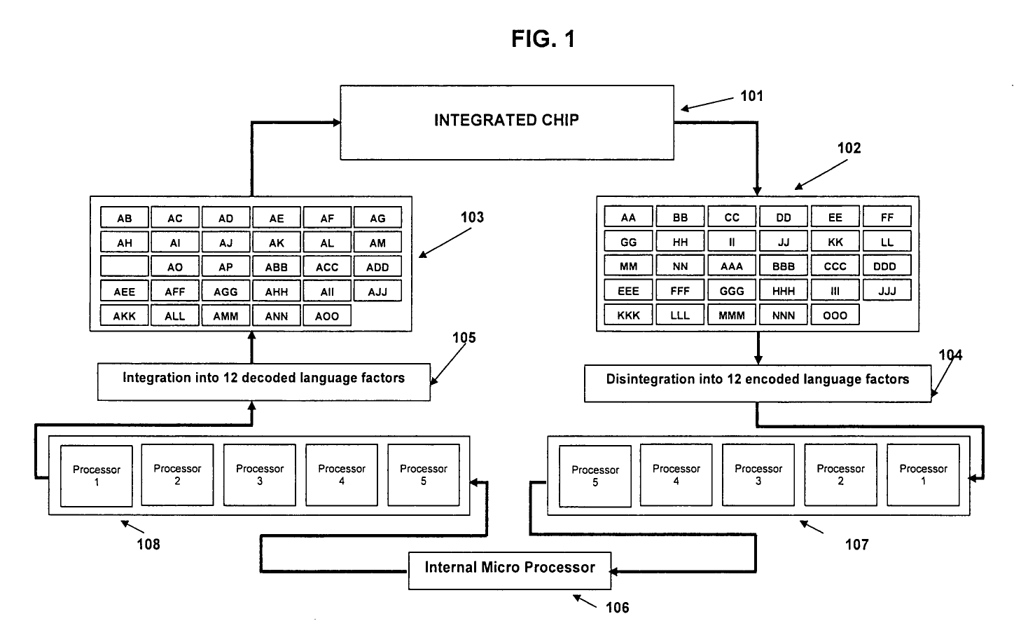

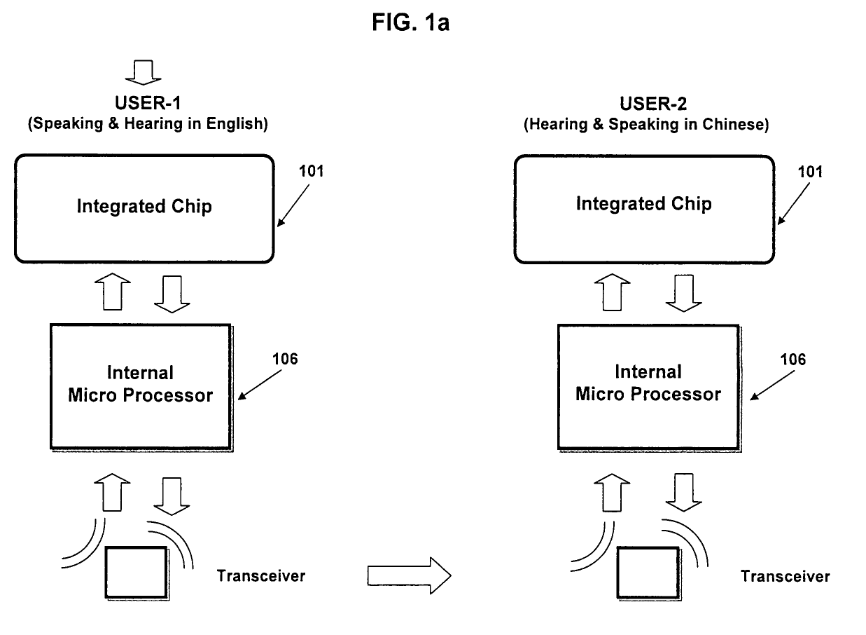

FIG. 1 and FIG. 1A is a principle block diagram depicting the spoken language translation and communication system. A spoken language input is received at one end from a user comprising at least one source language and delivered at other end to another user comprising at least one target language using natural language processing technology and language translation processing technology. The source spoken language input goes through disintegration process performed by natural language disintegration technology 102, 104, 107 and encoded into a digitized global source disintegrated language format at one end for target output language translation. The encoded disintegrated digitized global source language format is received by other end and decoded into integrated digitized global target language format which goes through further integration decoding process performed by natural language integration technology 103, 105, 108 and translated into received spoken language output.

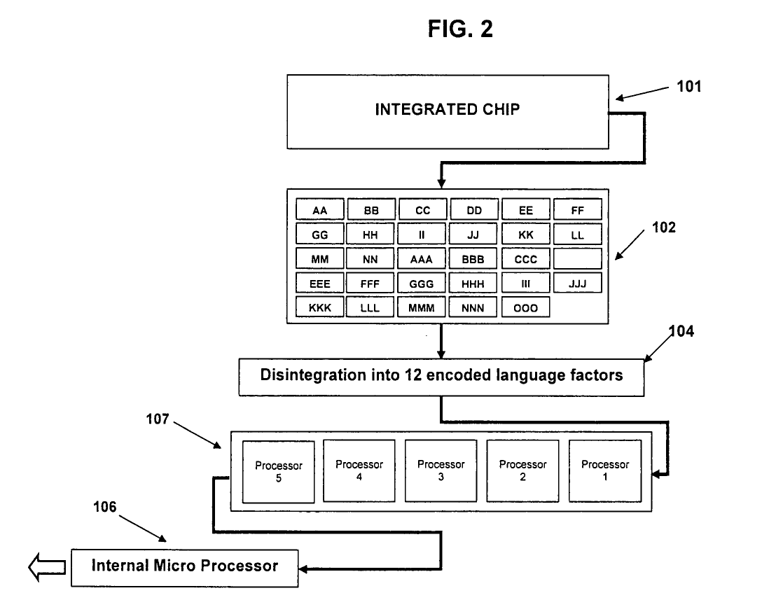

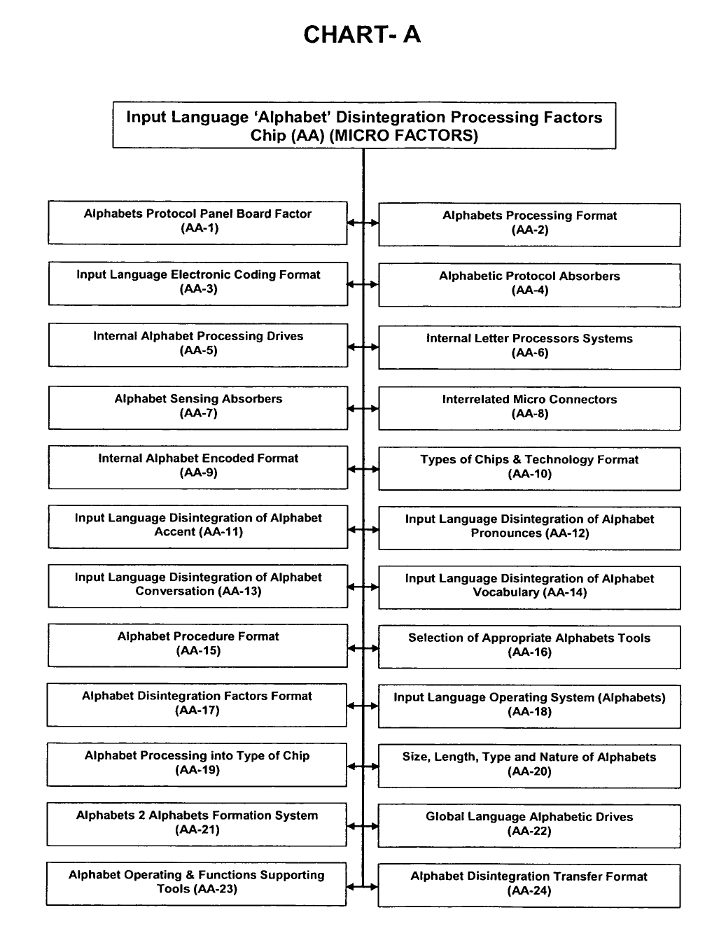

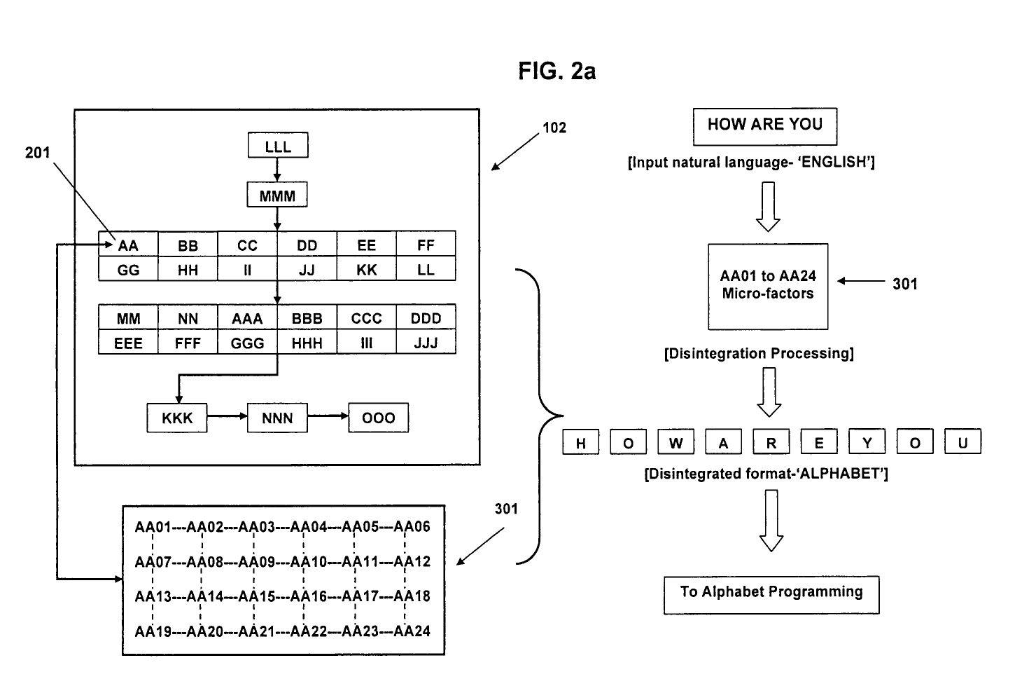

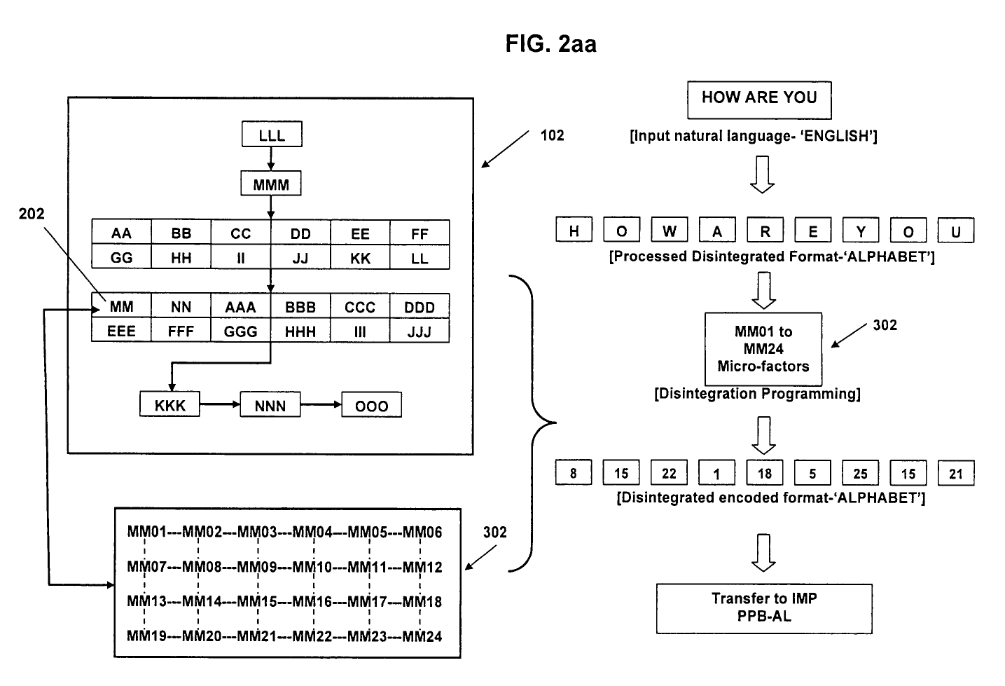

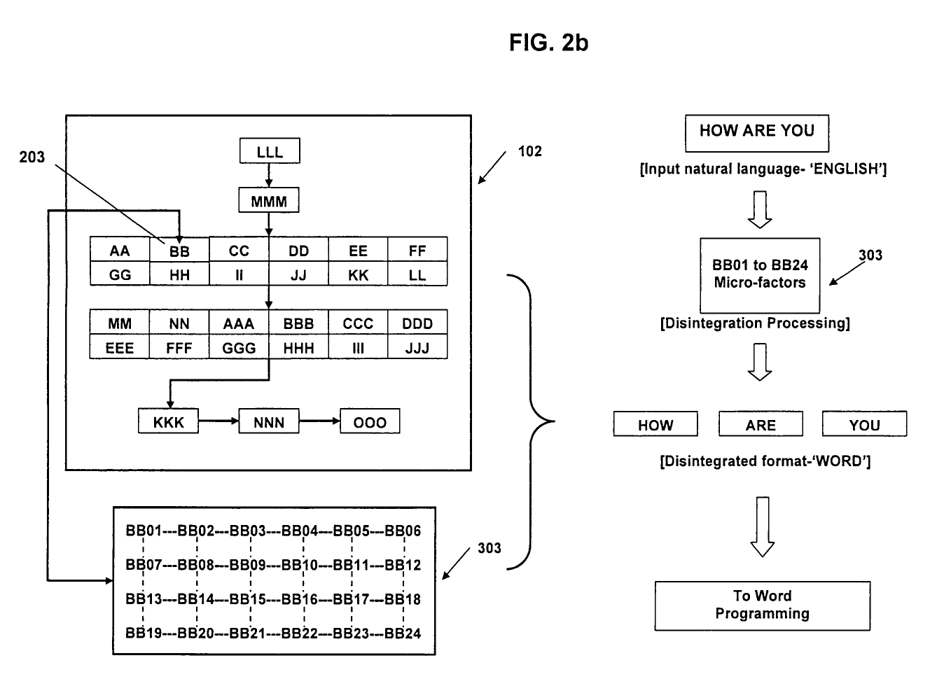

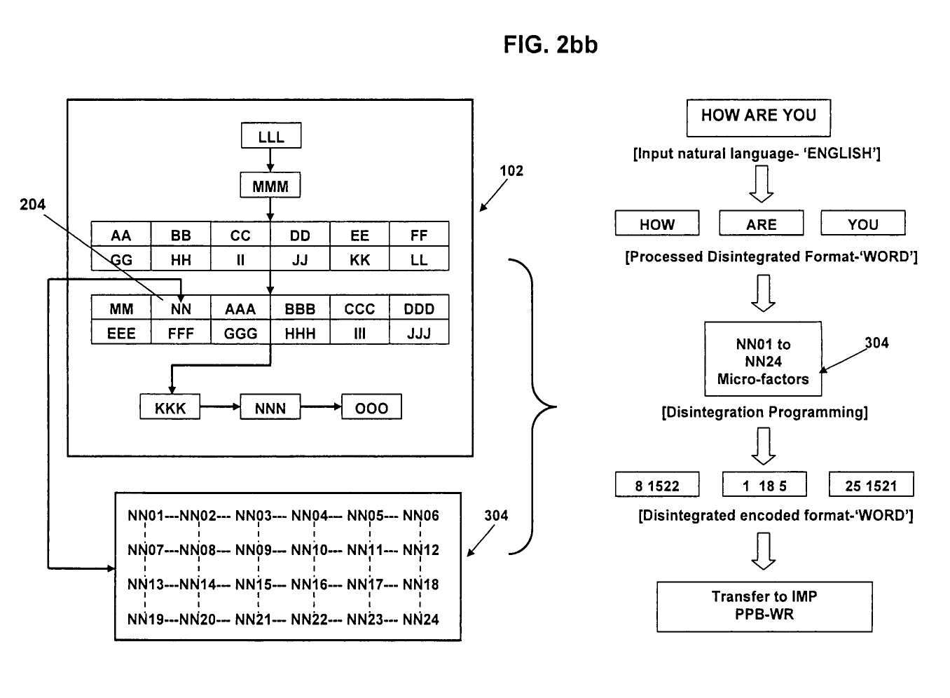

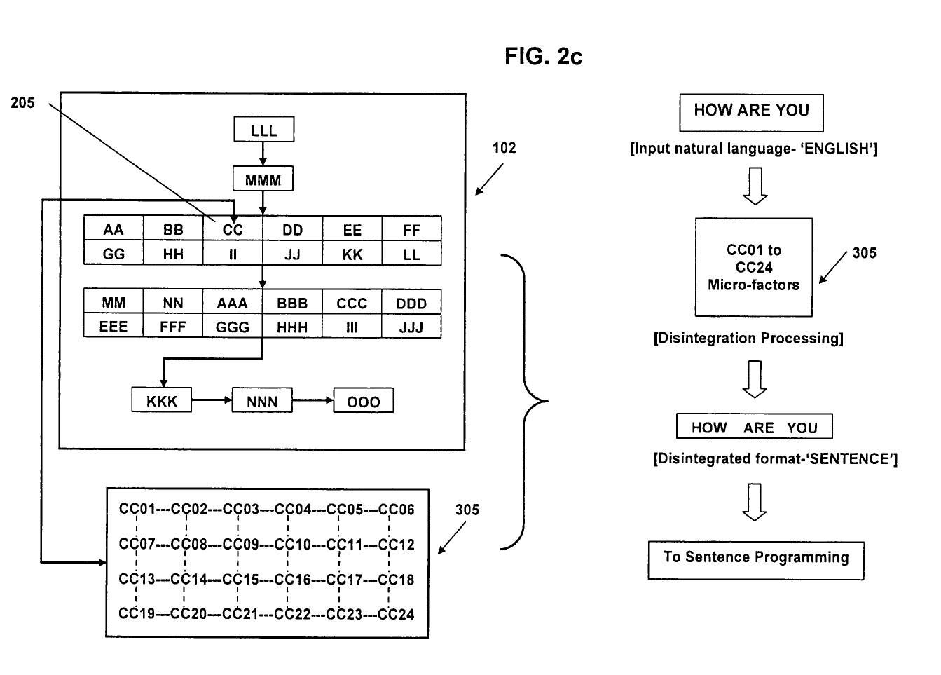

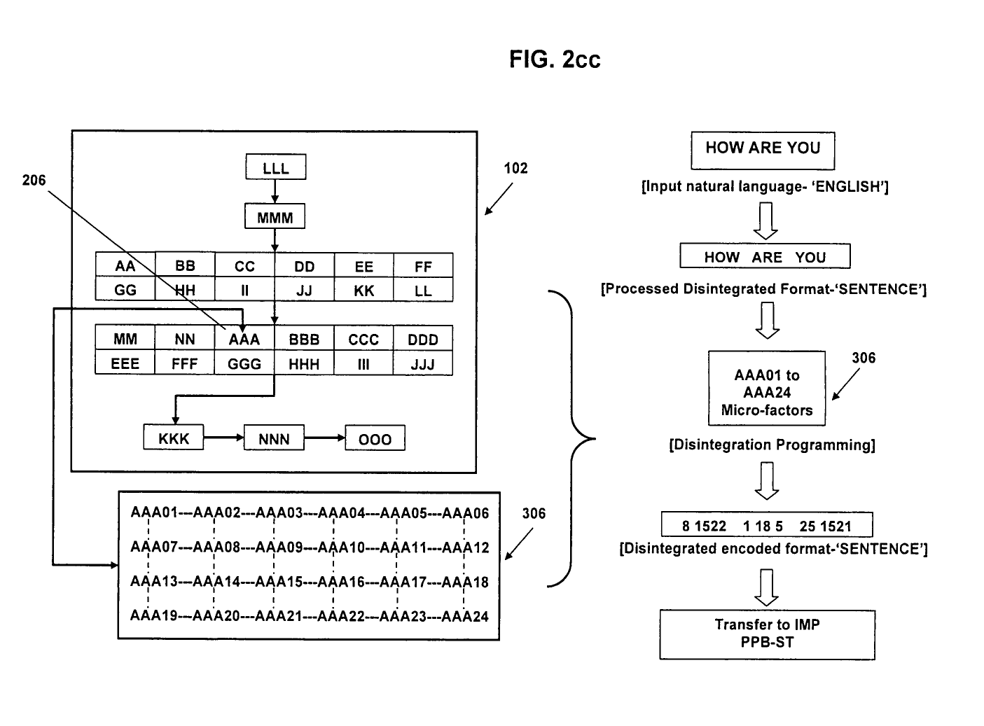

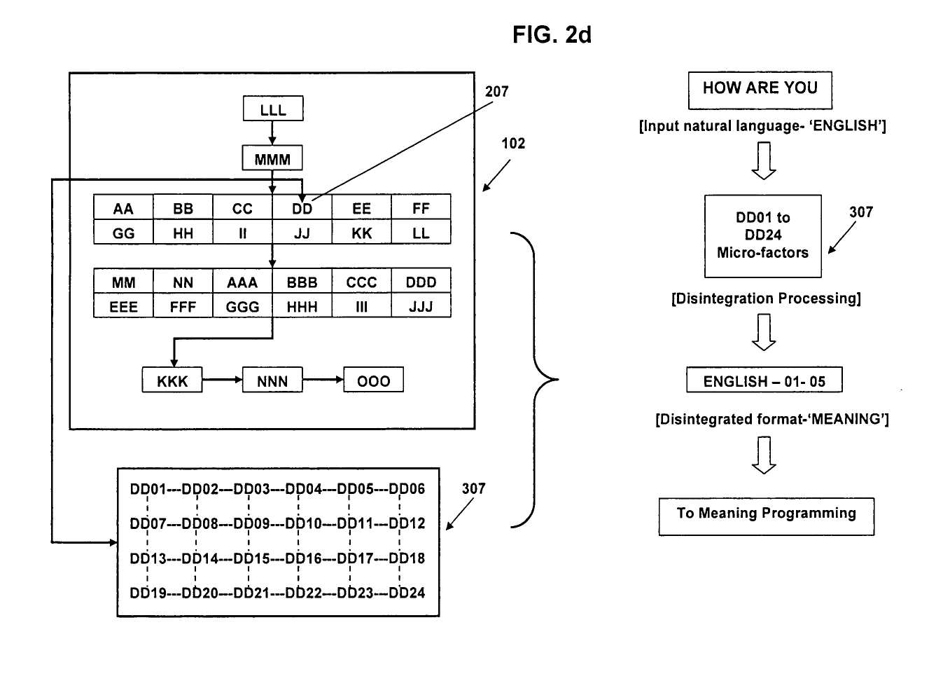

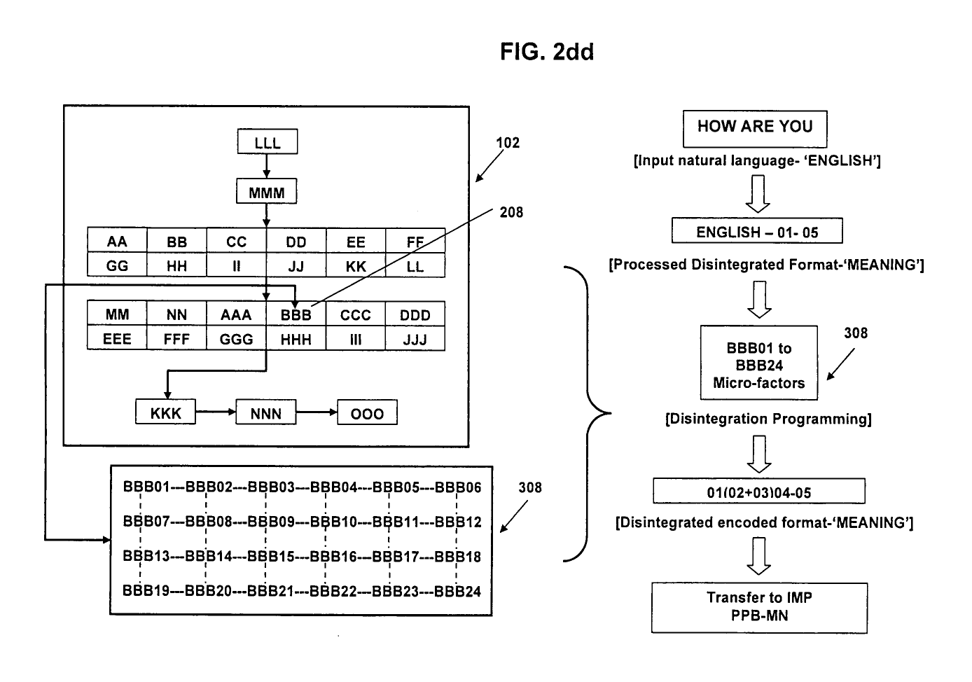

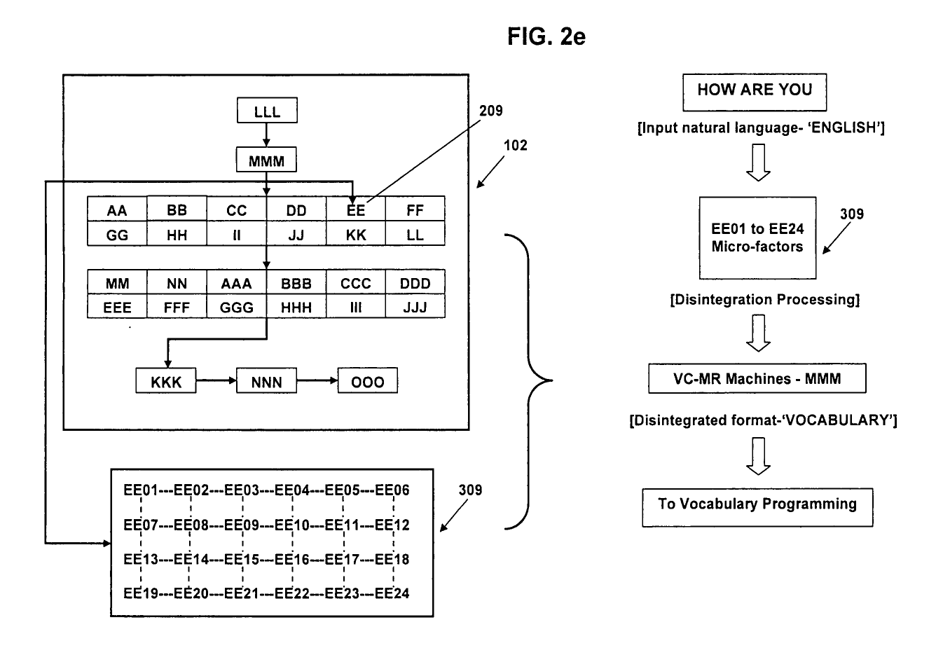

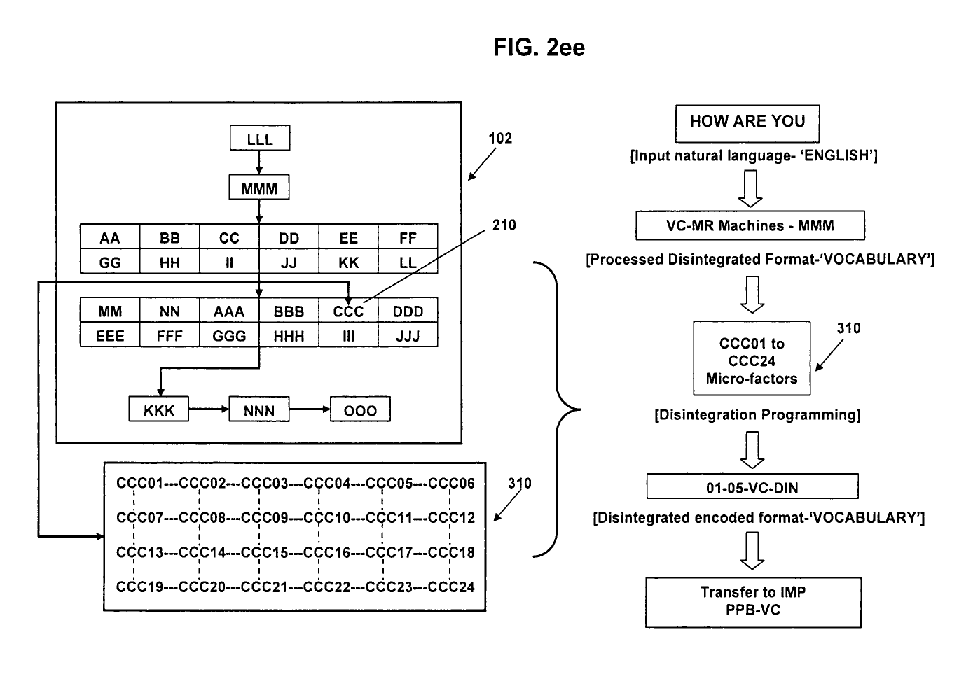

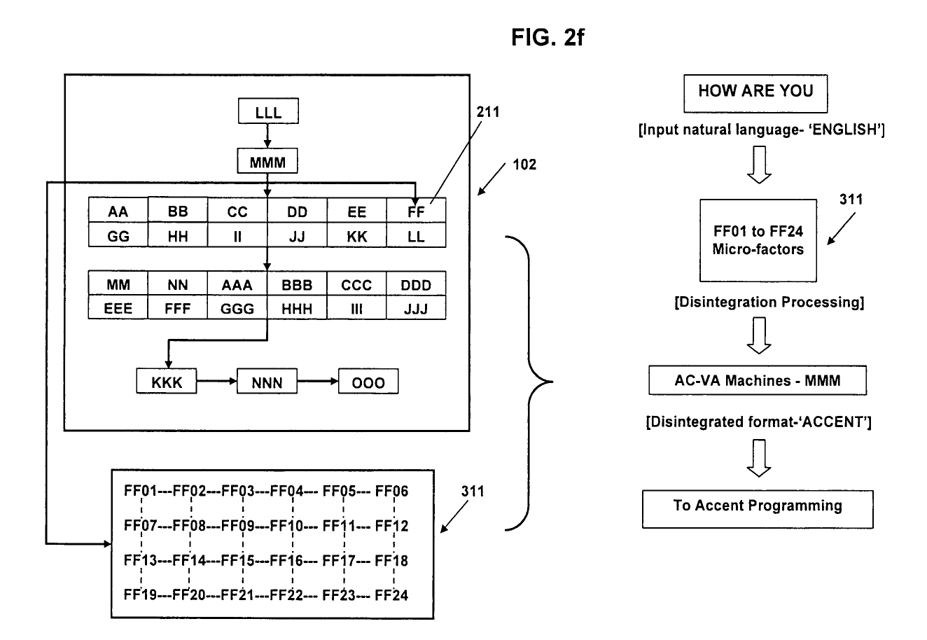

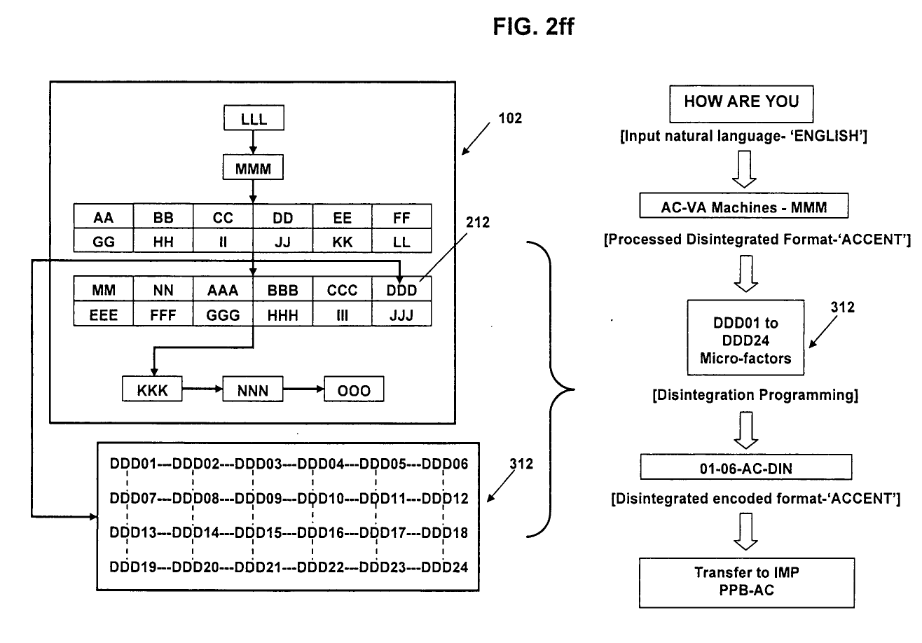

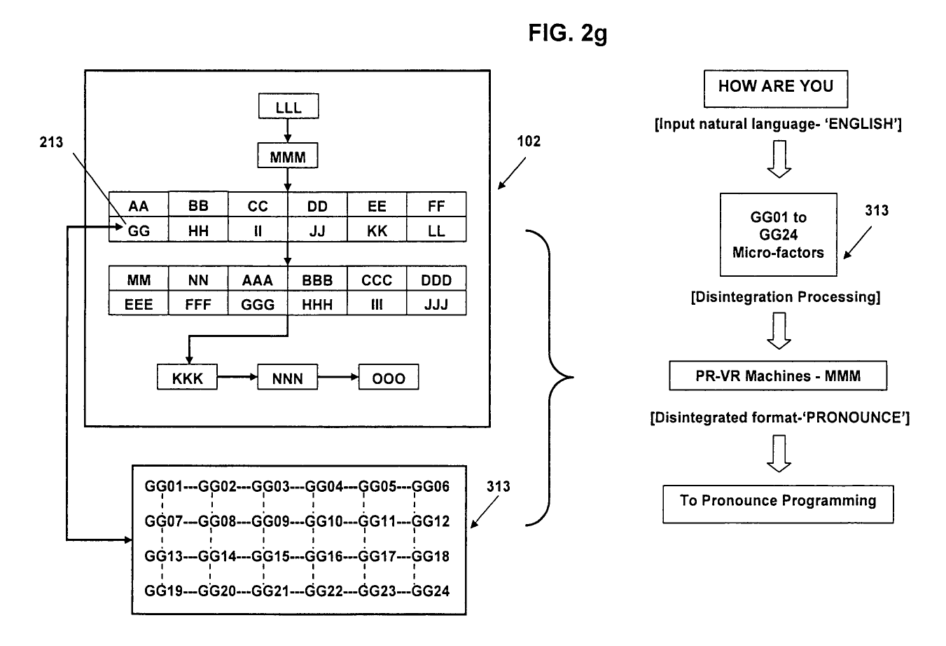

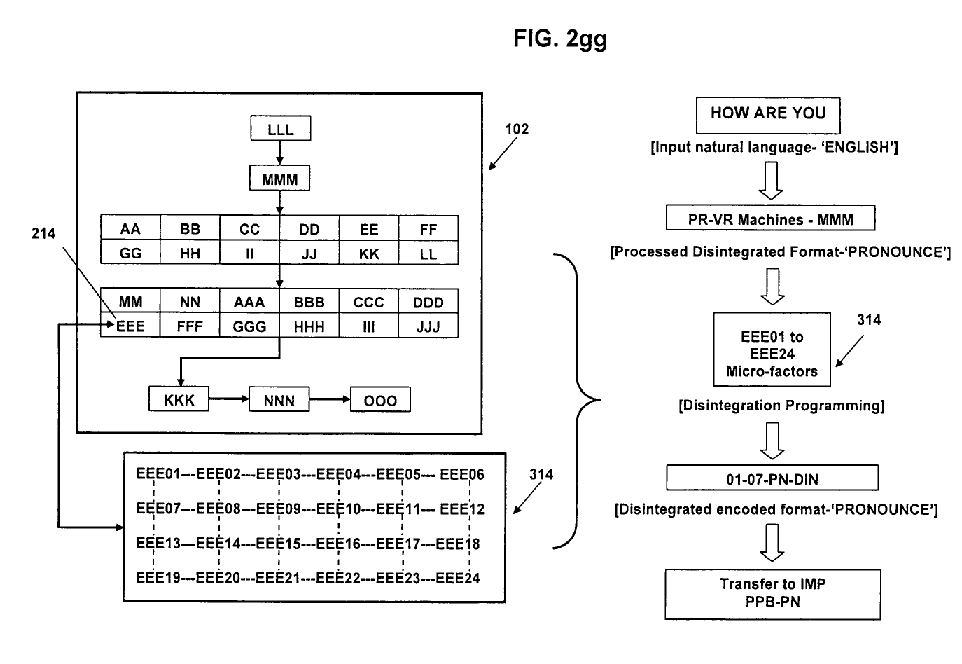

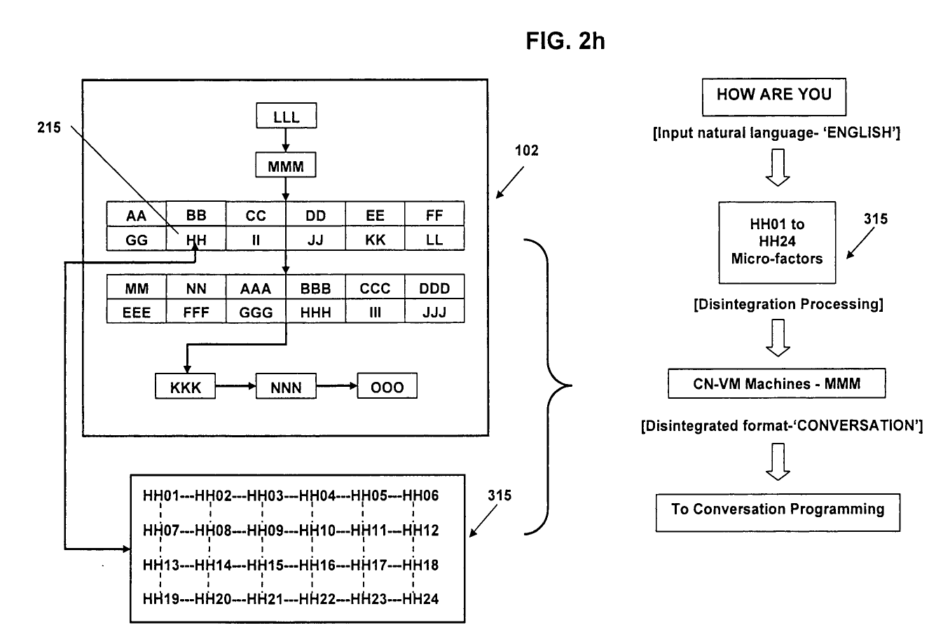

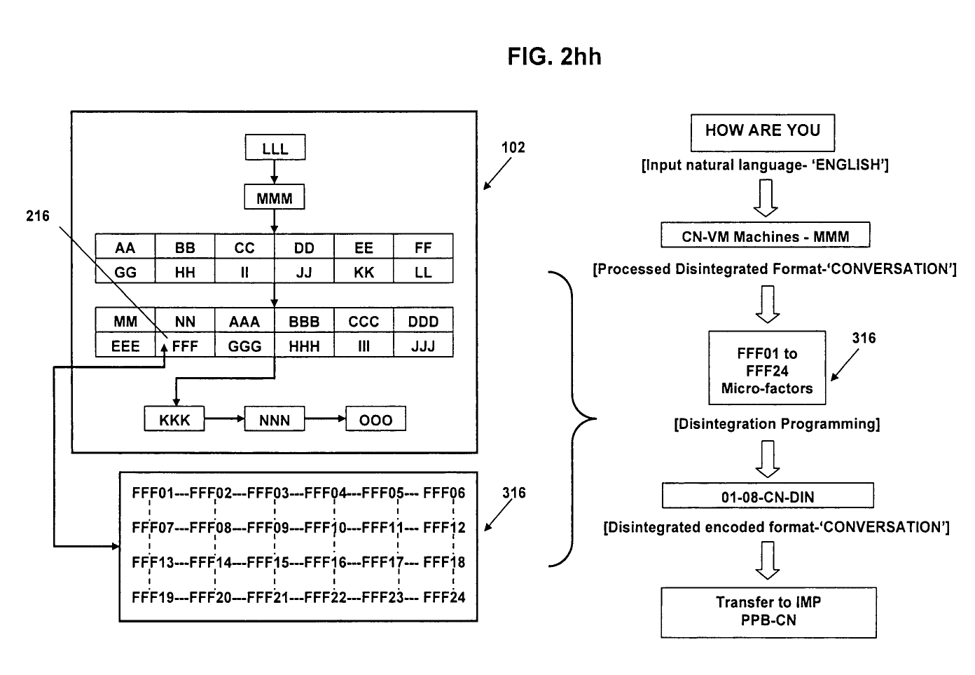

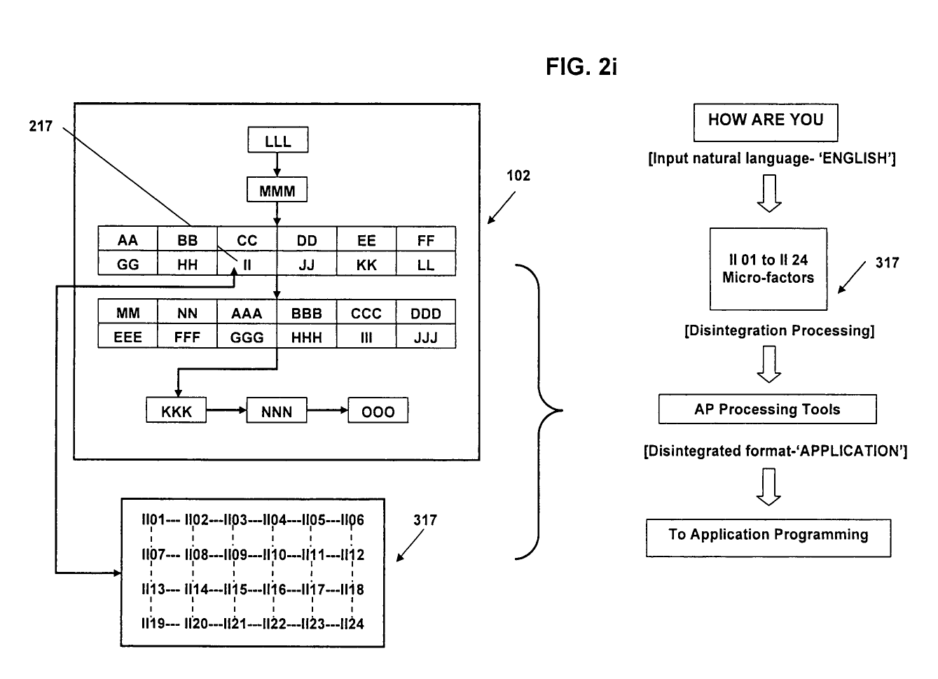

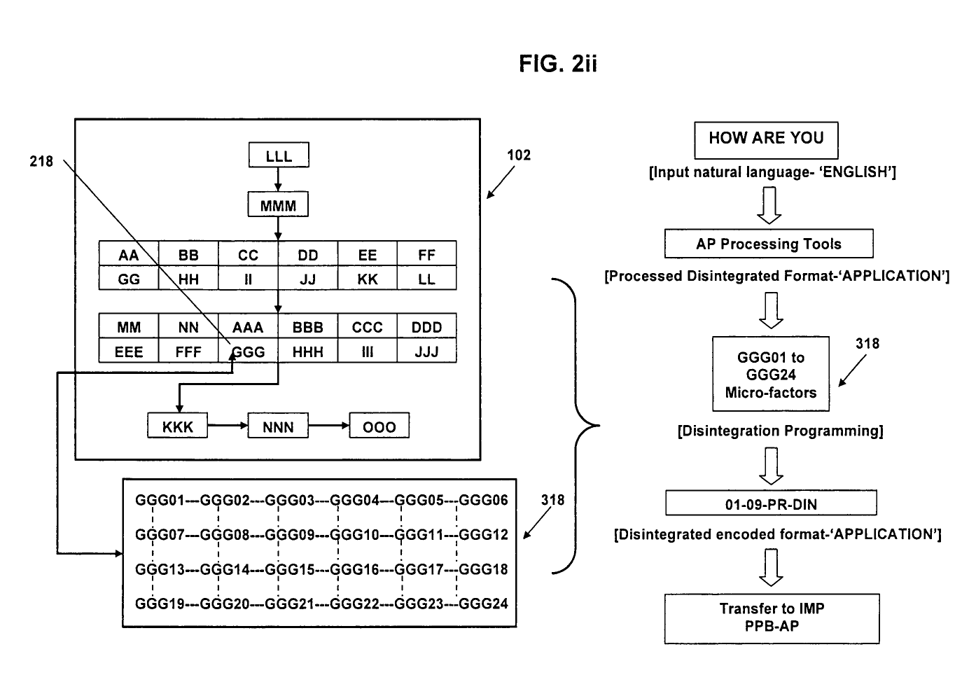

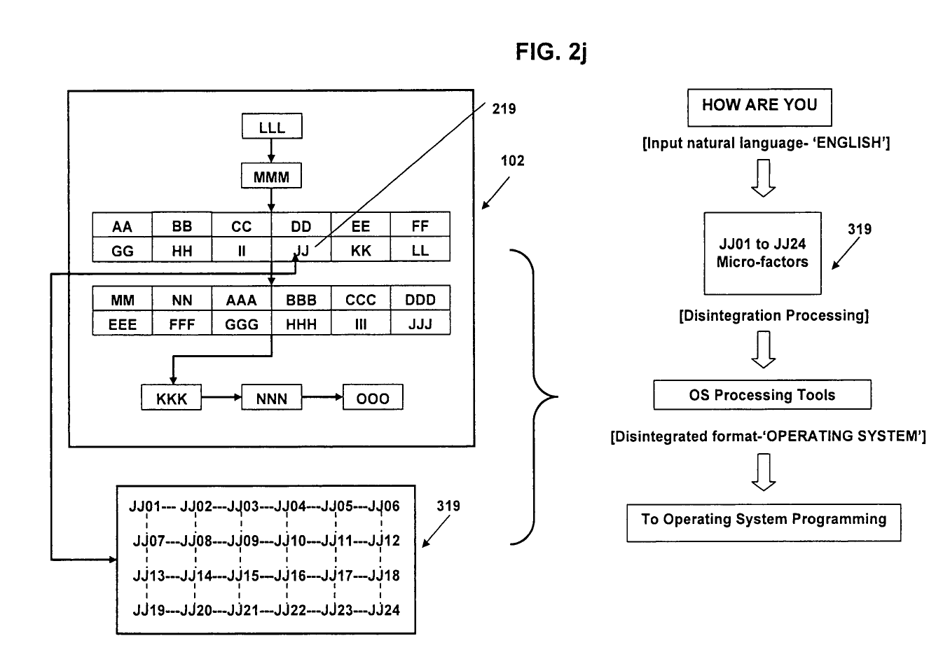

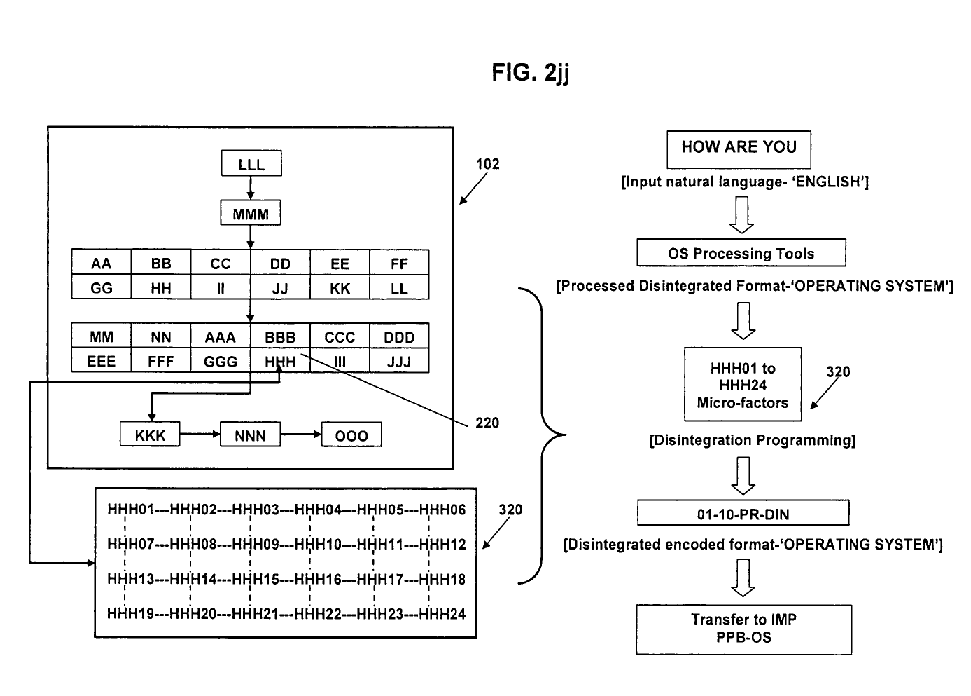

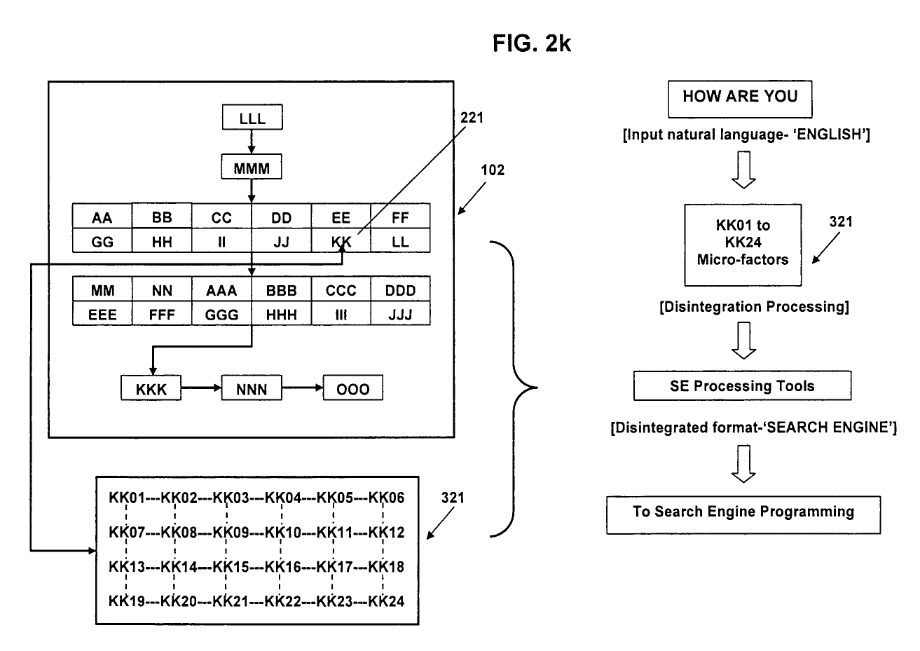

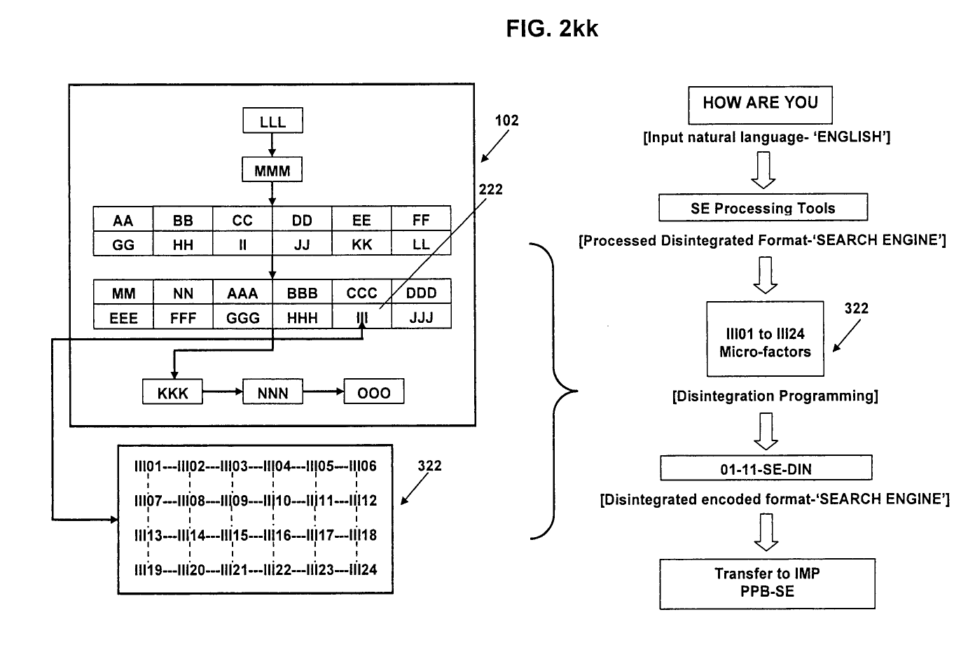

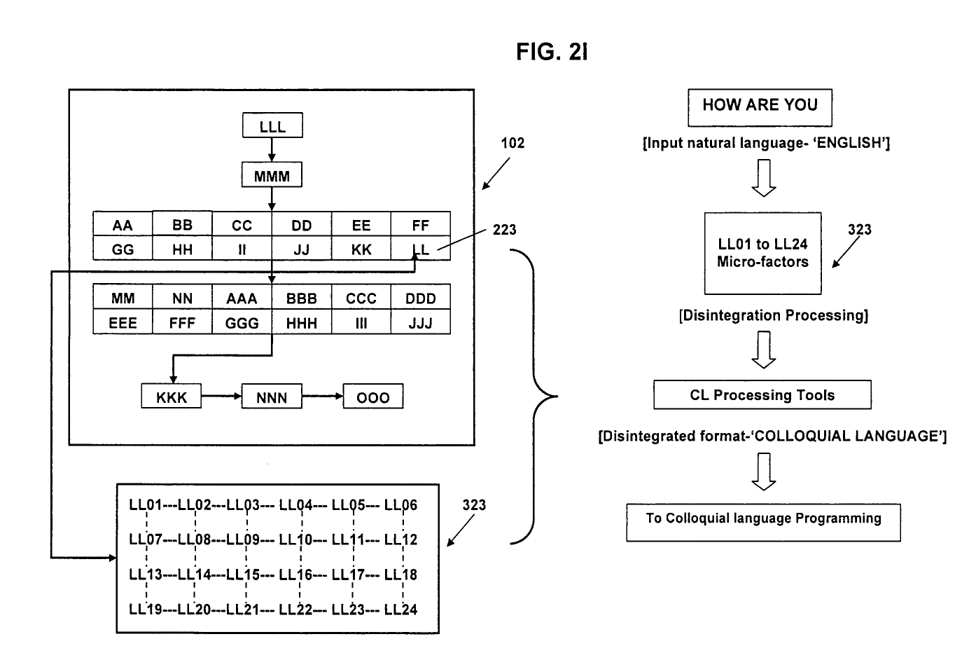

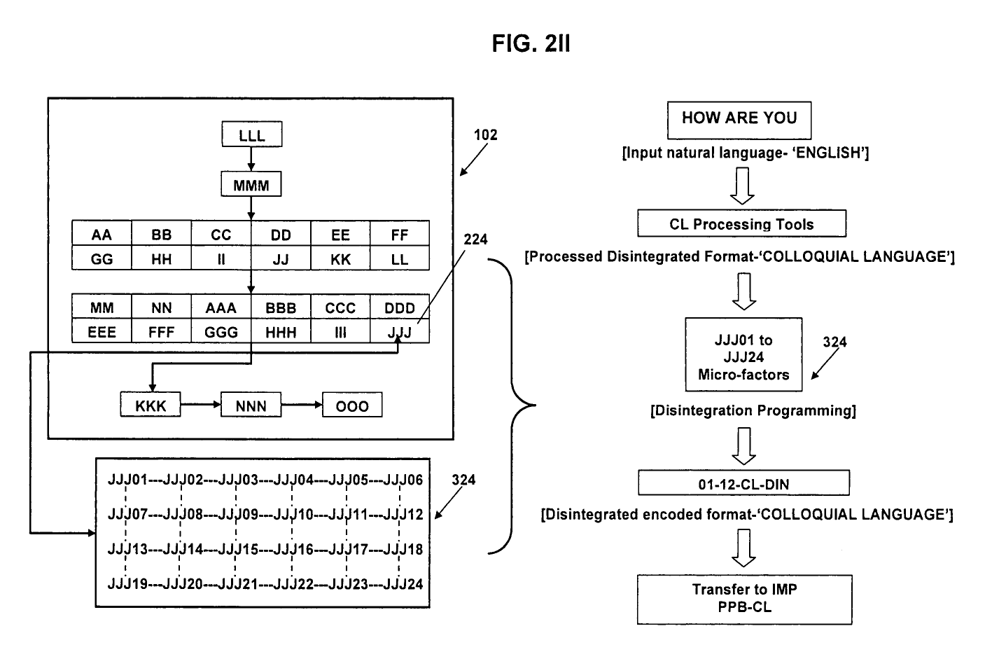

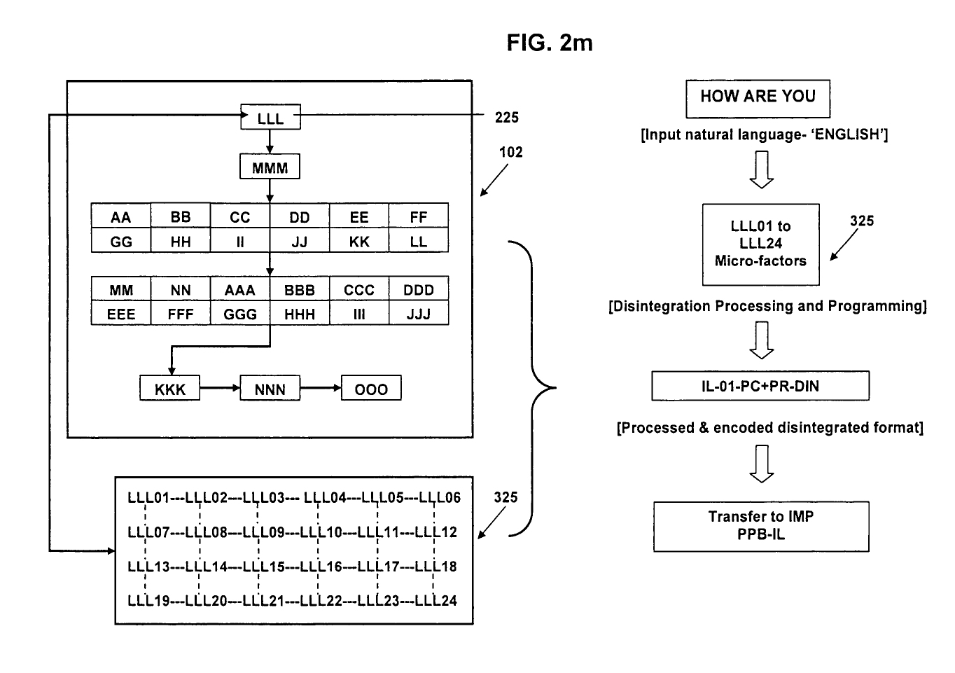

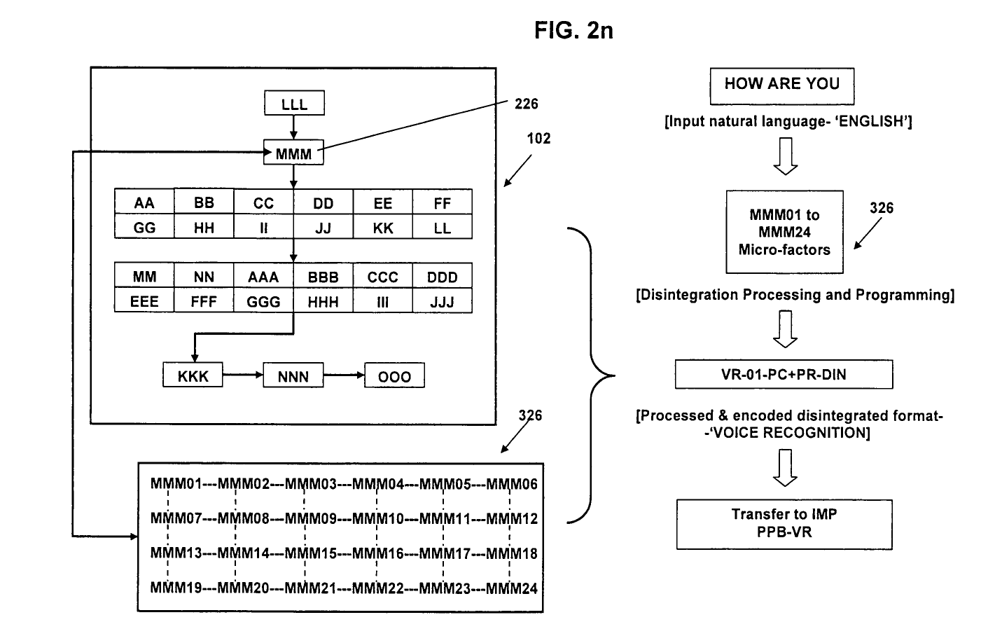

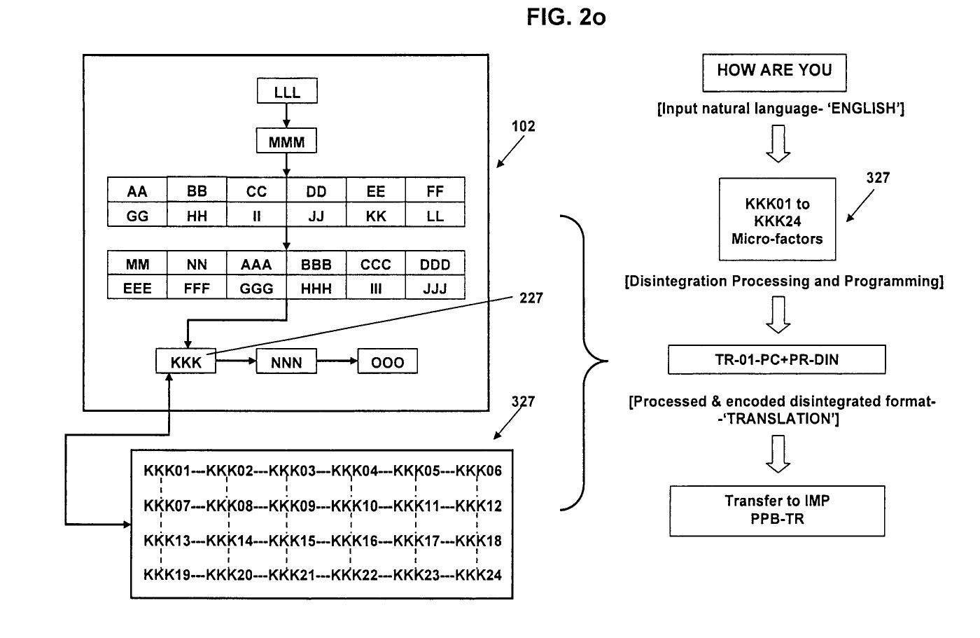

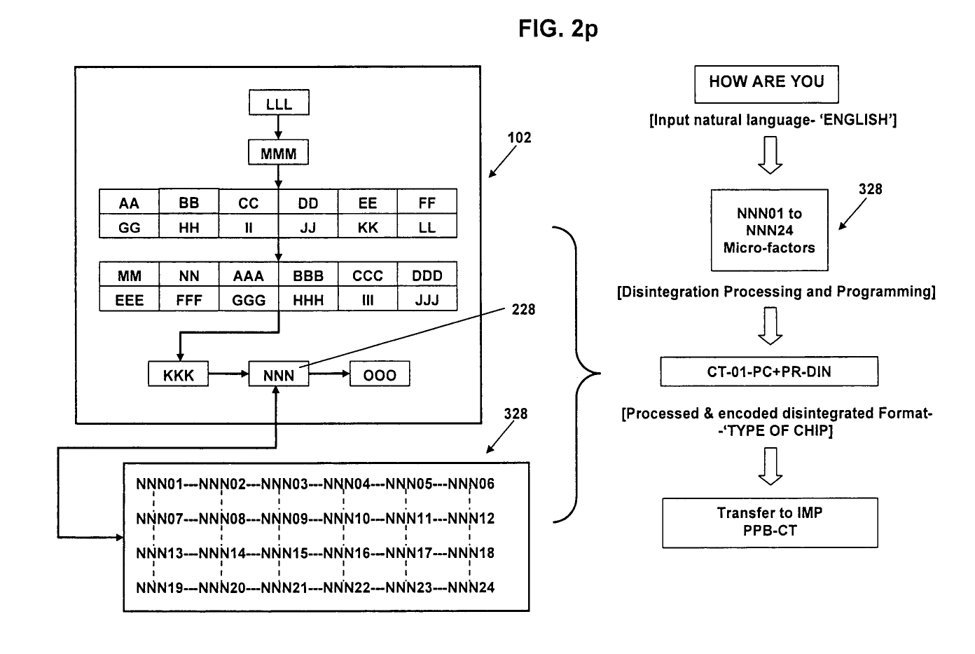

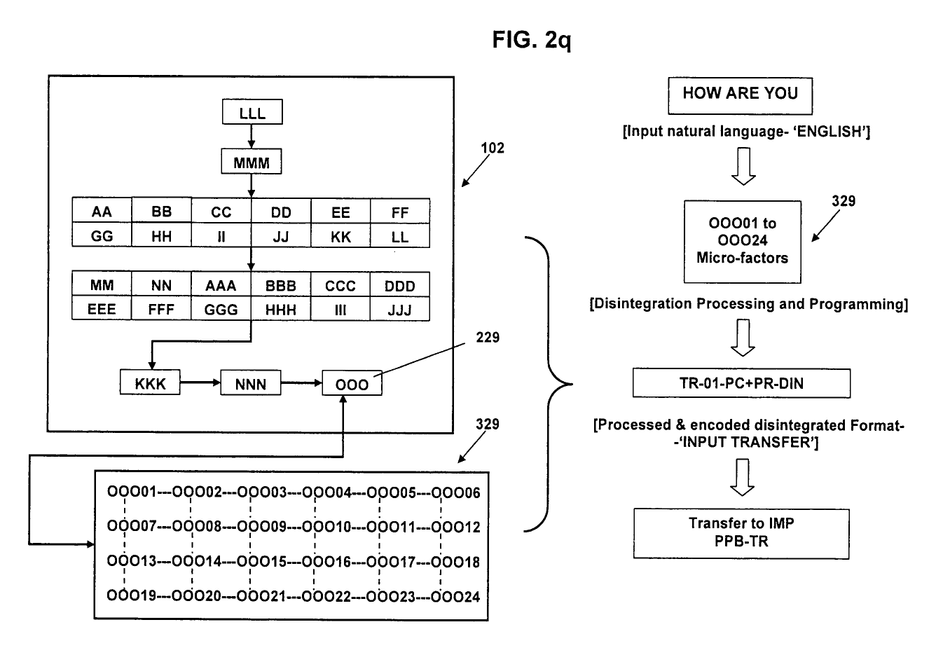

FIG. 2 is a block diagram of input natural language disintegration technology. The main object of input natural language disintegration technology is to disintegrate the input source natural language into twelve encoded language factors 104 from the transmitting end. These twelve encoded language factors 104 transferred to Internal Micro Processor (IMP) 106 for internal processing of the received output of the input source natural language disintegrated factors into global language format for requested language translation.

The input source natural language is received and processed through Integrated Chip (disintegration processing technology chip) 101 which comprises twenty nine micro chips 102 of different language disintegration factors of the technology, viz. a) twelve language processing factors; b) twelve language programming factors; and c) five primary processing factors; as explained hereunder:
a) Disintegration Internal Basic factors of language (processing and programming)
   i) Alphabets (AA/MM);
   ii) Words (BB/NN);
   iii) Sentences (CC/AAA); and
   iv) Meaning (DD/BBB).
b) Disintegration Internal Speech processing factors of language—(processing and programming)
   i) Vocabulary (EE/CCC);
   ii) Accent (FF/DDD);
   iii) Pronunciation (GG/EEE); and
   iv) Conversation (HH/FFF).
c) Disintegration Internal Operating supporting factors of language—(processing and programming)
   i) Application (II/GGG);
   ii) Operating System (JJ/HHH);
   iii) Search engine (KK/III); and
   iv) Colloquial language (LL/JJJ).
d) Internal Primary processing and programming factors of language—
   i) Language chip (LLL);
   ii) Voice recognition chip (MMM);
   iii) Translating chip (KKK);
   iv) Type of chip and technology (NNN); and
   v) Transfer chip (OOO).

These micro chips 102 have been designed with appropriate role of their function while processing the technology. Each microchip identified above has been designed for its allotted function while performing the natural language disintegration process. These microchips 102 are networked together to exchange functions collectively or individually to deliver the encoded output of the language disintegration process of the given target to the Internal Micro Processor (IMP) 106.

Input source natural language goes through language disintegration encoding process and program performed by internal micro chips 102 (e.g. AA/MM) and micro factors (e.g. AA01-AA24/MM01-MM24) of the respective language processing and programming micro chip employing the respective processing format commands and respective programming version commands of different micro systems and sub-systems of language format processing and programming formation of the technology for further processing into Internal Micro Processor (IMP) 106 for requested language translation. Internal micro chip format of the natural language disintegration technology is designed and developed appropriately into twenty four respective micro factors for each micro chip. Internal micro factors operate and control the entire processing and programming systematically according to the protocol formation of the micro processing of the language factors. The main object of the micro factors is to achieve the accurate language translation for the given targets and commands for further navigation and processing of the input language according to the natural language disintegration technology. ‘CHART A’ details the role played by the internal micro factors by way of illustration of the ‘Alphabet format’ in the natural language disintegration technology.

FIG. 2a is an explanatory diagram depicting the disintegration of input natural language into basic processing factors—‘alphabet format’ performed by language disintegration processing technology according to an embodiment of the present invention.

Disintegration processing technology chip (Integrated Chip) 101 consists of twenty nine micro chips 102 of different disintegration factors of the technology. These micro chips 102 have been designed with appropriate role of their functions while processing the technology. ‘Disintegration alphabet format chip’ 201 is one of them which performs the processing of input natural language into ‘alphabet format’ by using internal micro factors or functions, AA1 to AA24, 301 and transfers the same to alphabet programming. ‘Disintegration alphabet format chip’ 201 activates to start the functions of micro factors, AA1 to AA24, 301 with the input of natural language which operates and controls the entire processing systematically according to the protocol formation of the alphabet processing factors. These factors 301 adjusted automatically to work either collectively or individually according to the situation. The main object of these alphabet processing factors 301 is to achieve the solution for the given targets and commands from the basic factors of the technology for further navigating and processing of the input language alphabet format according to the disintegration programming technology. The entire process is organized and controlled by input processing format of alphabet microchip 201 and its micro factors or functions 301.

Performance of ‘Disintegration alphabet format chip’ 201 can be understood by the explanatory illustration wherein operation begins when an input natural language “HOW ARE YOU” namely in English, is received. Input language basic factors processing is performed by using micro factors AA1 to AA24, 301 and alphabet format in the form “H”, “O”, “W”, “A”, “R”, “E”, “Y”, “O”, “U” of the input natural language “HOW ARE YOU” is produced and transferred to alphabet programming.

FIG. 2aa is an explanatory diagram depicting the disintegration of basic factors of alphabets into ‘encoded alphabet format’ performed by language disintegration programming technology according to an embodiment of the present invention. Performance of ‘Disintegration programming alphabet format chip’ 202 can be understood by the explanatory illustration wherein operation begins when disintegrated processed alphabet format in the form “H”, “O”, “W”, “A”, “R”, “E”, “Y”, “O”, “U” of the input natural language “HOW ARE YOU” is absorbed and formed into coding format of the version “8”, “15”, “22”, “1”, “18”, “5”, “25”, “15”, “21” by application of micro factors MM-01 to MM-24 302 using disintegration programming technology. This ‘encoded alphabet format’ is then transferred to Internal Micro Processor (IMP) 106 for internal disintegration valuation processing for language translation.

FIG. 2b is an explanatory diagram depicting the disintegration of input natural language into basic processing factors—‘word format’ performed by language disintegration processing technology according to an embodiment of the present invention.

Disintegration processing technology chip 101 consists of twenty nine micro chips 102 of different disintegration factors of the technology. These micro chips 102 have been designed with appropriate role of their functions while processing the technology. ‘Disintegration word format chip’ 203 is one of them which performs the processing of input natural language into ‘word format’ by using internal micro factors or functions, BB1 to BB24, 303 and transfers the same to word programming. ‘Disintegration word format chip’ 203 activates to start the functions of micro factors, BB1 to BB24, 303 with the input of natural language which operate and control the entire processing systematically according to the protocol formation of the word processing factors. These factors 303 adjusted automatically to work either collectively or individually according to the situation. The main object of these word processing factors 303 is to achieve the solution for the given targets and commands from the basic factors of the technology for further navigating and processing of the input language word format according to the disintegration programming technology. The entire process is organized and controlled by input processing format of word microchip 203 and its micro factors or functions 303.

Performance of ‘Disintegration word format chip 203’ can be understood by the explanatory illustration wherein operation begins when an input natural language “HOW ARE YOU” namely in English, is received. Input language basic factors processing is performed by using micro factors BB1 to BB24, 303 and word format in the form “HOW”, “ARE”, “YOU” of the input natural language “HOW ARE YOU” is produced and transferred to word programming.

FIG. 2bb is an explanatory diagram depicting the disintegration of basic factors of word into ‘encoded word format’ performed by using language disintegration programming technology according to an embodiment of the present invention. Performance of ‘Disintegration programming word format chip’ 204 can be understood by the explanatory illustration wherein operation begins when disintegrated processed word format in the form “HOW”, “ARE”, “YOU” of the input natural language “HOW ARE YOU” is absorbed and formed into coding format of the version “8 1522”, “1 18 5”, “251521” by application of micro factors NN-01 to NN-24 304 using disintegration programming technology. This ‘encoded word format’ is then transferred to Internal Micro Processor (IMP) 106 for internal disintegration valuation processing for language translation.

FIG. 2c is an explanatory diagram depicting the disintegration of input natural language into basic processing factors—‘sentence format’ performed by language disintegration processing technology according to an embodiment of the present invention.

Disintegration processing technology chip 101 consists of twenty nine micro chips 102 of different disintegration factors of the technology. These micro chips 102 have been designed with appropriate role of their functions while processing the technology. Disintegration sentence format chip 205 is one of them which performs the processing of input natural language into ‘sentence format’ by using internal micro factors or functions, CC1 to CC24, 305 and transfers the same to sentence programming. ‘Disintegration sentence format chip’ 205 activates to start the functions of micro factors, CC1 to CC24, 305 with the input of natural language which operate and control the entire processing systematically according to the protocol formation of the sentence processing factors. These factors 305 adjusted automatically to work either collectively or individually according to the situation. The main object of these sentence processing factors 305 is to achieve the solution for the given targets and commands from the basic factors of the technology for further navigating and processing of the input language sentence format according to the disintegration programming technology. The entire process is organized and controlled by input processing format of sentence microchip 205 and its micro factors or functions 305.

Performance of ‘Disintegration sentence format chip’ 205 can be understood by the explanatory illustration wherein operation begins when an input natural language “HOW ARE YOU” namely in English, is received. Input language basic factors processing is performed by using micro factors CC1 to CC24, 305 and sentence format in the form “HOW”, “ARE”, “YOU” of the input natural language “HOW ARE YOU” is produced and transferred to sentence programming.

FIG. 2cc is an explanatory diagram depicting the disintegration of basic factors of sentence into ‘encoded sentence format’ performed by language disintegration programming technology according to an embodiment of the present invention. Performance of ‘Disintegration programming sentence format chip’ 206 can be understood by the explanatory illustration wherein operation begins when disintegrated processed sentence formats in the form “HOW”, “ARE”, “YOU” of the input natural language “HOW ARE YOU” is absorbed and formed into coding format of the version “8 1522”, “1 18 5”, “251521” by application of micro factors AAA-01 to AAA-24 306 using disintegration programming technology. This ‘encoded sentence format’ is then transferred to Internal Micro Processor (IMP) 106 for internal disintegration valuation processing for language translation.

FIG. 2d is an explanatory diagram depicting the disintegration of input natural language into basic processing factors—‘meaning format’ performed by language disintegration processing technology according to an embodiment of the present invention.

Disintegration processing technology chip 101 consists of twenty nine micro chips 102 of different disintegration factors of the technology. These micro chips 102 have been designed with appropriate role of their functions while processing the technology. ‘Disintegration meaning format chip’ 207 is one of them which performs the processing of input natural language into ‘meaning format’ by using internal micro factors or functions, DD1 to DD24, 307 and transfers the same to meaning programming. ‘Disintegration meaning format chip’ 207 activates to start the functions of micro factors, DD1 to DD24, 307 with the input of natural language which operate and control the entire processing systematically according to the protocol formation of the meaning processing factors 307. These factors 307 adjusted automatically to work either collectively or individually according to the situation. The main object of these meaning processing factors 307 is to achieve the solution for the given targets and commands from the basic factors of the technology for further navigating and processing of the input language meaning format according to the disintegration programming technology. The entire process is organized and controlled by input processing format of meaning microchip 207 and its micro factors or functions 307.

Performance of ‘Disintegration meaning format chip’ 207 can be understood by the explanatory illustration wherein operation begins when an input natural language “HOW ARE YOU” namely in English, is received. Input language basic factors processing is performed by using micro factors DD1 to DD24, 307 and meaning format in the form “ENGLISH—01-05” of the input natural language “HOW ARE YOU” is produced and transferred to meaning programming.

FIG. 2dd is an explanatory diagram depicting the disintegration of basic factors of meaning into ‘encoded meaning format’ performed by language disintegration programming technology according to an embodiment of the present invention. Performance of ‘Disintegration programming meaning format chip’ 208 can be understood by the explanatory illustration wherein operation begins when disintegrated processed meaning format in the form “ENGLISH—01-05” of the input natural language “HOW ARE YOU” is absorbed and formed into coding format of the version “01(02+03)04-05” by application of micro factors BBB-01 to BBB-24 308 using disintegration programming technology. This ‘encoded meaning format’ is then transferred to Internal Micro Processor (IMP) 106 for internal disintegration valuation processing for language translation.

FIG. 2e is an explanatory diagram depicting the disintegration of input natural language into speech processing factors—‘vocabulary format’ performed by language disintegration processing technology according to an embodiment of the present invention.

Disintegration processing technology chip 101 consists of twenty nine micro chips 102 of different disintegration factors of the technology. These micro chips 102 have been designed with appropriate role of their functions while processing the technology. ‘Disintegration vocabulary format chip’ 209 is one of them which performs the processing of input natural language into ‘vocabulary format’ by using internal micro factors or functions, EE1 to EE24, 309 and transfers the same to vocabulary programming ‘Disintegration vocabulary format chip’ 209 activates to start the functions of micro factors, EE1 to EE24, 309 with the input of natural language which operate and control the entire processing systematically according to the protocol formation of the vocabulary processing factors. These factors 309 adjusted automatically to work either collectively or individually according to the situation. The main object of these vocabulary processing factors 309 is to achieve the solution for the given targets and commands from the speech factors of the technology for further navigating and processing of the input language vocabulary format according to the disintegration programming technology. The entire process is organized and controlled by input processing format of vocabulary microchip 209 and its micro factors or functions 309.

Performance of ‘Disintegration vocabulary format Chip’ 209 can be understood by the explanatory illustration wherein operation begins when an input natural language “HOW ARE YOU” namely in English, is received. Input language speech factors processing is performed by using micro factors EE1 to EE24, 309 and vocabulary format in the form “VC-MR MACHINES-MMM” of the input natural language “HOW ARE YOU” is produced and transferred to vocabulary programming.

FIG. 2ee is an explanatory diagram depicting the disintegration of speech factors of vocabulary into ‘encoded vocabulary format’ performed by language disintegration programming technology according to an embodiment of the present invention. Performance of ‘Disintegration programming vocabulary format chip’ 210 can be understood by the explanatory illustration wherein operation begins when disintegrated processed vocabulary format in the form “VC-MR MACHINES-MMM” of the input natural language “HOW ARE YOU” is absorbed and formed into coding format of the version “01-05-VC-DIN” by application of micro factors CCC-01 to CCC-24 310 using disintegration programming technology. This ‘encoded vocabulary format’ is then transferred to Internal Micro Processor (IMP) 106 for internal disintegration valuation processing for language translation.

FIG. 2f is an explanatory diagram depicting the disintegration of input natural language into speech processing factors—‘accent format’ performed by language disintegration processing technology according to an embodiment of the present invention.

Disintegration processing technology chip 101 consists of twenty nine micro chips 102 of different disintegration factors of the technology. These micro chips 102 have been designed with appropriate role of their functions while processing the technology. ‘Disintegration accent format chip’ 211 is one of them which performs the processing of input natural language into ‘accent format’ by using internal micro factors or functions, FF1 to FF24, 311 and transfers the same to accent programming. ‘Disintegration accent format chip’ 211 activates to start the functions of micro factors, FF1 to FF24, 311 with the input of natural language which operate and control the entire processing systematically according to the protocol formation of the accent processing factors. These factors 311 adjusted automatically to work either collectively or individually according to the situation. The main object of these accent processing factors 311 is to achieve the solution for the given targets and commands from the speech factors of the technology for further navigating and processing of the input language accent format according to the disintegration programming technology. The entire process is organized and controlled by input processing format of accent microchip 211 and its micro factors or functions 311.

Performance of ‘Disintegration accent format chip’ 211 can be understood by the explanatory illustration wherein operation begins when an input natural language “HOW ARE YOU” namely in English, is received. Input language speech factors processing is performed by using micro factors FF1 to FF24, 311 and accent format in the form “AC-VA MACHINES-MMM” of the input natural language “HOW ARE YOU” is produced and transferred to accent programming.

FIG. 2ff is an explanatory diagram depicting the disintegration of speech factors of accent into ‘encoded accent format’ performed by language disintegration programming technology according to an embodiment of the present invention. Performance of ‘Disintegration programming accent format chip’ 212 can be understood by the explanatory illustration wherein operation begins when disintegrated processed accent format in the form “AC-VA MACHINES-MMM” of the input natural language “HOW ARE YOU” is absorbed and formed into coding format of the version “01-06-AC-DIN” by application of micro factors DDD-01 to DDD-24 312 using disintegration programming technology. This ‘encoded accent format’ is then transferred to Internal Micro Processor (IMP) 106 for internal disintegration valuation processing for language translation.

FIG. 2g is an explanatory diagram depicting the disintegration of input natural language into speech processing factors—‘pronunciation format’ performed by language disintegration processing technology according to an embodiment of the present invention.

Disintegration processing technology chip 101 consists of twenty nine micro chips 102 of different disintegration factors of the technology. These micro chips 102 have been designed with appropriate role of their functions while processing the technology. ‘Disintegration pronunciation format chip’ 213 is one of them which performs the processing of input natural language into ‘pronunciation format’ by using internal micro factors or functions, GG1 to GG24, 313 and transfers the same to pronunciation programming. ‘Disintegration pronunciation format chip’ 213 activates to start the functions of micro factors, GG1 to GG24, 313 with the input of natural language which operate and control the entire processing systematically according to the protocol formation of the pronunciation processing factors. These factors 313 adjusted automatically to work either collectively or individually according to the situation. The main object of these pronunciation processing factors 313 is to achieve the solution for the given targets and commands from the speech factors of the technology for further navigating and processing of the input language pronunciation format according to the disintegration programming technology. The entire process is organized and controlled by input processing format of pronunciation microchip 213 and its micro factors or functions 313.

Performance of ‘Disintegration pronunciation format chip’ 213 can be understood by the explanatory illustration wherein operation begins when an input natural language “HOW ARE YOU” namely in English, is received. Input language speech factors processing is performed by using micro factors GG1 to GG24, 313 and pronunciation format in the form “PR-VR MACHINES-MMM” of the input natural language “HOW ARE YOU” is produced and transferred to pronunciation programming.

FIG. 2gg is an explanatory diagram depicting the disintegration of speech factors of pronunciation format into ‘encoded pronunciation format’ performed by language disintegration programming technology according to an embodiment of the present invention. Performance of ‘Disintegration programming pronunciation format chip’ 214 can be understood by the explanatory illustration wherein operation begins when disintegrated processed pronunciation format in the form “PR-VR MACHINES-MMM” of the input natural language “HOW ARE YOU” is absorbed and formed into coding format of the version “01-07-PN-DIN” by application of micro factors EEE-01 to EEE-24 314 using disintegration programming technology. This ‘encoded pronunciation format’ is then transferred to Internal Micro Processor (IMP) 106 for internal disintegration valuation processing for language translation.

FIG. 2h is an explanatory diagram depicting the disintegration of input natural language into speech processing factors—‘conversation format’ performed by language disintegration processing technology according to an embodiment of the present invention.

Disintegration processing technology chip 101 consists of twenty nine micro chips 102 of different disintegration factors of the technology. These micro chips 102 have been designed with appropriate role of their functions while processing the technology. ‘Disintegration conversation format chip’ 215 is one of them which performs the processing of input natural language into conversation format by using internal micro factors or functions, FF1 to FF24, 315 and transfers the same to conversation programming. ‘Disintegration conversation format chip’ 215 activates to start the functions of micro factors, HH1 to HH24, 315 with the input of natural language which operate and control the entire processing systematically according to the protocol formation of the conversation processing factors. These factors 315 adjusted automatically to work either collectively or individually according to the situation. The main object of these conversation processing factors 315 is to achieve the solution for the given targets and commands from the speech factors of the technology for further navigating and processing of the input language conversation format according to the disintegration programming technology. The entire process is organized and controlled by input processing format of conversation microchip 215 and its micro factors or functions 315.

Performance of ‘Disintegration conversation format chip’ 215 can be understood by the explanatory illustration wherein operation begins when an input natural language “HOW ARE YOU” namely in English, is received. Input language speech factors processing is performed by using micro factors HH1 to HH24, 315 and conversation format in the form “CN-VM MACHINES-MMM” of the input natural language “HOW ARE YOU” is produced and transferred to conversation programming.

FIG. 2hh is an explanatory diagram depicting the disintegration of speech factors of conversation into ‘encoded conversation format’ performed by language disintegration programming technology according to an embodiment of the present invention. Performance of ‘Disintegration programming conversation format chip’ 216 can be understood by the explanatory illustration wherein operation begins when disintegrated processed conversation format in the form “CN-VM MACHINES-MMM” of the input natural language “HOW ARE YOU” is absorbed and formed into coding format of the version “01-08-CN-DIN” by application of micro factors FFF-01 to FFF-24 316 using disintegration programming technology. This ‘encoded conversation format’ is then transferred to Internal Micro Processor (IMP) 106 for internal disintegration valuation processing for language translation.

FIG. 2i is an explanatory diagram depicting the disintegration of input natural language into operating supporting processing factors—‘application format’ performed by language disintegration processing technology according to an embodiment of the present invention.

Disintegration processing technology chip 101 consists of twenty nine micro chips 102 of different disintegration factors of the technology. These micro chips 102 have been designed with appropriate role of their functions while processing the technology. ‘Disintegration application format chip’ 217 is one of them which performs the processing of input natural language into ‘application format’ by using internal micro factors or functions, II1 to II24, 317 and transfers the same to application programming. ‘Disintegration application format chip’ 217 activates to start the functions of micro factors, I11 to II24, 317 with the input of natural language which operate and control the entire processing systematically according to the protocol formation of the application processing factors. These factors 317 adjusted automatically to work either collectively or individually according to the situation. The main object of these application processing factors 317 is to achieve the solution for the given targets and commands from the operating supporting factors of the technology for further navigating and processing of the input language application format according to the disintegration programming technology. The entire process is organized and controlled by input processing format of application microchip 217 and its micro factors or functions 317.

Performance of ‘Disintegration application format chip’ 217 can be understood by the explanatory illustration wherein operation begins when an input natural language “HOW ARE YOU” namely in English, is received. Input language operating supporting factors processing is performed by using micro factors II1 to II24, 317 and the input natural language “HOW ARE YOU” is processed through “AP PROCESSING TOOLS” and transferred to application programming.

FIG. 2ii is an explanatory diagram depicting the disintegration of operating supporting factors of application into ‘encoded application format’ performed by language disintegration programming technology according to an embodiment of the present invention. Performance of ‘Disintegration programming application format chip’ 218 can be understood by the explanatory illustration wherein operation begins when processed disintegrated input natural language “HOW ARE YOU” through “AP PROCESSING TOOLS” is absorbed and formed into coding format of the version “01-09-PR-DIN” by application of micro factors GGG-01 to GGG-24 318 using disintegration programming technology. This ‘encoded application format’ is then transferred to Internal Micro Processor (IMP) 106 for internal disintegration valuation processing for language translation.

FIG. 2j is an explanatory diagram depicting the disintegration of input natural language into operating supporting processing factors—‘operating system format’ performed by language disintegration processing technology according to an embodiment of the present invention.

Disintegration processing technology chip 101 consists of twenty nine micro chips 102 of different disintegration factors of the technology. These micro chips 102 have been designed with appropriate role of their functions while processing the technology. ‘Disintegration operating system format chip’ 219 is one of them which performs the processing of input natural language into operating system format by using internal micro factors or functions, JJ1 to JJ24, 319 and transfers the same to operating system programming. ‘Disintegration operating system format chip’ 219 activates to start the functions of micro factors, JJ1 to JJ24, 319 with the input of natural language which operate and control the entire processing systematically according to the protocol formation of the operating system processing factors. These factors 319 adjusted automatically to work either collectively or individually according to the situation. The main object of these operating system processing factors 319 is to achieve the solution for the given targets and commands from the operating supporting factors of the technology for further navigating and processing of the input language operating system format according to the disintegration programming technology. The entire process is organized and controlled by input processing format of operating system microchip 219 and its micro factors or functions 319.

Performance of ‘Disintegration operating system format chip’ 219 can be understood by the explanatory illustration wherein operation begins when an input natural language “HOW ARE YOU” namely in English, is received. Input language operating supporting factors processing is performed by using micro factors JJ1 to JJ24, 319 and input natural language “HOW ARE YOU” is processed through “OS PROCESSING TOOLS” and transferred to application programming.

FIG. 2jj is an explanatory diagram depicting the disintegration of operating supporting factors of application into ‘encoded operating system format’ performed by using language disintegration programming technology according to an embodiment of the present invention. Performance of ‘Disintegration programming operating system format chip’ 220 can be understood by the explanatory illustration wherein operation begins when processed disintegrated input natural language “HOW ARE YOU” through “OS PROCESSING TOOLS” is absorbed and formed into coding format of the version “01-10-PR-DIN” by operating system of micro factors HHH-01 to HHH-24 320 using disintegration programming technology. This ‘encoded operating system format’ is then transferred to Internal Micro Processor (IMP) 106 for internal disintegration valuation processing for language translation.

FIG. 2k is an explanatory diagram depicting the disintegration of input natural language into operating supporting processing factors—‘search engine format’ performed by language disintegration processing technology according to an embodiment of the present invention.

Disintegration processing technology chip 101 consists of twenty nine micro chips 102 of different disintegration factors of the technology. These micro chips 102 have been designed with appropriate role of their functions while processing the technology. ‘Disintegration search engine format chip’ 221 is one of them which performs the processing of input natural language into search engine format by using internal micro factors or functions, KK1 to KK24, 321 and transfers the same to search engine programming. ‘Disintegration search engine format chip’ 221 activates to start the functions of micro factors, KK1 to KK24, 321 with the input of natural language which operate and control the entire processing systematically according to the protocol formation of the search engine processing factors. These factors 321 adjusted automatically to work either collectively or individually according to the situation. The main object of these search engine processing factors 321 is to achieve the solution for the given targets and commands from the operating supporting factors of the technology for further navigating and processing of the input language search engine format according to the disintegration programming technology. The entire process is organized and controlled by input processing format of search engine microchip 221 and its micro factors or functions 321.

Performance of ‘Disintegration search engine format chip’ 221 can be understood by the explanatory illustration wherein operation begins when an input natural language “HOW ARE YOU” namely in English, is received. Input language operating supporting factors processing is performed by using micro factors KK1 to KK24, 321 and input natural language “HOW ARE YOU” is processed through “SE PROCESSING TOOLS” and transferred to application programming.

FIG. 2kk is an explanatory diagram depicting the disintegration of operating supporting factors of application into ‘encoded search engine format’ performed by language disintegration programming technology according to an embodiment of the present invention. Performance of ‘Disintegration programming search engine format chip’ 222 can be understood by the explanatory illustration wherein operation begins when processed disintegrated input natural language “HOW ARE YOU” through “SE PROCESSING TOOLS” is absorbed and formed into coding format of the version “01-11-SE-DIN” by search engine of micro factors III-01 to III-24 322 using disintegration programming technology. This ‘encoded search engine format’ is then transferred to Internal Micro Processor (IMP) 106 for internal disintegration valuation processing for language translation.

FIG. 2l is an explanatory diagram depicting the disintegration of input natural language into operating supporting processing factors—‘colloquial language format’ performed by language disintegration processing technology according to an embodiment of the present invention.

Disintegration processing technology chip 101 consists of twenty nine micro chips 102 of different disintegration factors of the technology. These micro chips 102 have been designed with appropriate role of their functions while processing the technology. ‘Disintegration colloquial language format chip’ 223 is one of them which performs the processing of input natural language into colloquial language format by using internal micro factors or functions, LL1 to LL24, 323 and transfers the same to colloquial language programming. ‘Disintegration colloquial language format chip’ 223 activates to start the functions of micro factors, LL1 to LL24, 323 with the input of natural language which operate and control the entire processing systematically according to the protocol formation of the colloquial language processing factors. These factors 323 adjusted automatically to work either collectively or individually according to the situation. The main object of these colloquial language processing factors 323 is to achieve the solution for the given targets and commands from the operating supporting factors of the technology for further navigating and processing of the input language colloquial language format according to the disintegration programming technology. The entire process is organized and controlled by input processing format of colloquial language microchip 223 and its micro factors or functions 323.

Performance of ‘Disintegration colloquial language format chip’ 223 can be understood by the explanatory illustration wherein operation begins when an input natural language “HOW ARE YOU” namely in English, is received. Input language operating supporting factors processing is performed by using micro factors LL1 to LL24, 323 and input natural language “HOW ARE YOU” is processed through “CL PROCESSING TOOLS” and transferred to application programming.

FIG. 211 is an explanatory diagram depicting the disintegration of operating supporting factors of application into ‘encoded colloquial language format’ performed by language disintegration programming technology according to an embodiment of the present invention. Performance of ‘Disintegration programming colloquial language format chip’ 224 can be understood by the explanatory illustration wherein operation begins when processed disintegrated input natural language “HOW ARE YOU” through “CL PROCESSING TOOLS” is absorbed and formed into coding format of the version “01-12-CL-DIN” by colloquial language of micro factors JJJ-01 to JJJ-24 324 using disintegration programming technology. This ‘encoded colloquial language format’ is then transferred to Internal Micro Processor (IMP) 106 for internal disintegration valuation processing for language translation.

FIG. 2m is an explanatory diagram depicting the disintegration of input natural language into primary processing factors ‘language chip format’, which is processed and programmed into ‘encoded language chip format’ performed by language disintegration processing and programming technology according to an embodiment of the present invention. Primary processing factors directly influence input natural language processing with proper application of respective micro factors collectively or separately according to the situation. Performance of ‘Disintegration language format chip’ 225 e.g. multilingual language chip, selective language chip, bilingual language chip and lingual language chip can be understood by the explanatory illustration wherein operation begins when an input natural language “HOW ARE YOU” namely in English, is received. Processing and programming of input language primary processing factors is performed by using micro factors LLL1 to LLL24, 325 and processed language chip format of the input natural language “HOW ARE YOU” is absorbed and formed into coding format of the version “IL-01-PC+PR-DIN” using disintegration programming technology.

FIG. 2n is an explanatory diagram depicting the disintegration of input natural language into primary processing factors ‘voice recognition format’, which is processed and programmed into ‘encoded voice recognition format’ performed by language disintegration processing and programming technology according to an embodiment of the present invention. Primary processing factors directly influence input natural language processing with proper application of respective micro factors collectively or separately according to the situation. Performance of ‘Disintegration voice recognition format chip’ 226 can be understood by the explanatory illustration wherein operation begins when an input natural language “HOW ARE YOU” namely in English, is received. Processing and programming of input language primary processing factors is performed by using micro factors MMM1 to MMM24, 326 and processed selective language format of the input natural language “HOW ARE YOU” is absorbed and formed into coding format of the version “VR-01-PC+PR-DIN” using disintegration programming technology.

FIG. 2o is an explanatory diagram depicting the disintegration of input natural language into primary processing factors ‘translating format’, which is processed and programmed into ‘encoded translating language format’ performed by language disintegration processing and programming technology according to an embodiment of the present invention. Primary processing factors directly influence input natural language processing with proper application of respective micro factors collectively or separately according to the situation. Performance of ‘Disintegration translating language format chip’ 227 can be understood by the explanatory illustration wherein operation begins when an input natural language “HOW ARE YOU” namely in English, is received. Processing and programming of input language primary processing factors is performed by using micro factors KKK1 to KKK24, 327 and processed selective language format of the input natural language “HOW ARE YOU” is absorbed and formed into coding format of the version “TR-01-PC+PR-DIN” using disintegration programming technology.

FIG. 2p is an explanatory diagram depicting the disintegration of input natural language into primary processing factors ‘type of chip and technology format’, which is processed and programmed into ‘encoded type of chip and technology format’ performed by language disintegration processing and programming technology according to an embodiment of the present invention. Primary processing factors directly influence input natural language processing with proper application of respective micro factors collectively or separately according to the situation. Performance of ‘Disintegration type of chip and technology format chip’ 228 e.g. multilingual language chip, selective language chip, bilingual language chip and lingual language chip can be understood by the explanatory illustration wherein operation begins when an input natural language “HOW ARE YOU” namely in English, is received. Processing and programming of input language primary processing factors is performed by using micro factors NNN1 to NNN24, 328 and processed type of chip and technology format of the input natural language “HOW ARE YOU” is absorbed and formed into coding format of the version “CT-0′-PC+PR-DIN” using disintegration programming technology.

FIG. 2q is an explanatory diagram depicting the disintegration of input natural language into primary processing factors ‘transfer format’, which is processed and programmed into ‘encoded transfer language format’ performed by language disintegration processing and programming technology according to an embodiment of the present invention. Primary processing factors directly influence input natural language processing with proper application of respective micro factors collectively or separately according to the situation. Performance of ‘Disintegration transfer language format chip’ 229 can be understood by the explanatory illustration wherein operation begins when an input natural language “HOW ARE YOU” namely in English, is received. Processing and programming of input language primary processing factors is performed using micro factors OOO1 to OOO24, 329 and processed transfer language format of the input natural language “HOW ARE YOU” is absorbed and formed into coding format of the version “TR-01-PC+PR-DIN” using disintegration programming technology.

### Internal Micro Processor (Imp) for Natural Language Integration and Disintegration:

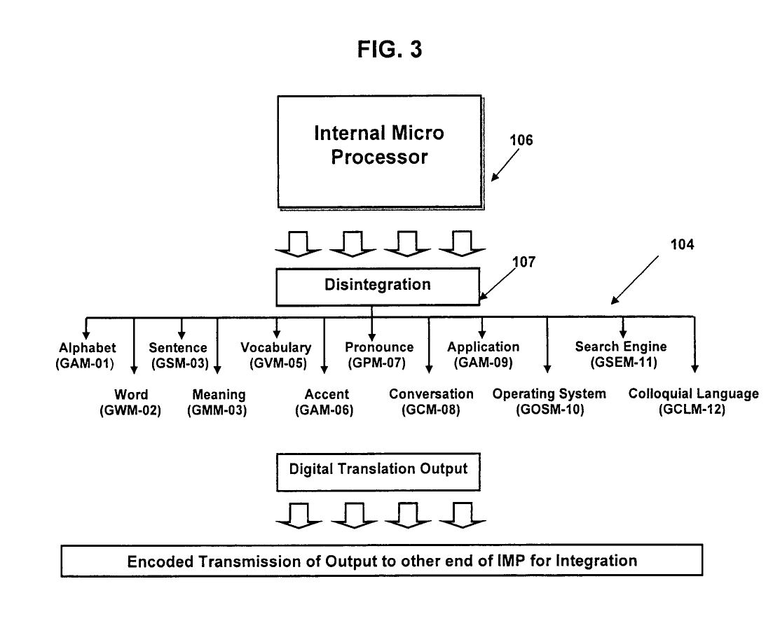

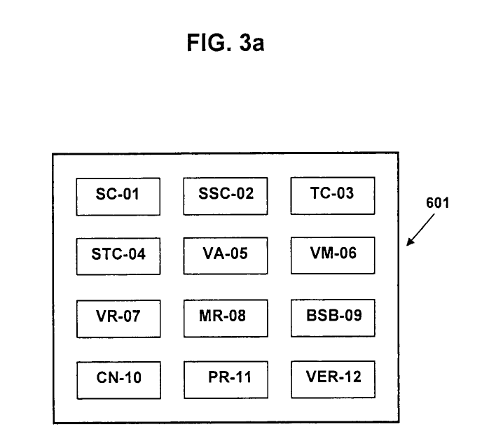

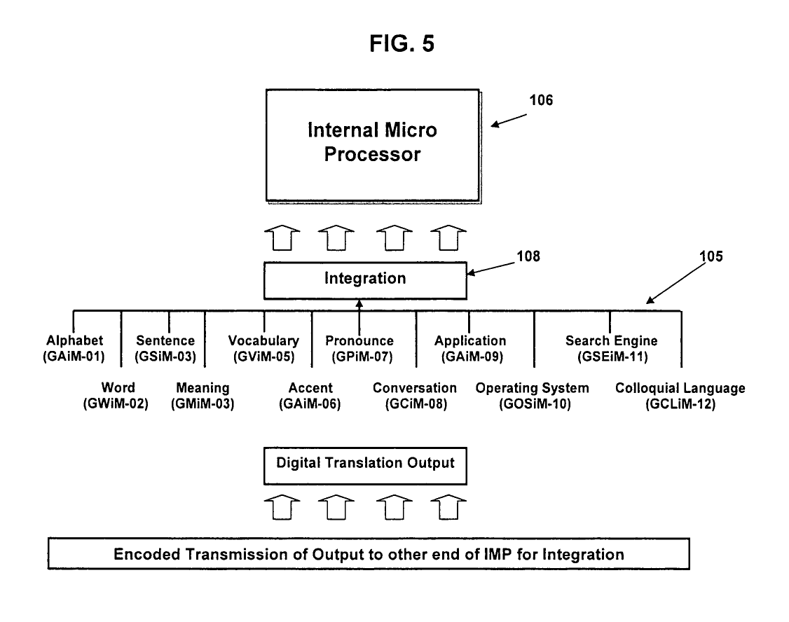

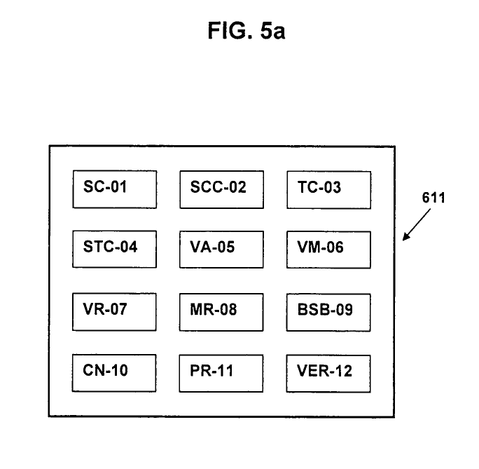

Internal Micro Processor (IMP) 106 acts as an intermediary between Integrated Chip 101 which comprises twenty nine micro chips 102, 103 and their processing. Its role is pivotal in the inter language translation technology of natural language integration and disintegration processing technologies. Internal micro processing is internally connected with the Integrated Chip 101 whereby:
i) Alphabets of global natural languages are programmed and coded into this Internal Micro Processor (IMP) 106.
ii) Words of global natural languages are programmed and coded into this Internal Micro Processor (IMP) 106.
iii) Sentence formations of global natural languages are coded into this Internal Micro Processor (IMP) 106.
iv) Meanings of global natural languages are coded into this Internal Micro Processor (IMP) 106.
v) Vocabularies of global natural languages are coded into this Internal Micro Processor (IMP) 106.
vi) Accents of global natural languages are recorded into this Internal Micro Processor (IMP) 106.
vii) Styles of pronunciation of global natural languages are recorded into this Internal Micro Processor (IMP) 106.
viii) Conversation procedures of global natural languages are recorded into this Internal Micro Processor (IMP) 106.
ix) Applications of global natural languages are designed into this Internal Micro Processor (IMP) 106.
x) Operating systems of Integrated Chip are designed into this Internal Micro Processor (IMP) 106.
xi) Search engines of translating and meaning directories are designed into this Internal Micro Processor (IMP) 106.
xii) Colloquial languages meaning directories of global natural languages are designed into this Internal Micro Processor (IMP) 106.
   These twelve language factors as depicted in FIG. 3 and FIG. 5 are collectively processed for language translation technology into Internal Micro Processor (IMP) 106.

FIG. 3a is a block diagram of Internal Micro Processor (IMP) sub-tools 601 for disintegrated language factors of source spoken language input. The primary object of the Internal Micro Processor (IMP) sub-tools 601 is to work as a bridge between Internal Micro Processor (IMP) disintegration processing input language valuation 107 and Internal Micro Processor (IMP) integration processing output language valuation 108 from one end to other end. Internal Micro Processor (IMP) sub-tools 601 of disintegration processing technology are shown into twelve factors of disintegrated delivered language brought under single format of Internal Micro Processor (IMP) sub-tools networking system 601. The output of disintegration processing technology is transferred to Internal Micro Processor (IMP) 106 for further processing of natural language disintegration processing technology and language translation disintegration processing technology. These disintegrated language factors are collectively processed through Internal Micro Processor (IMP) encoded format by Internal Micro Processor (IMP) sub-tools valuation processors as shown in Table I:

TABLE I

| Input language disintegration | Internal Micro Processor (IMP) sub tools |
|---|---|
| processing encoded factors | disintegration valuation processors |
| Alphabet (AL-01) | Systems Centers (SC-01) |
| Word (WR-02) | Sub System Centers (SSC-02) |
| Sentence (ST-03) | Tool Center (TC-03) |
| Meaning (MN-04) | Sub Tools Centers (STC-04) |
| Accent (AC-05) | Voice Accuracy (VA-05) |
| Conversation (CN-06) | Voice Modulation (VM-06) |
| Pronunciation (PR-07) | Voice Recording (VR-07) |
| Vocabulary (VC-08) | Module Recording (MR-08) |
| Application (AP-09) | Boats & Sub Boats (BSB-09) |
| Operating System (OS-10) | Connectors (CN-10) |
| Search Engine (SE-11) | Protocol (PR-11) |
| Colloquial Language (CL-12) | Version (VR-12) |

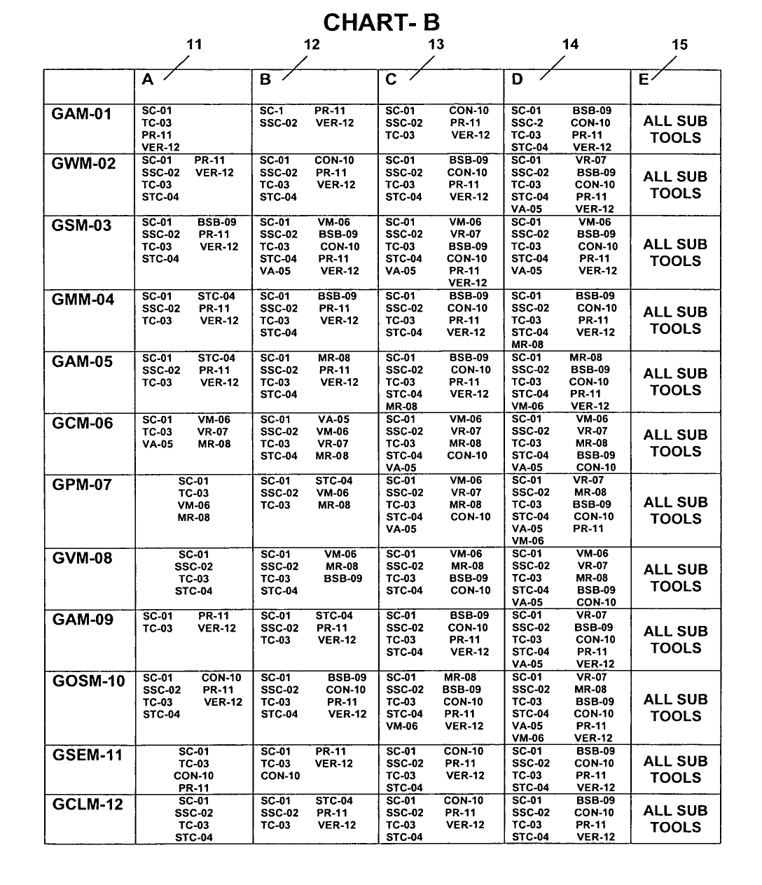

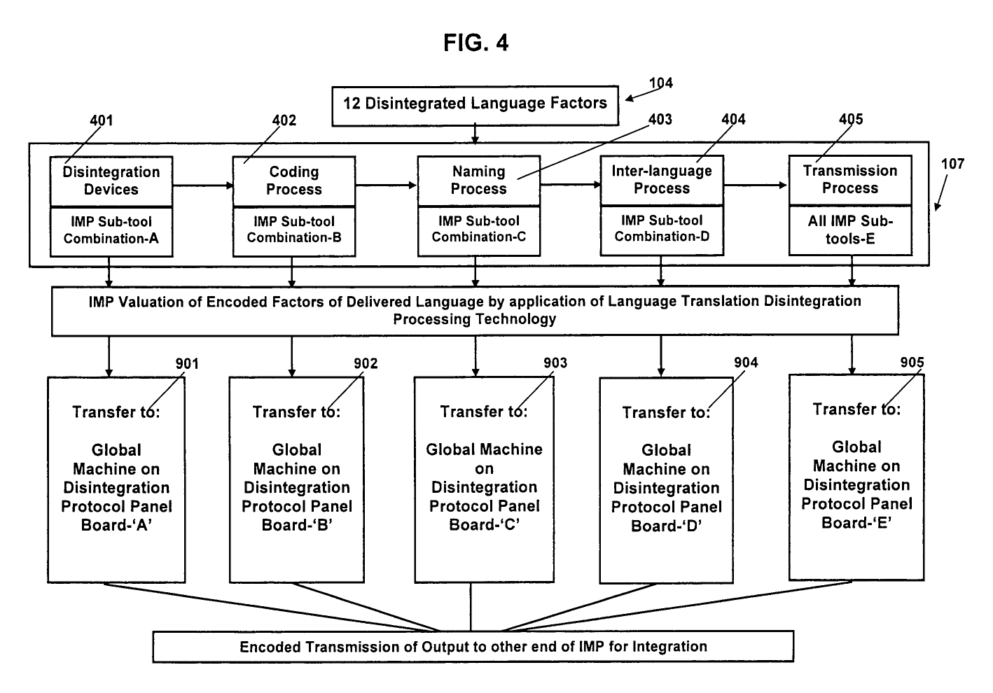

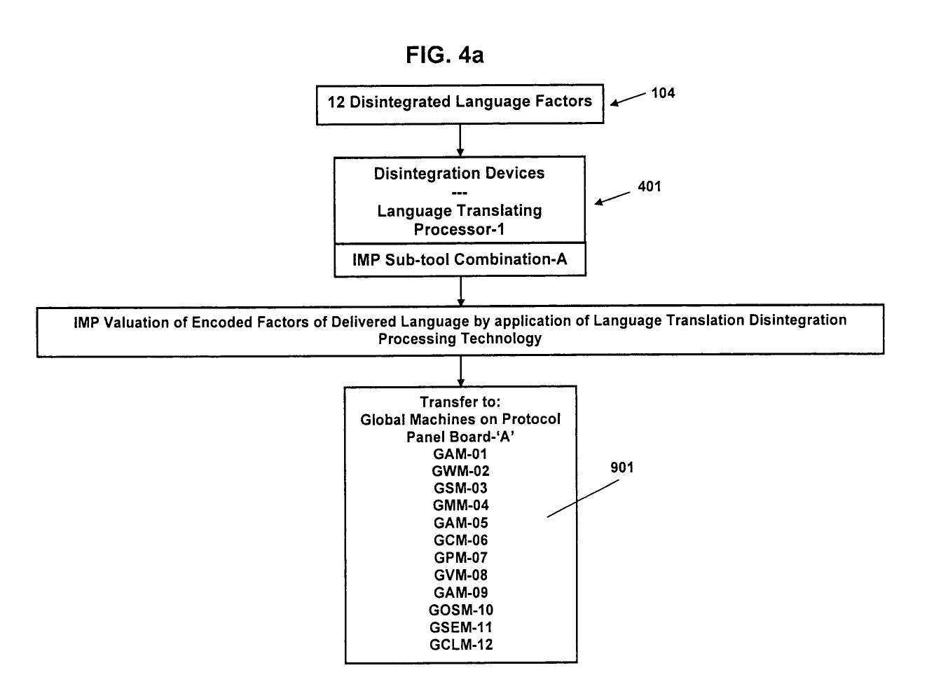

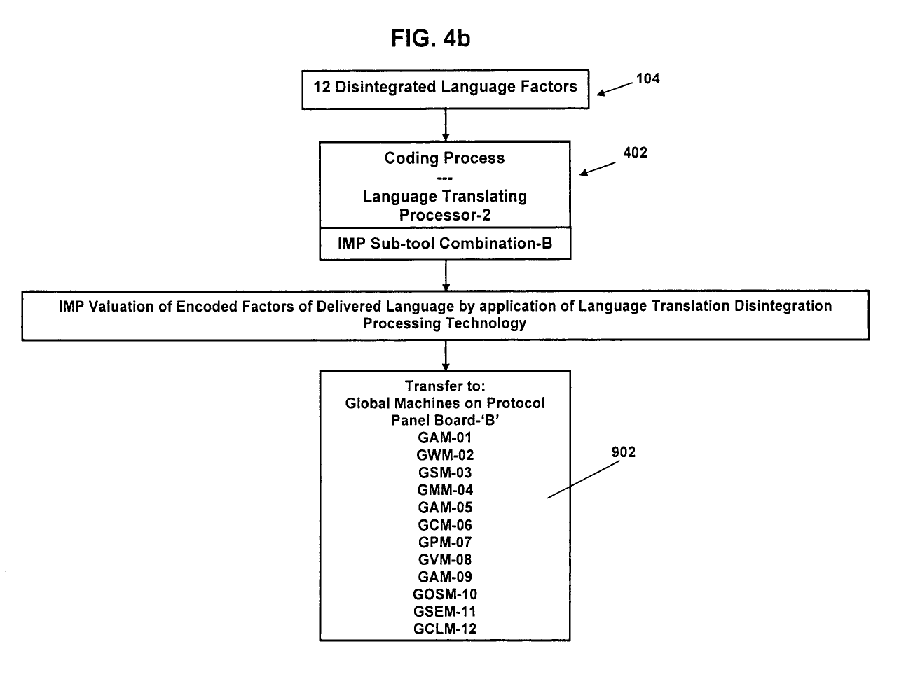

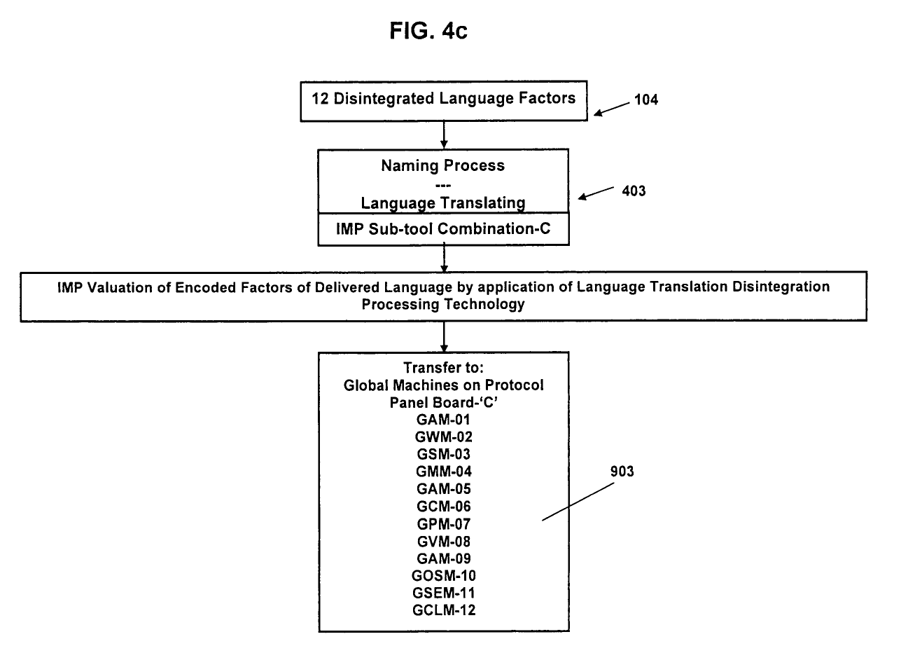

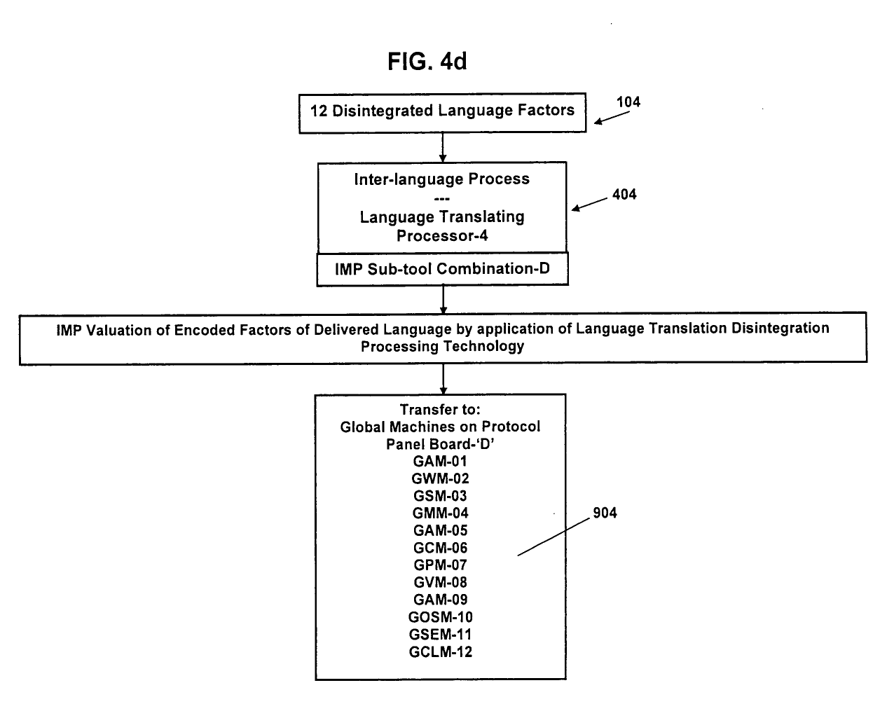

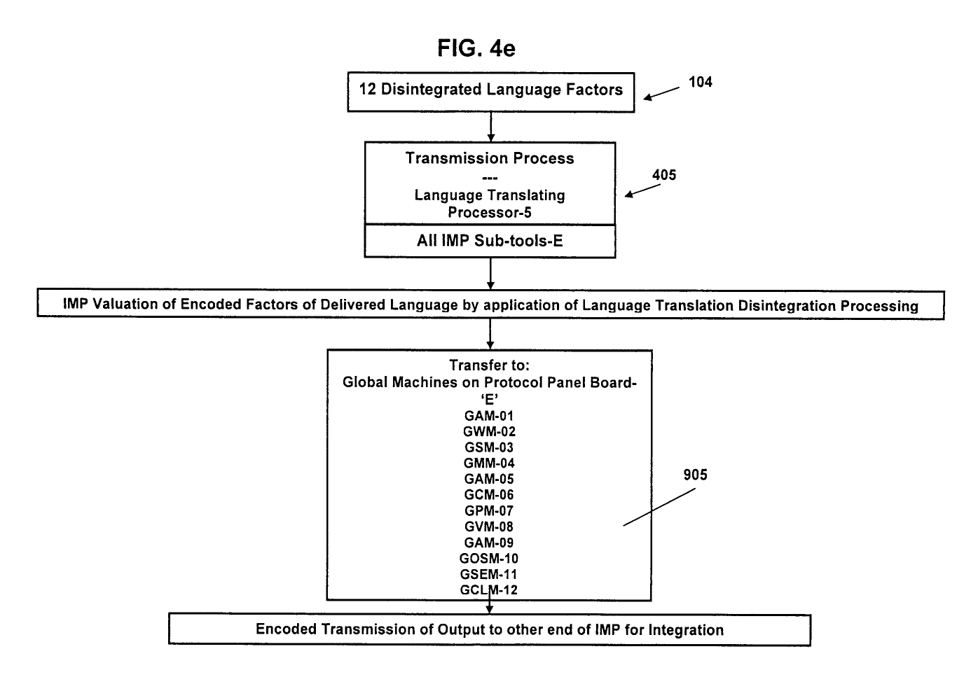

FIG. 4 is a block diagram depicting the five stages 401, 402, 403, 404, 405 internal disintegration processing of language translating processors of Internal Micro Processor (IMP) 106 for internal processing of the received output of the delivered natural language disintegrated factors into global language format for requested language translation. Internal Micro Processor (IMP) 106 is also known as language translating technology, the primary object thereof is to translate the input natural language into another output natural language through encoded language format of natural language processing technology.

It shows the entire process of the Internal Micro Processor (IMP) 107 disintegration processing technology. To explain this, the output of entire disintegration processing and programming performed and explained in FIGS. 2a to 2q, i.e. disintegrated language factors 104 of input language, is collectively transferred to Internal Micro Processor (IMP) 107 disintegration processing for language translation. The Internal Micro Processor (IMP) 106 is designed internally into five stages 401, 402, 403, 404, 405 of language translating processors to collectively process the twelve disintegrated language factors 104 of input language. Such disintegrated factors 104 of Input language further translated through these five stages 401, 402, 403, 404, 405 of encoded format of Internal Micro Processor (IMP) 107, viz.
i) disintegration devices format 401;
ii) coding format 402;
iii) naming format 403;
iv) inter language translation format 404; and
v) processor end transmission format 405;
   by their respective sub-tools 601. After going through the five stages 401, 402, 403, 404, 405 Internal Micro Processor (IMP) disintegration processing 107, the entire digital translation output of respective format of coding (Global Language Format) is transmitted from one end to integration processing of language translating processors of Internal Micro Processor (IMP) 106.

### Global Language Machine—Encoded Global Language Disintegration Format:

Global Language Machine (GLM) at one end consists of global language information for processing twelve language factors as listed in Table II by using the language disintegration technology as well as language disintegration transmitting technology. Each format is disintegrated and designed through five stages/processors of Internal Micro Processor (IMP) 107 into twelve disintegrated language factors. These twelve disintegrated language factors are further delivered to Global Language Machine (GLM) for further processing to convert them into respective encoded global language disintegrated format 901, 902, 903, 904, 905 as listed in Table II for language translation.

TABLE II
Encoded Global language disintegrated format

| Language factors (Input | Encoded Global language |
|---|---|
| Source Language) | disintegrated format |
| ALPHABET | GAM-01 |
| WORD | GWM-02 |
| SENTENCE | GSM-03 |
| MEANING | GMM-04 |
| ACCENT | GAM-05 |
| CONVERSATION | GCM-06 |
| PRONUNCIATION | GPM-07 |
| VOCABULARY | GVM-08 |
| APPLICATION | GAM-09 |
| OPERATING SYSTEM | GOSM-10 |
| SEARCH ENGINE | GSEM-11 |
| COLLOQIAL LANGUAGE | GCLM-12 |

### Chart B

Chart B details the encoded values of the Internal Micro Processor (IMP) sub-tools 601 disintegration valuation processors identified against the encoded global language disintegrated format as listed in Table II. The Internal Micro Processor (IMP) 106 is designed internally into five stages 401, 402, 403, 404, 405 of language translating processors to collectively process the twelve disintegrated language factors of input language. Such disintegrated factors of Input language further processed collectively through these five stages of encoded format of Internal Micro Processor (IMP), viz.
i) disintegration devices format 401;
ii) coding format;402
iii) naming format; 403 iv) inter language translation format; 404 and
v) processor end transmission format; 405
   by their respective sub-tools combinations namely combination ‘A’ 11, combination ‘B’ 12, combination ‘C’13, combination ‘D’14 and combination ‘E’15 as shown in Chart B. Respective combinations are collectively transferred to Global Language Machine (GLM) on respective disintegration protocol boards 901, 902, 903, 904, 905 and converted into respective global language disintegration format as listed in Table II by using language disintegration translating processing as well as natural language disintegration processing for inter language translation.

FIG. 4a illustrates an explanatory diagram depicting the first stage 401 internal disintegration valuation processing of the received output of delivered natural language disintegrated factors in the form of ‘encoded language format’ performed by language translating processor I (disintegration devices of ‘language format’) 401 of Internal Micro Processor (IMP) 106 according to an embodiment of the present invention.

Performance of first stage internal disintegration processing of language translating processor I 401 of Internal Micro Processor (IMP) 107 can be understood by the explanatory illustration wherein operation begins when the output of twelve delivered natural language disintegrated factors 104 namely:
i) encoded ‘alphabet’ format;
ii) encoded ‘word’ format;
iii) encoded ‘sentence’ format;
iv) encoded ‘meaning’ format;
v) encoded ‘pronunciation’ format;
vi) encoded ‘accent’ format;
vii) encoded ‘vocabulary’ format;
viii) encoded ‘conversation’ format;
ix) encoded ‘application’ format;
x) encoded ‘operating system’ format;
xi) encoded ‘search engine’ format; and
xii) encoded ‘colloquial language’ format;
   is received and further processed by natural language disintegration processing technology and language translation disintegration processing technology at this stage. Twelve delivered natural language disintegrated factors 104 delivered to Internal Micro Processor (IMP) sub-tools 601 disintegration networking as depicted in FIG. 3a and processed into combination—A 11 of sub-tools ‘disintegration devices encoded format’ 401 by respective Internal Micro Processor (IMP) sub-tools valuation processors as listed in Table I. The combination—A 11 of sub-tools ‘disintegration devices encoded format’ 401 is explained in CHART B.

Thereafter, combination—A 11 of sub-tools ‘disintegration devices encoded format’ 401 transferred to Global Language Machine (GLM) on disintegration protocol panel board ‘A’ 901. Each disintegration protocol panel board (PPB) 901, 902, 903, 904, 905 comprises upto twenty four processing panel boards which are designed to process from one letter word to maximum twenty four letter word of global languages. Each protocol panel board (PPB)) 901, 902, 903, 904, 905 of Internal Micro Processor (IMP) disintegration processing technology is programmed according to the protocol format of entire Inter-Language Translation. These protocol panel boards) 901, 902, 903, 904, 905 are programmed with global language disintegration factors with necessary language disintegration translating processing as well as natural language disintegration processing for digital application of voice recognition output of absorbed disintegration factors of delivered natural language for inter language translation wherein the combination—A 11 of sub-tools ‘disintegration devices encoded format’ 401 is converted into respective global language disintegration format as shown in Table II.

FIG. 4b illustrates an explanatory diagram depicting the second stage 402 internal disintegration valuation processing of the received output of delivered natural language disintegrated factors in the form of ‘encoded language format’ performed by language translating processor II (coding process of ‘language format’) 402 of Internal Micro Processor (IMP) 106 according to an embodiment of the present invention.

Performance of second stage internal disintegration processing of language translating processor II 402 of Internal Micro Processor (IMP) 107 can be understood by the explanatory illustration wherein operation begins when the output of twelve delivered natural language disintegrated factors 104 is received and further processed by natural language disintegration processing technology and language translation disintegration processing technology at this stage. Twelve delivered natural language disintegrated factors 104 delivered to Internal Micro Processor (IMP) sub-tools 601 disintegration networking as depicted in FIG. 3a and processed into combination—B 12 of sub-tools ‘coding format’ 402 by respective Internal Micro Processor (IMP) sub-tools disintegration valuation processors as listed in Table I. The combination—B 12 of sub-tools ‘coding format’ 402 is explained in CHART B.

Thereafter, combination—B 12 of sub-tools ‘coding format’ 402 transferred to Global Language Machine (GLM) on disintegration protocol panel board ‘B’ 902. Each disintegration protocol panel board (PPB) 901, 902, 903, 904, 905 comprises up to twenty four processing panel boards which are designed to process from one letter word to maximum twenty four letter word of global languages. These protocol panel boards (PPB) 901, 902, 903, 904, 905 are programmed with global language disintegration factors with necessary language disintegration translating processing as well as natural language disintegration processing for digital application of voice recognition output of absorbed disintegration factors of delivered natural language for inter language translation wherein the combination—B 12 of sub-tools ‘coding format’ 402 is converted into respective global language disintegration format as shown in Table

FIG. 4c illustrates an explanatory diagram depicting the third stage 403 internal disintegration valuation processing of the received output of delivered natural language disintegrated factors in the form of ‘encoded language format’ performed by language translating processor III (naming process of ‘language format’) 403 of Internal Micro Processor (IMP) 106 according to an embodiment of the present invention.

Performance of third stage internal disintegration processing of language translating processor III 403 of Internal Micro Processor (IMP) 107 can be understood by the explanatory illustration wherein operation begins when the output of twelve delivered natural language disintegrated factors 104 is received and further processed by natural language disintegration processing technology and language translation disintegration processing technology at this stage. Twelve delivered natural language disintegrated factors 104 delivered to Internal Micro Processor (IMP) sub-tools disintegration networking as depicted in FIG. 3a and processed into combination—C 13 of sub-tools ‘naming format’ by respective Internal Micro Processor (IMP) sub-tools valuation processors as listed in Table I. The combination—C 13 of sub-tools ‘naming format’ 403 is explained in CHART B.

Thereafter, combination—C 13 of sub-tools ‘naming format’ 403 transferred to Global Language Machine (GLM) on disintegration protocol panel board ‘C’ 903. Each disintegration protocol panel board (PPB) 901, 902, 903, 904, 905 comprises up to twenty four processing panel boards which are designed to process from one letter word to maximum twenty four letter word of global languages. These protocol panel boards (PPB) 901, 902, 903, 904, 905 are programmed with global language disintegration factors with necessary language disintegration translating processing as well as natural language disintegration processing for digital application of voice recognition output of absorbed disintegration factors of delivered natural language for inter language translation wherein the combination—C 13 of sub-tools ‘naming format’ 403 is converted into respective global language disintegration format as shown in Table II.

FIG. 4d illustrates an explanatory diagram depicting the fourth stage 404 internal disintegration valuation processing of the received output of delivered natural language disintegrated factors in the form of ‘encoded language format’ performed by language translating processor IV (inter language processing of ‘language format’) 404 of Internal Micro Processor (IMP) 106 according to an embodiment of the present invention.

Performance of fourth stage internal disintegration processing of language translating processor IV 404 of Internal Micro Processor (IMP) 107 can be understood by the explanatory illustration wherein operation begins when the output of twelve delivered natural language disintegrated factors 104 is received and further processed by natural language disintegration processing technology and language translation disintegration processing technology at this stage. Twelve delivered natural language disintegrated factors 104 delivered to Internal Micro Processor (IMP) sub-tools disintegration networking as depicted in FIG. 3a and processed into combination—D 14 of sub-tools ‘inter language format’ 404 by respective Internal Micro Processor (IMP) sub-tools valuation processors as listed in Table I. The combination−D 14 of sub-tools ‘inter language format’ 404 is explained in CHART B.

Thereafter, combination—D 14 of sub-tools ‘inter language formats 404 transferred to global language machine (GLM) on disintegration protocol panel board ‘D’ 904. Each disintegration protocol panel board (PPB) 901, 902, 903, 904, 905 comprises up to twenty four processing panel boards which are designed to process from one letter word to maximum twenty four letter word of global languages. These protocol panel boards (PPB) 901, 902, 903, 904, 905 are programmed with global language disintegration factors with necessary language disintegration translating processing as well as natural language disintegration processing for digital application of voice recognition output of absorbed disintegration factors of delivered natural language for inter language translation wherein the combination—D 14 of sub-tools ‘inter language format’ 404 is converted into respective global language disintegration format as shown in Table II.

FIG. 4e illustrates an explanatory diagram depicting the fifth stage 405 internal disintegration valuation processing of the received output of delivered natural language disintegrated factors in the form of ‘encoded language format’ performed by language translating processor V (encoded transmission of ‘language format’) 405 of Internal Micro Processor (IMP) 106 according to an embodiment of the present invention.

Performance of fifth stage internal disintegration processing of language translating processor V of Internal Micro Processor (IMP) 107 can be understood by the explanatory illustration wherein operation begins when the output of twelve delivered natural language disintegrated factors 104 is received and further processed by natural language disintegration processing technology and language translation disintegration processing technology at this stage. Twelve delivered natural language disintegrated factors 104 delivered to Internal Micro Processor (IMP) sub-tools disintegration networking as depicted in FIG. 3a and processed into combination—E 15 of sub-tools ‘encoded transmission format’ 405 by respective Internal Micro Processor (IMP) sub-tools valuation processors as listed in Table I. The combination—E 15 of sub-tools ‘encoded transmission format’ 405 is explained in CHART B.

Thereafter, combination—E 15 of sub-tools ‘encoded transmission format 405 transferred to Global Language Machine (GLM) on disintegration protocol panel board ‘E’ 905. Each disintegration protocol panel board (PPB) 901, 902, 903, 904, 905 comprises up to twenty four processing panel boards which are designed to process from one letter word to maximum twenty four letter word of global languages. These protocol panel boards (PPB) 901, 902, 903, 904, 905 are programmed with global language disintegration factors with necessary language disintegration translating processing as well as natural language disintegration processing for digital application of voice recognition output of absorbed disintegration factors of delivered natural language for inter language translation wherein the combination—E 15 of sub-tools ‘encoded transmission format’ 405 is converted into respective global language disintegration format as shown in Table II.

Global Language Machine—Decoded Global language integration format:

Global Language Machine (GLM) at the other end consists of global language information for processing twelve encoded global language disintegrated format as listed in Table II by using the language integration technology as well as language integration transmitting technology. These twelve encoded global language disintegrated format received at global language machine (GLM) on integration protocol panel boards (PPB) 911, 912, 913, 914, 915. Each integration protocol panel board (PPB) 901, 902, 903, 904, 905 comprises up to twenty four processing panel boards which are designed to process from one letter word to maximum twenty four letter word of global languages. These protocol panel boards (PPB) 901, 902, 903, 904, 905 are programmed with global language integration factors with necessary language integration translating processing as well as natural language integration processing for digital application of voice recognition input of absorbed encoded disintegration format of delivered natural language for inter language translation. Further, these encoded twelve global language disintegrated format received at global language machine (GLM) on integration protocol panel boards (PPB) 901, 902, 903, 904, 905 is converted into respective global language decoded integration format 911, 912, 913, 914, 915 as shown in Table III. Thereafter, the decoded global language integration format transferred to the sub-tools integration networking as depicted in FIG. 5a.

TABLE III

| Encoded Global language | Decoded Global language |
|---|---|
| disintegrated format | integrated format |
| GAM-01 | GAiM-01 |
| GWM-02 | GWiM-02 |
| GSM-03 | GSiM-03 |
| GMM-04 | GMiM-04 |
| GAM-05 | GAiM-05 |
| GCM-06 | GCiM-06 |
| GPM-07 | GPiM-07 |
| GVM-08 | GViM-08 |
| GAM-09 | GAiM-09 |
| GOSM-10 | GOSiM-10 |
| GSEM-11 | GSEiM-11 |
| GCLM-12 | GCLiM-12 |

FIG. 5a is a block diagram of Internal Micro Processor (IMP) sub tools 611 for integrated language factors of target spoken language output. The primary object of the Internal Micro Processor (IMP) sub-tools 611 is to work as a bridge between Internal Micro Processor (IMP) disintegration processing input language valuation 107 and Internal Micro Processor (IMP) integration processing output language valuation 108 from one end to other end. Internal Micro Processor (IMP) sub-tools 611 of integration processing technology are shown into twelve factors of integrated target spoken language output brought under single format of Internal Micro Processor (IMP) sub-tools networking system 611. The decoded global language integration format is transferred to Internal Micro Processor (IMP) sub-tools 611 of integration processing technology and processed through Internal Micro Processor (IMP) sub-tools 611 integration valuation processors. These decoded global language integration formats are collectively processed further into Internal Micro Processor (IMP) decoded format by Internal Micro Processor (IMP) sub-tools valuation processors as shown in Table IV.

TABLE IV

| Decoded Global language | Internal Micro Processor (IMP) sub tools |
|---|---|
| integration format | integration valuation processors |
| GAiM-01 | Systems Centers (SC-01) |
| GWiM-02 | Sub System Centers (SSC-02) |
| GSiM-03 | Tool Center (TC-03) |
| GMiM-04 | Sub Tools Centers (STC-04) |
| GAiM-05 | Voice Accuracy (VA-05) |
| GCiM-06 | Voice Modulation (VM-06) |
| GPiM-07 | Voice Recording (VR-07) |
| GViM-08 | Module Recording (MR-08) |
| GAiM-09 | Boats & Sub Boats (BSB-09) |
| GOSiM-10 | Connectors (CN-10) |
| GSEiM-11 | Protocol (PR-11) |
| GCLiM-12 | Version (VR-12) |

Thereafter, the processed integration value is transferred to programming and processing of natural language integration processing technology and language translation integration processing technology and converted into respective output language integration processing decoded factors as shown in Table V for requested target natural language translation.

TABLE V

| Internal Micro Processor (IMP) sub tools | Output language integration |
|---|---|
| integration valuation processors | processing decoded factors |
| Systems Centers (SC-01) | Alphabet (AL-01) |
| Sub System Centers (SSC-02) | Word (WR-02) |
| Tool Center (TC-03) | Sentence (ST-03) |
| Sub Tools Centers (STC-04) | Meaning (MN-04) |
| Voice Accuracy (VA-05) | Accent (AC-05) |
| Voice-Modulation (VM-06) | Conversation (CN-06) |
| Voice Recording (VR-07) | Pronunciation (PR-07) |
| Module Recording (MR-08) | Vocabulary (VC-08) |
| Boats & Sub Boats (BSB-09) | Application (AP-09) |
| Connectors (CN-10) | Operating System (OS-10) |
| Protocol (PR-11) | Search Engine (SE-11) |
| Version (VR-12) | Colloquial Language (CL-12) |

### Chart C

Chart C details the decoded values of the Internal Micro Processor (IMP) sub-tools 611 integration valuation processors identified against the decoded global language integrated format as listed in Table IV. The Internal Micro Processor (IMP) 107 is designed internally into five stages 501, 502, 503, 504, 505 of language translating processors to collectively process the twelve integrated language factors of output language. Such integrated factors of Input language further processed collectively through into five stages 501, 502, 503, 504, 505 of decoded format of Internal Micro Processor (IMP), viz.
i) processor start reception format; 501
ii) inter language translation format; 502
iii) naming format; 503
iv) decoding format; 504 and
v) integration devices format; 505
   by their respective sub-tools combinations namely combination ‘A’,21 combination ‘B’,22 combination ‘C’,23 combination ‘D’24 and combination ‘E’25 as shown in Chart C for natural language integration processing for inter language translation.

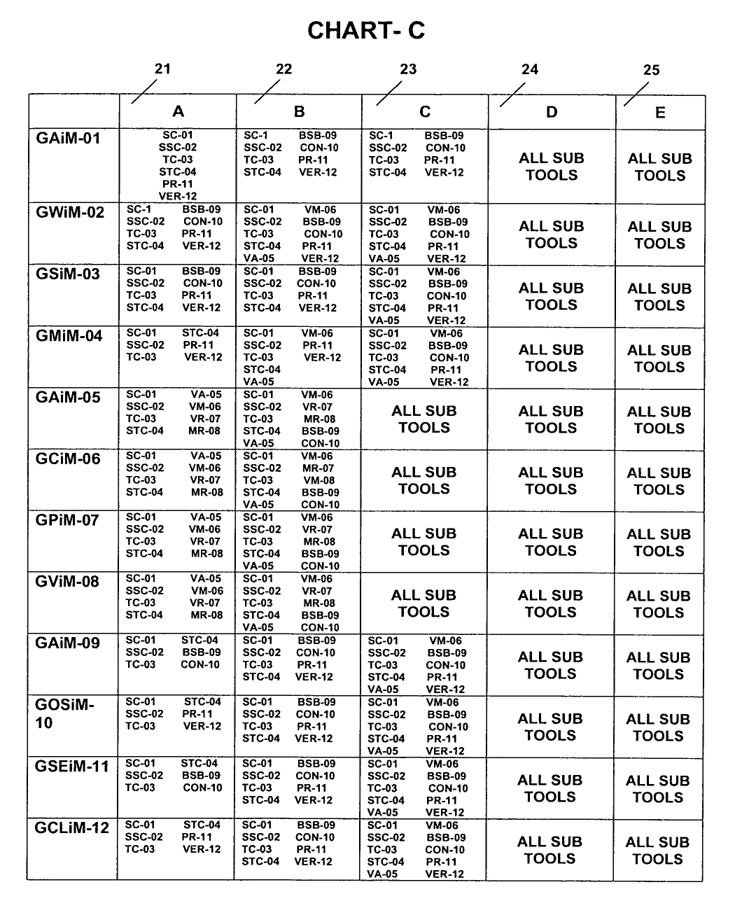

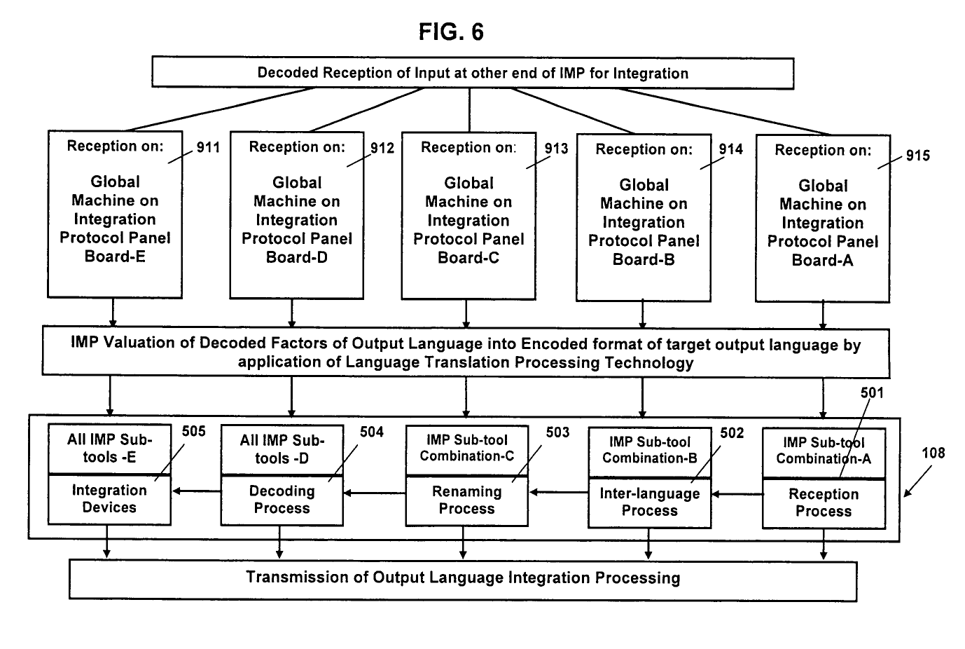

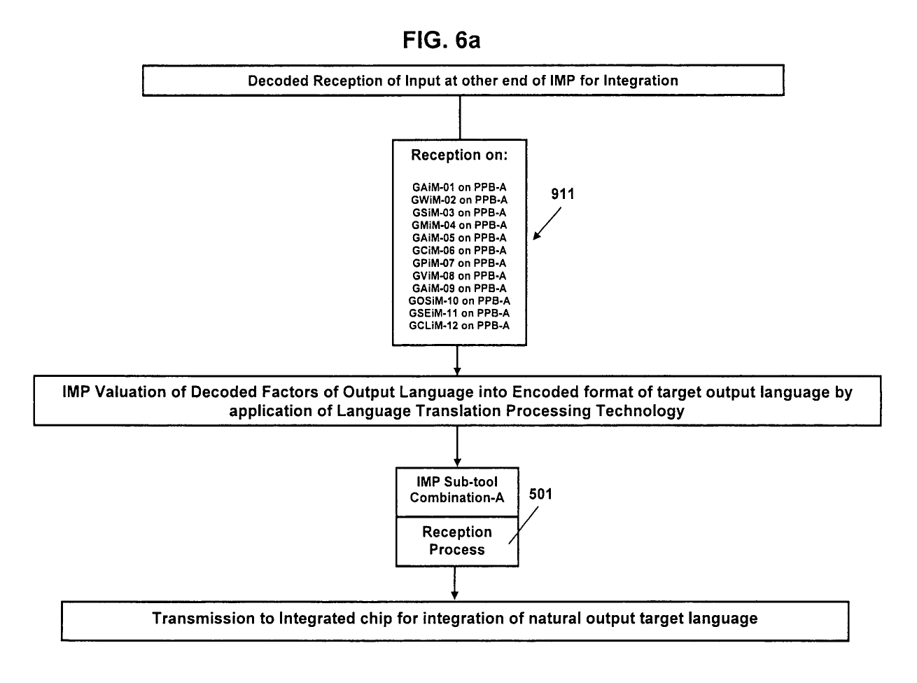

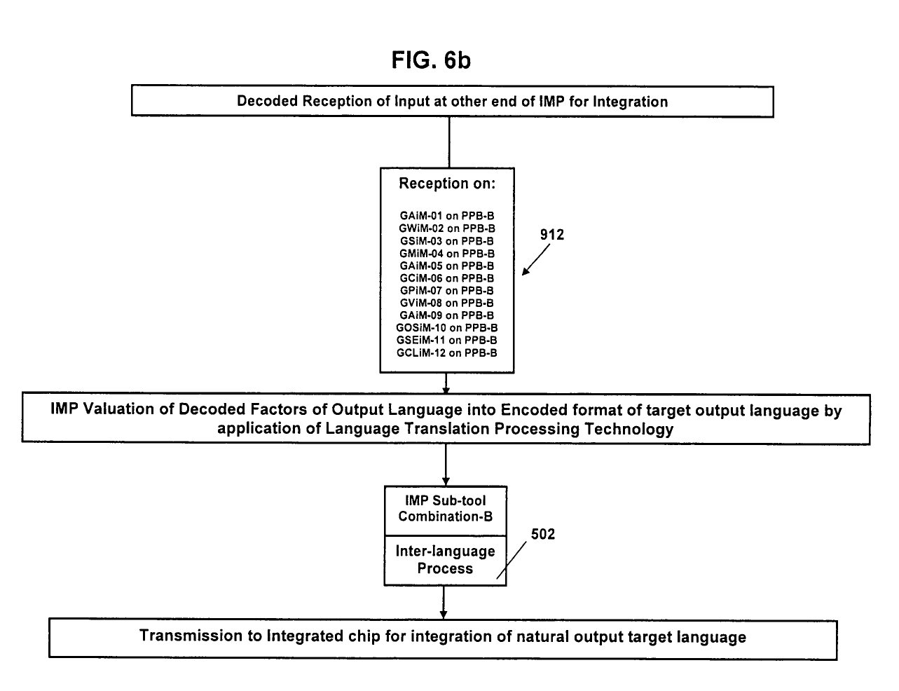

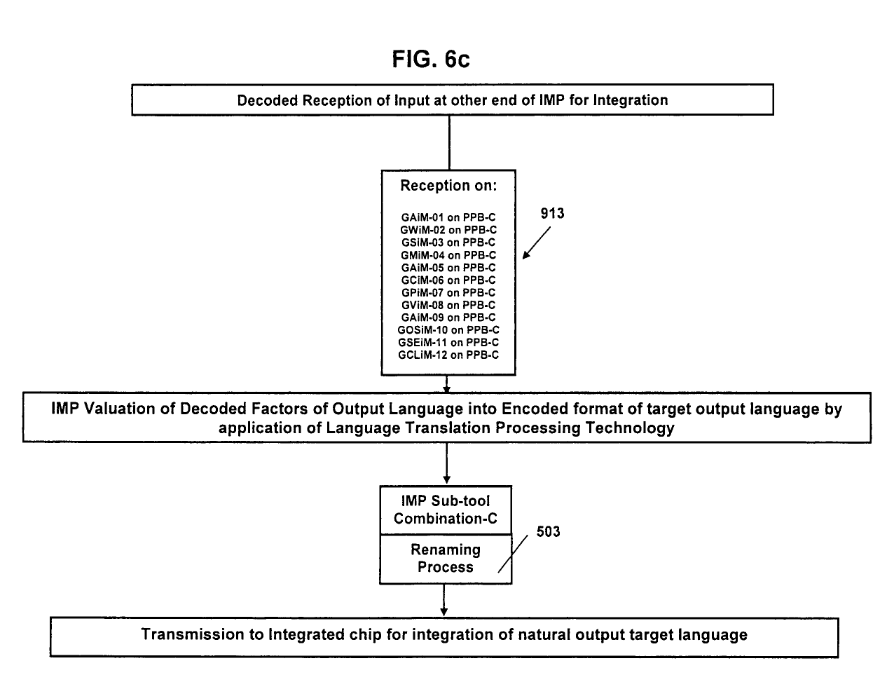

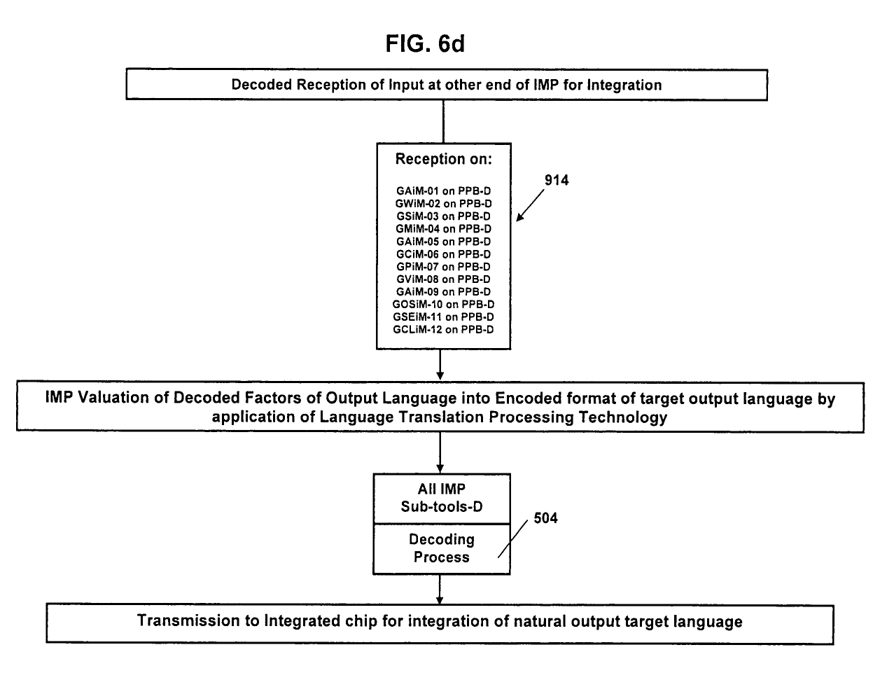

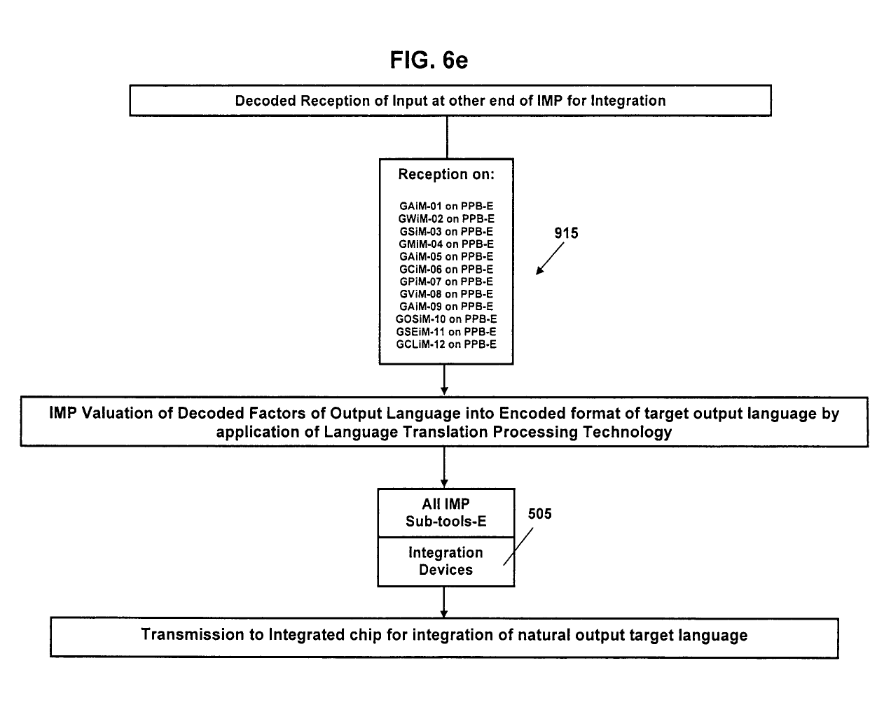

FIG. 6 is a block diagram depicting the five stages 501, 502, 503, 504, 505 internal integration processing of language translating processors of Internal Micro Processor (IMP) 108 for internal processing of the received input of the global language format into received natural language integrated format for requested language translation. Internal Micro Processor (IMP) 106 is also known as language translating technology, the primary object thereof is to translate the input of global language into another (output) language through decoded language formats of natural language processing technology.

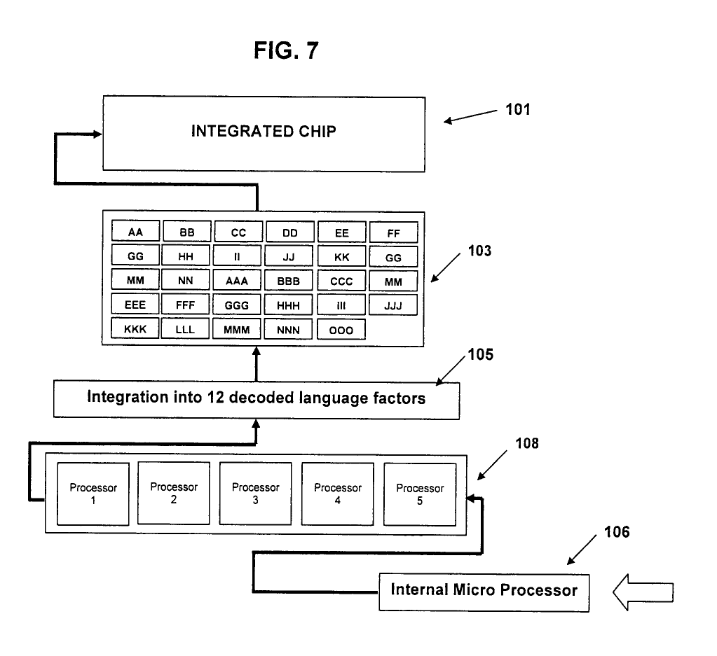

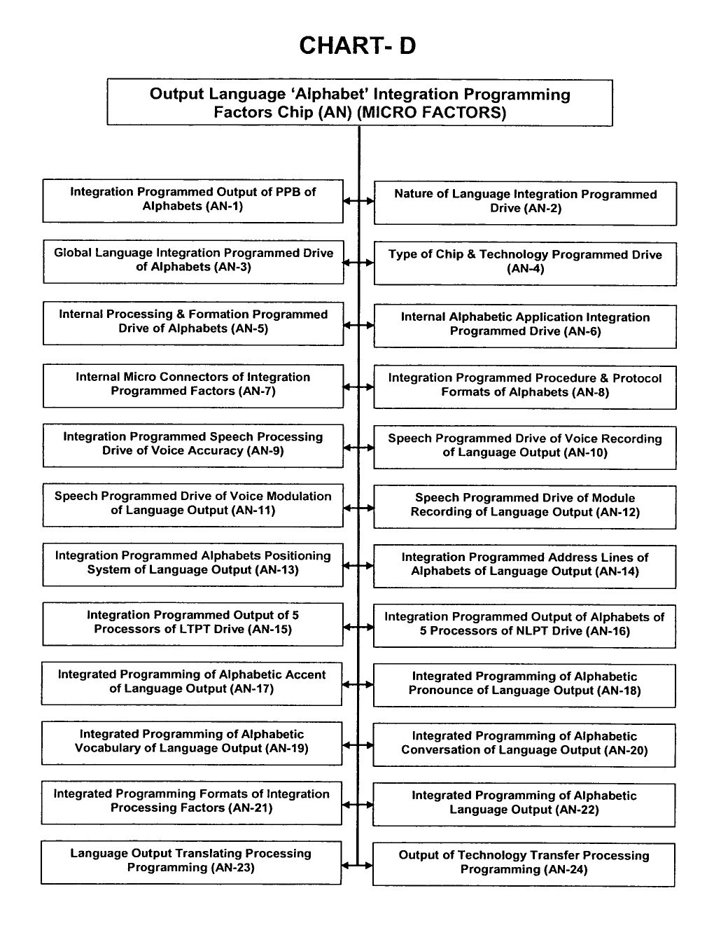

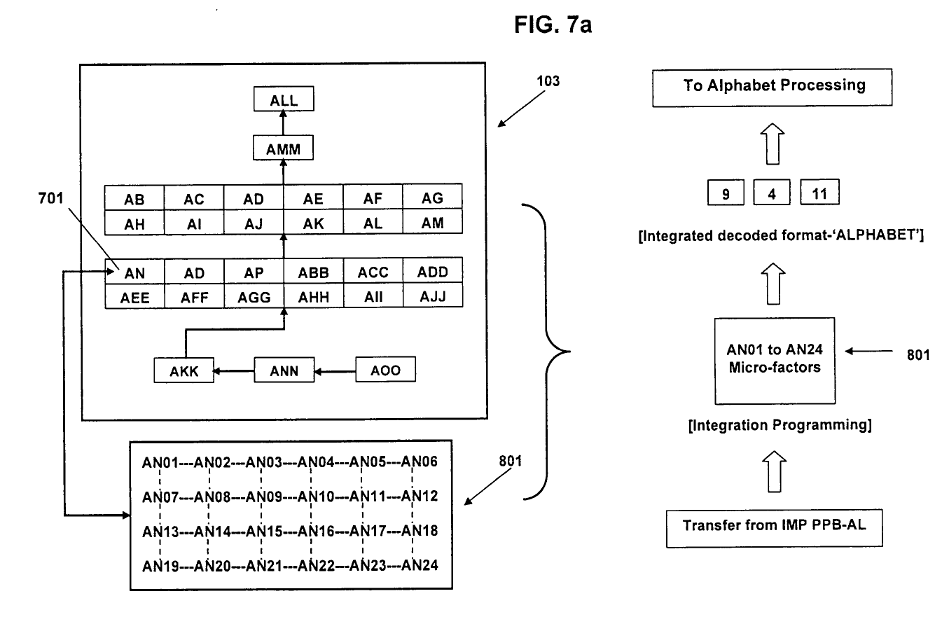

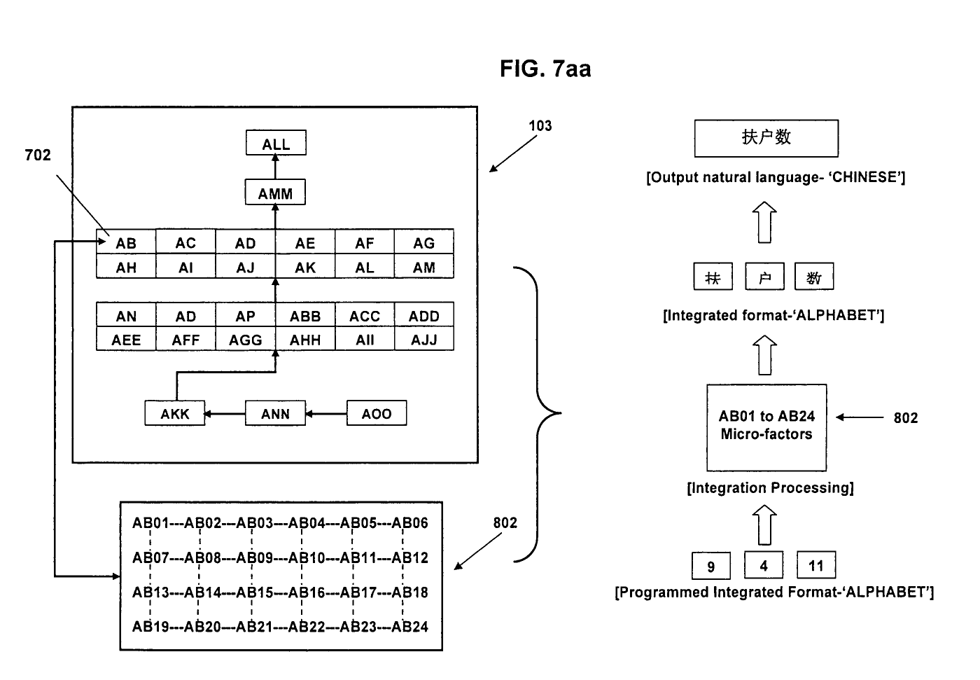

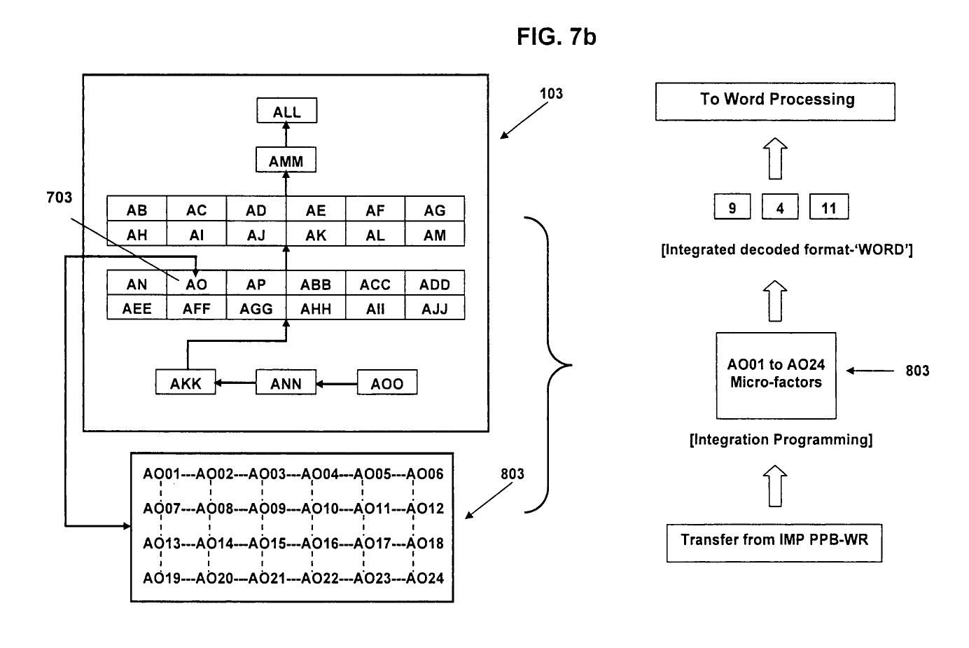

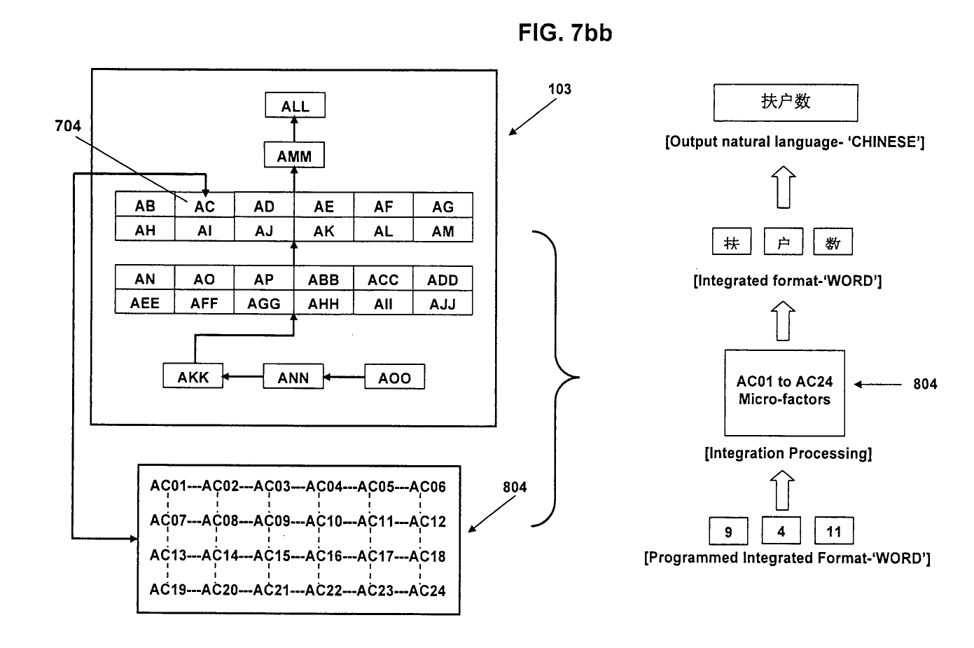

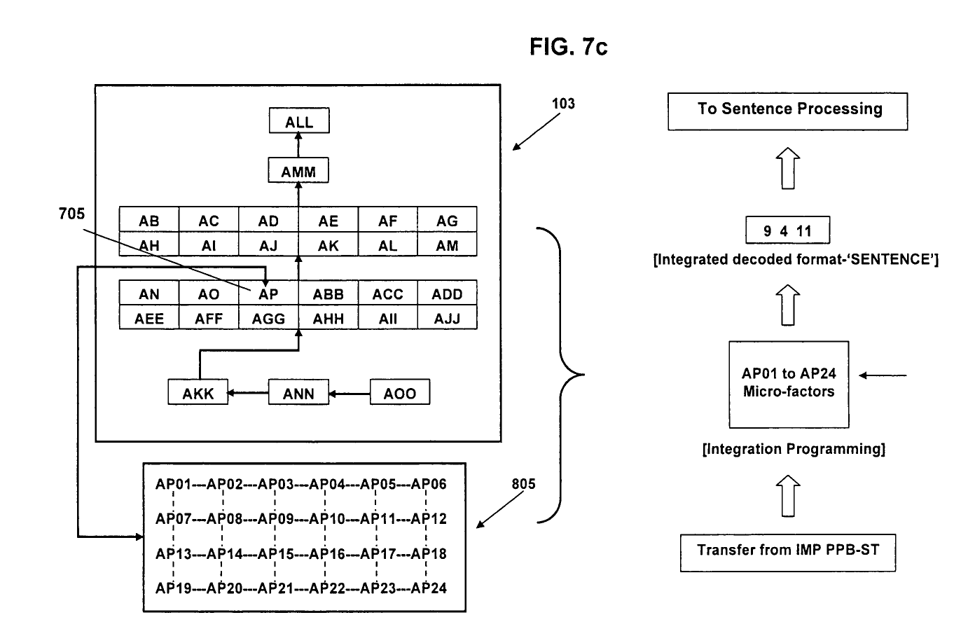

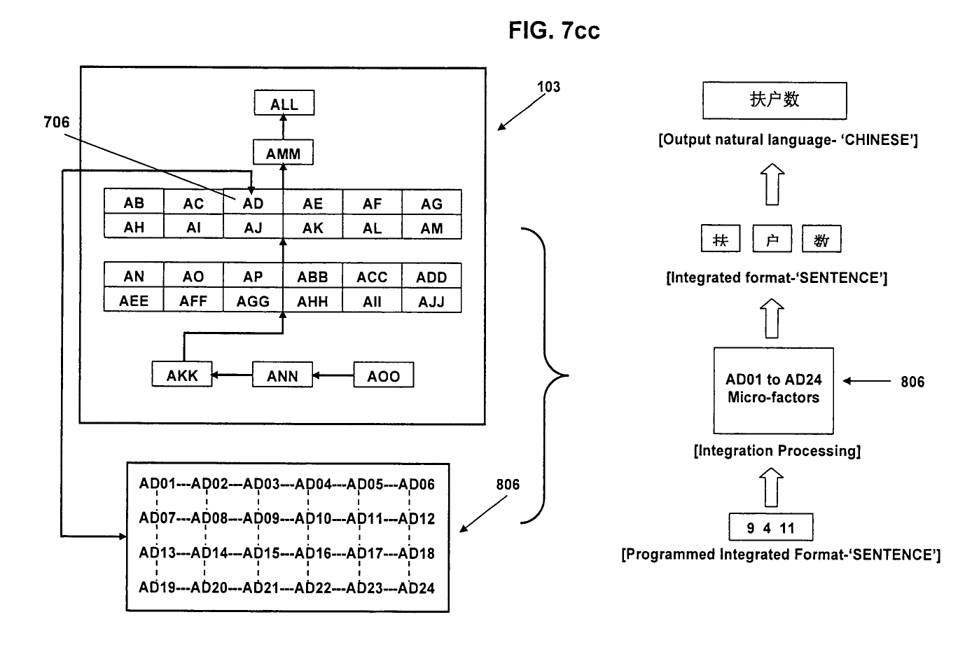

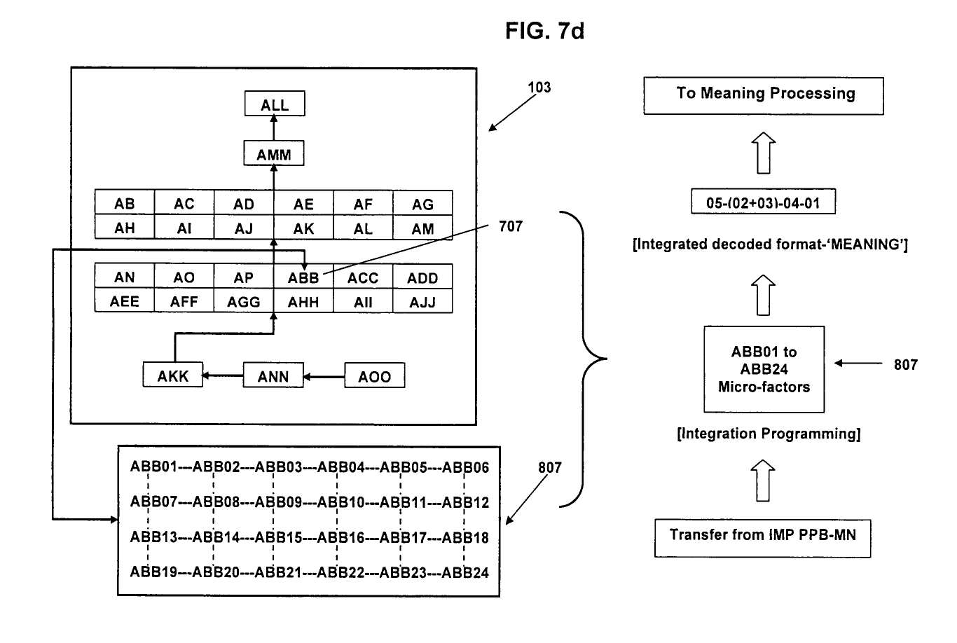

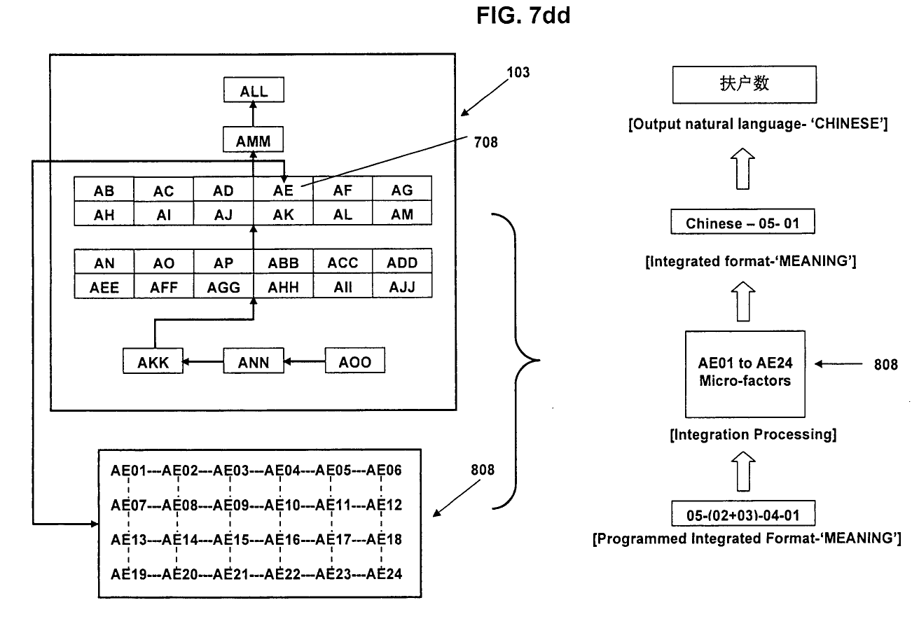

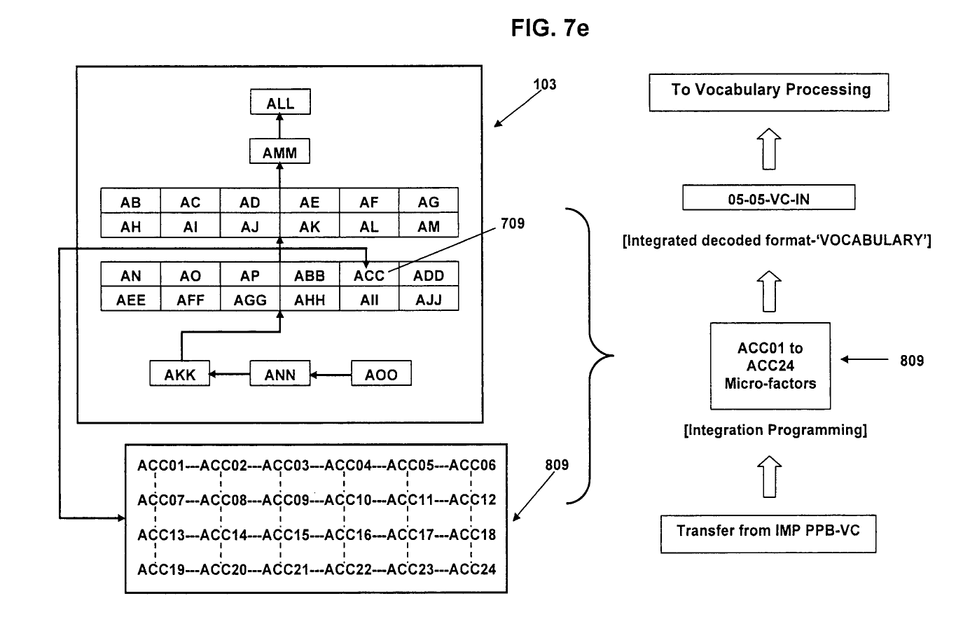

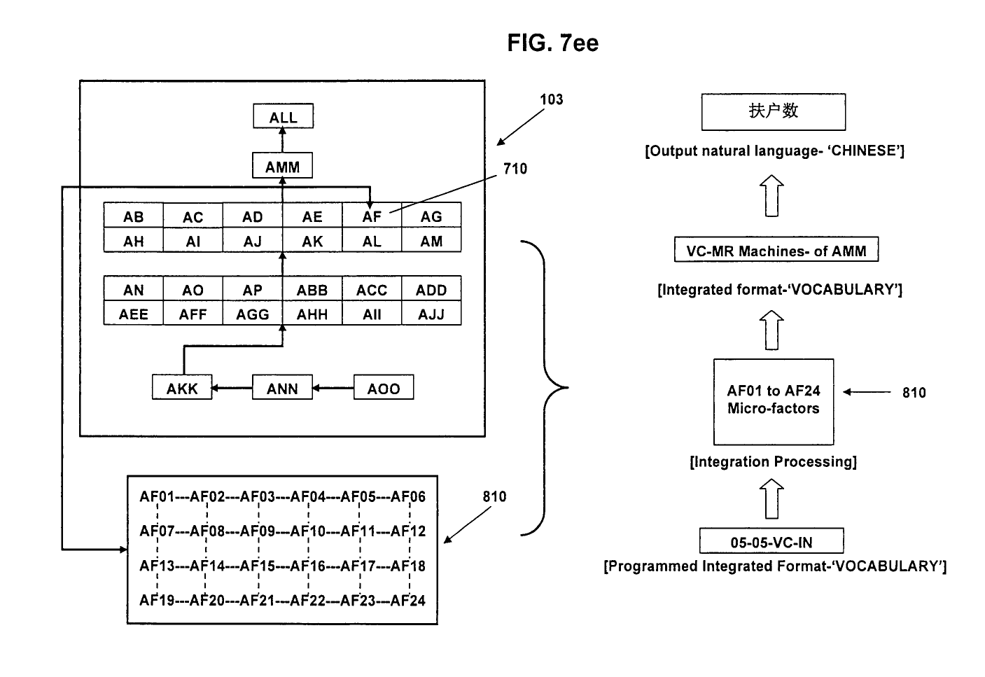

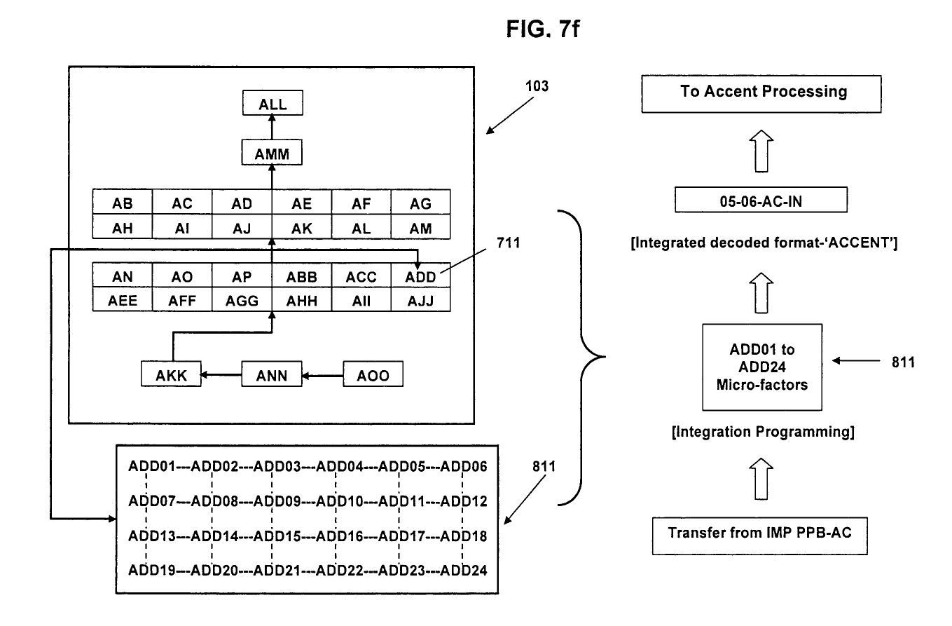

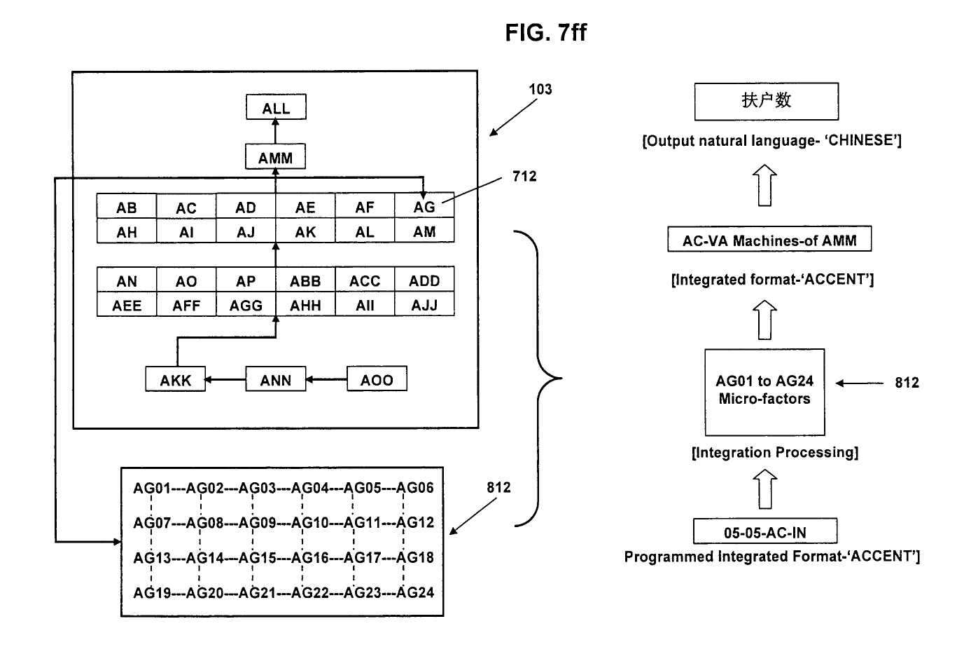

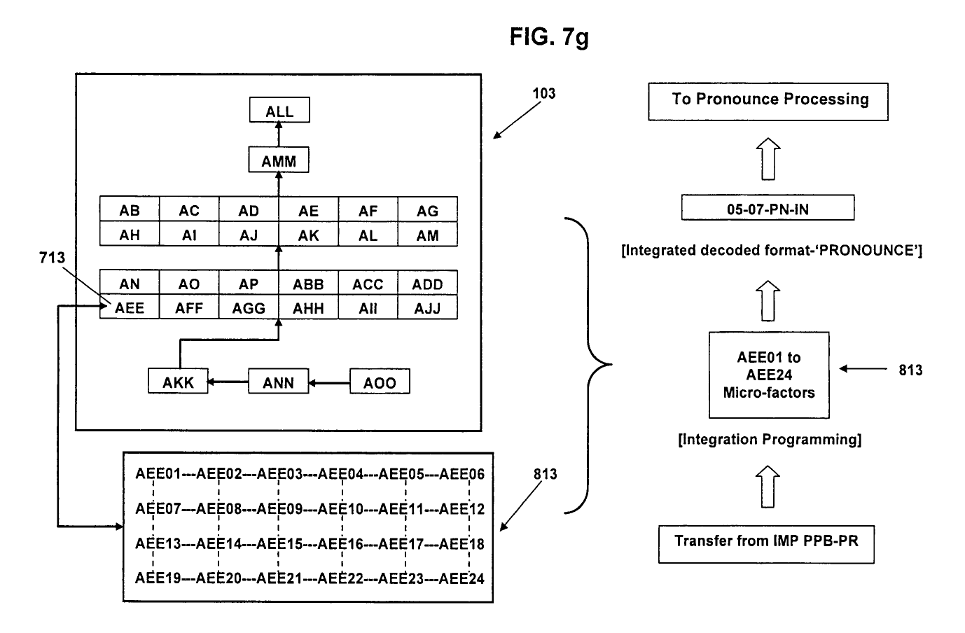

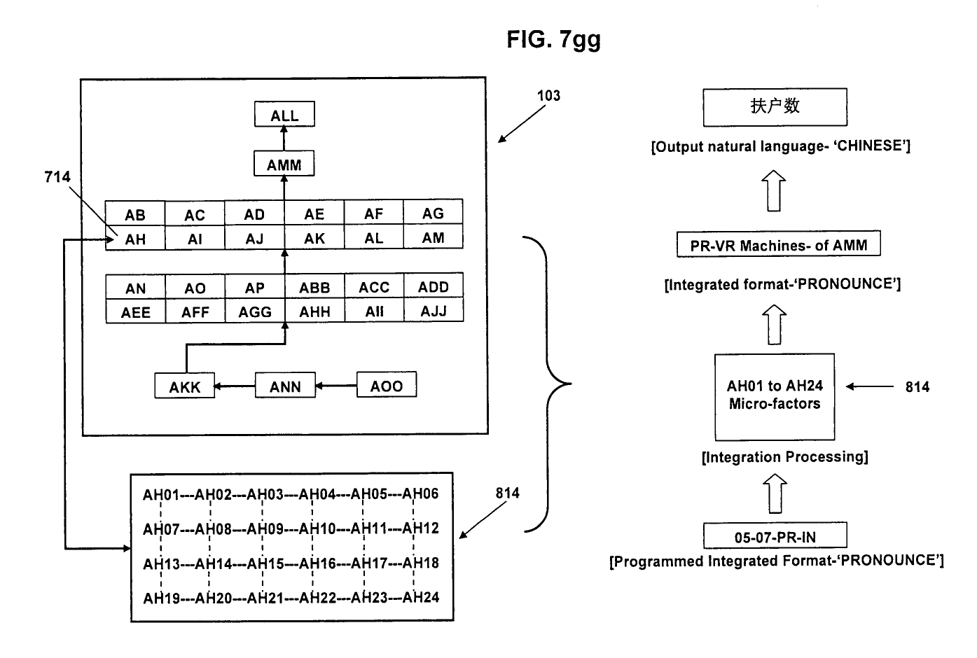

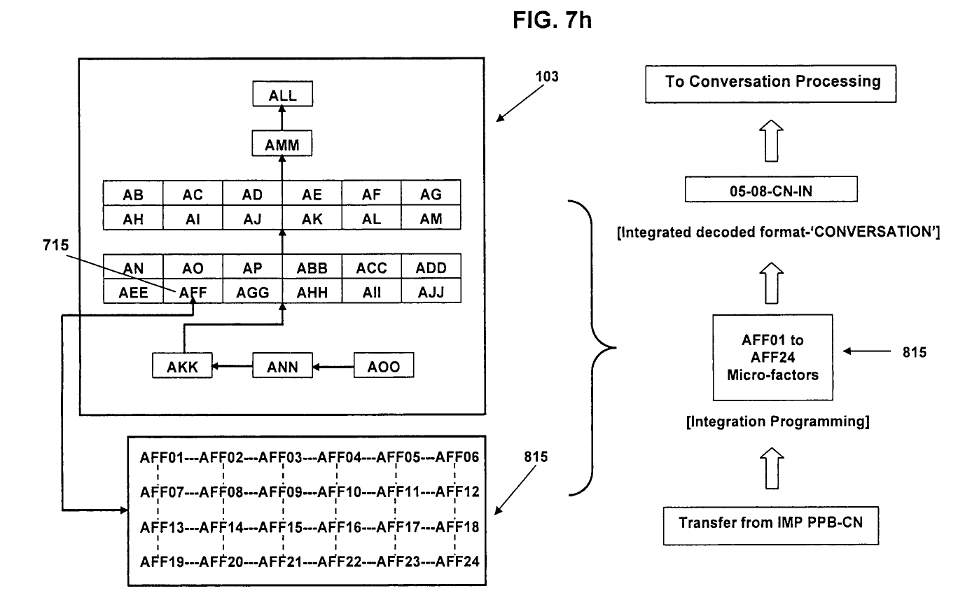

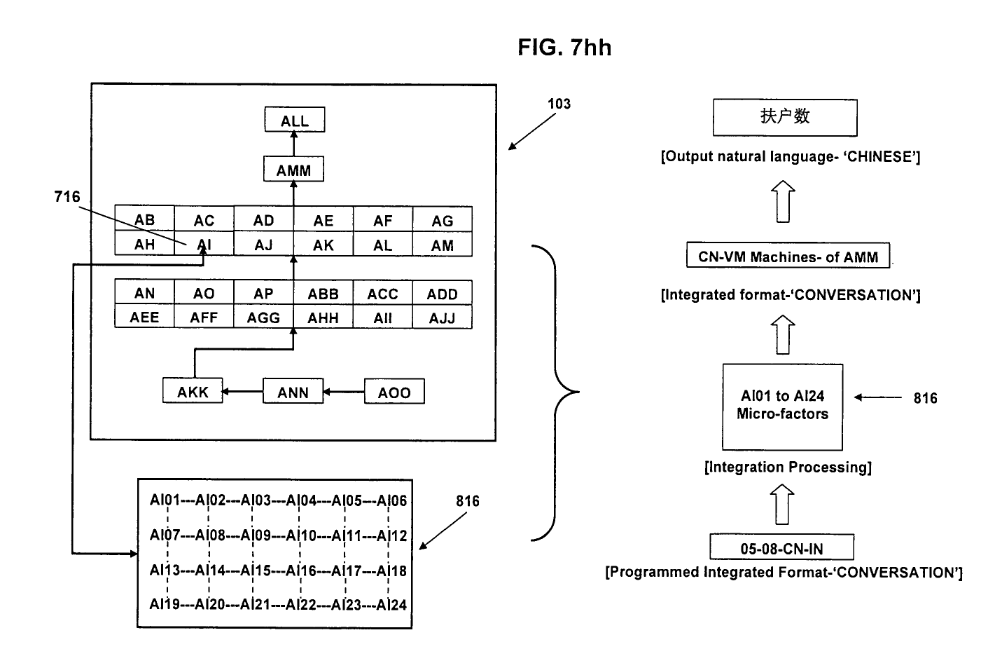

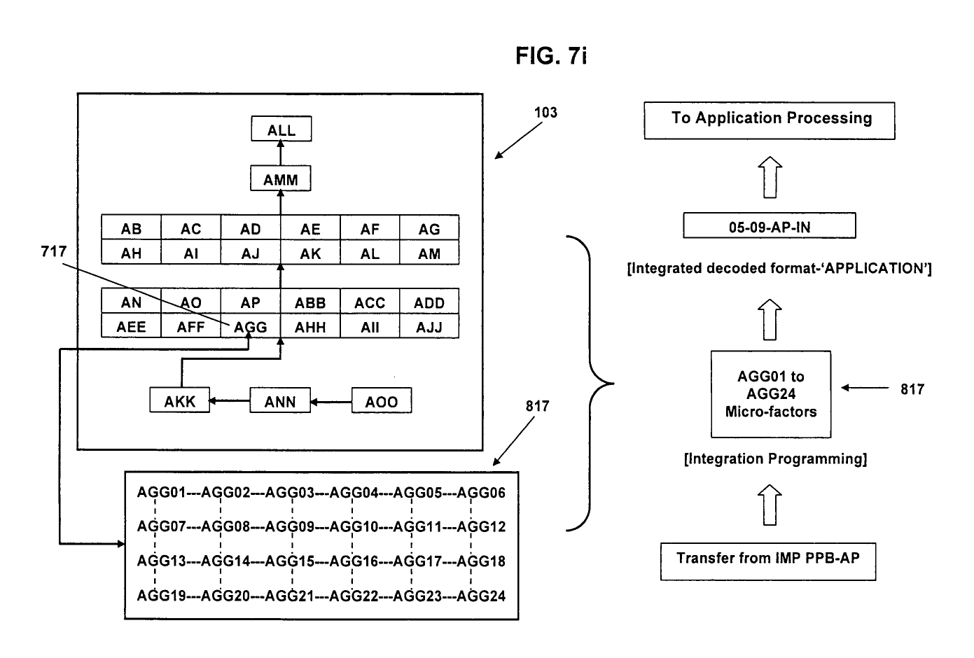

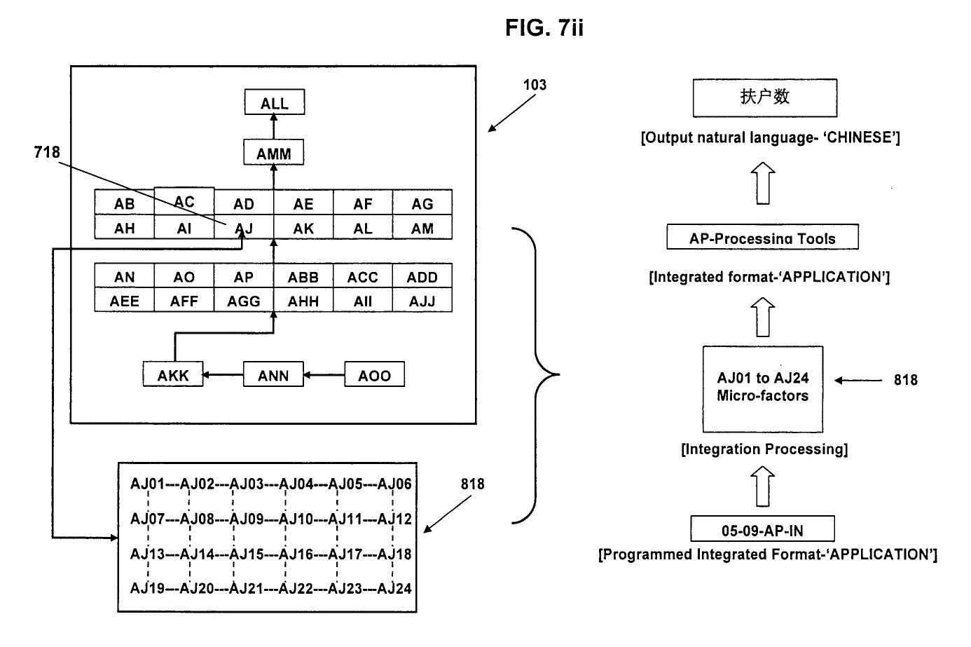

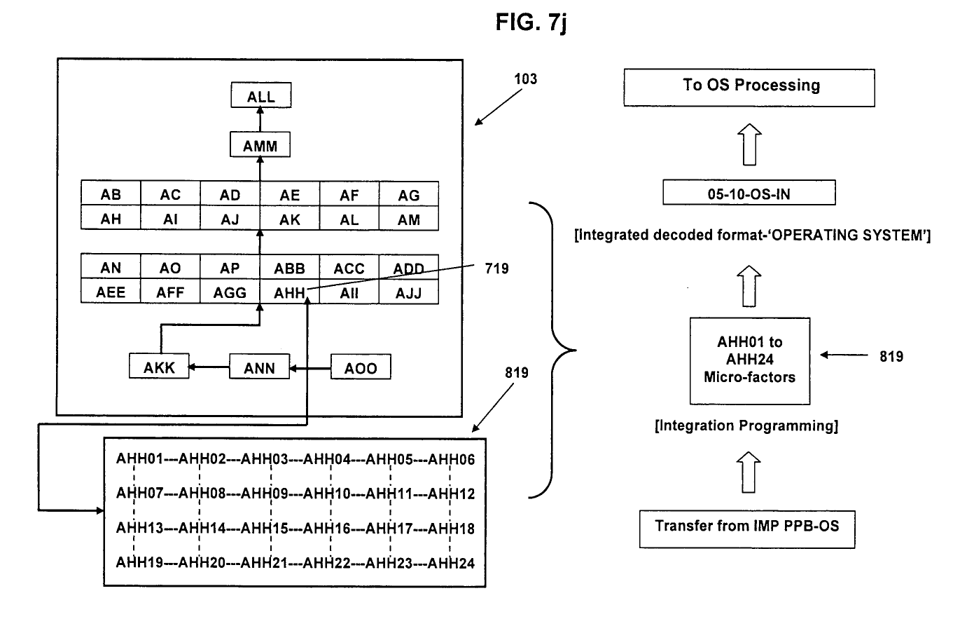

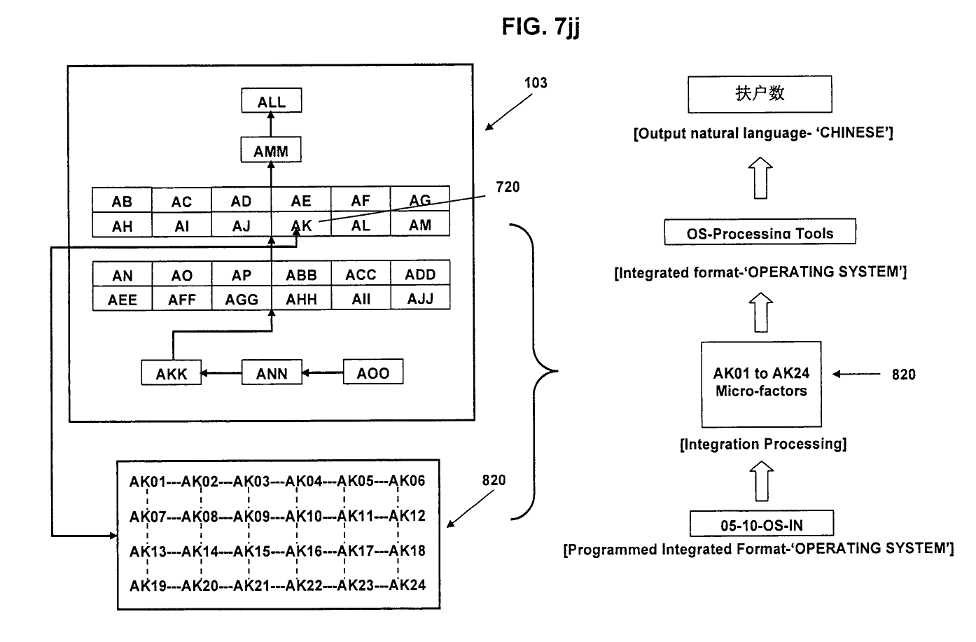

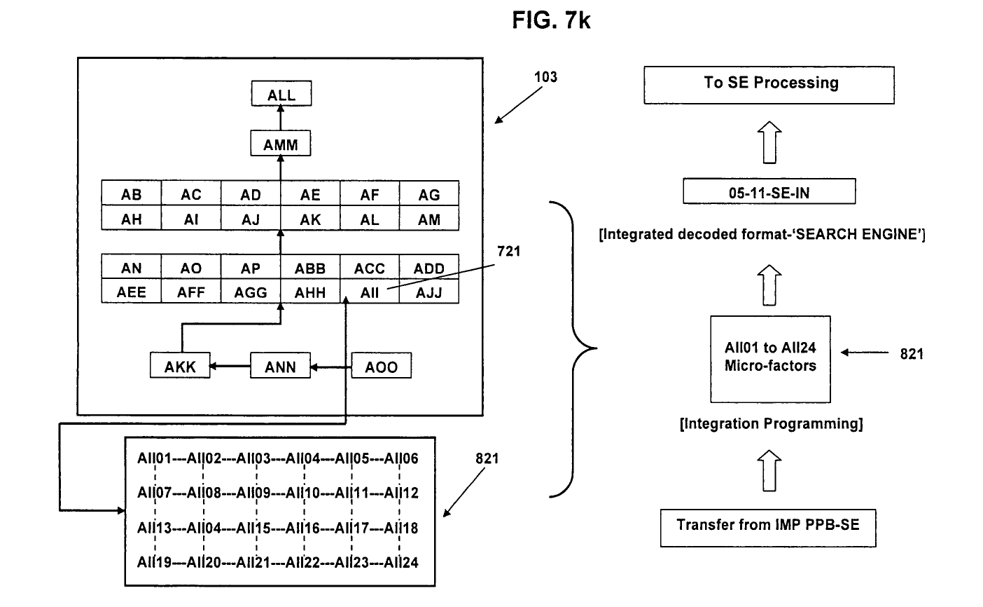

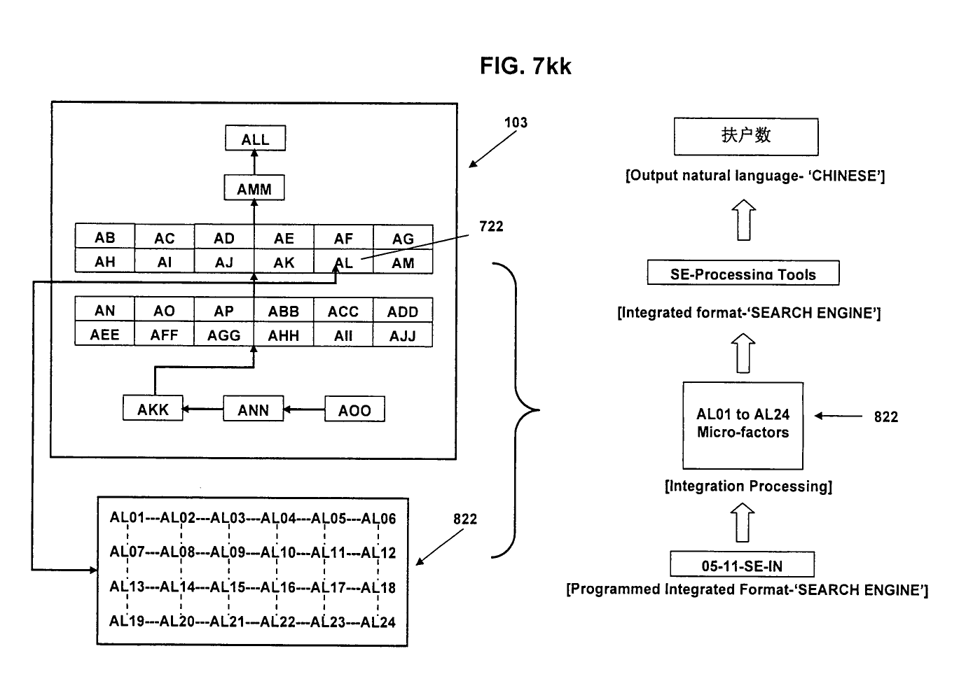

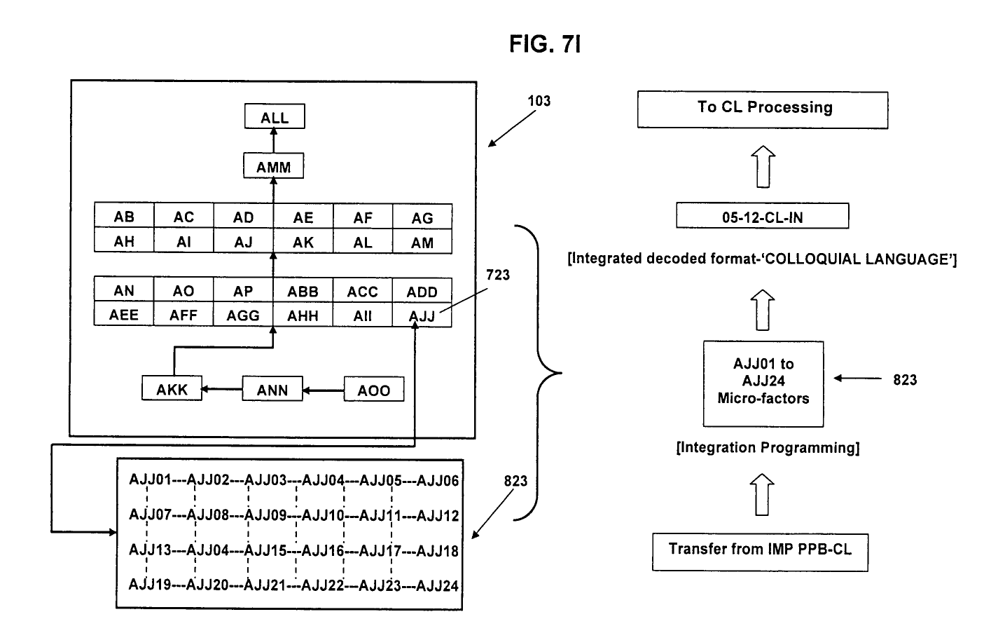

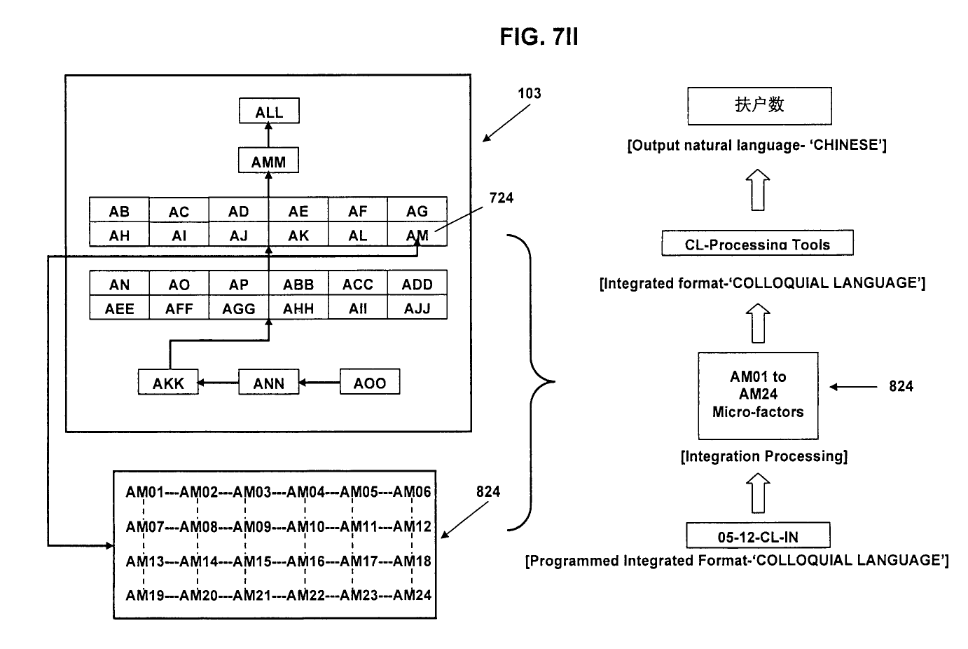

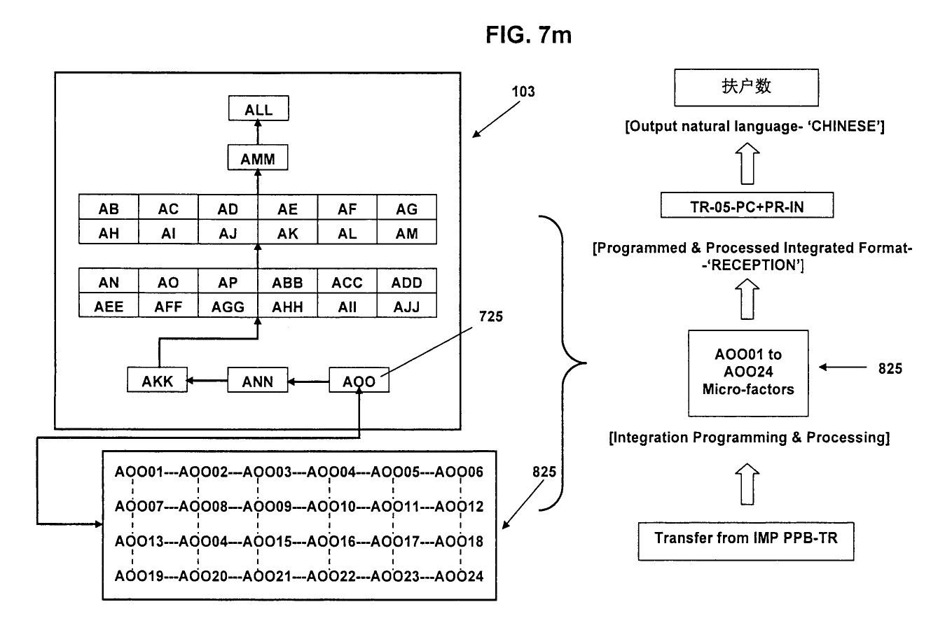

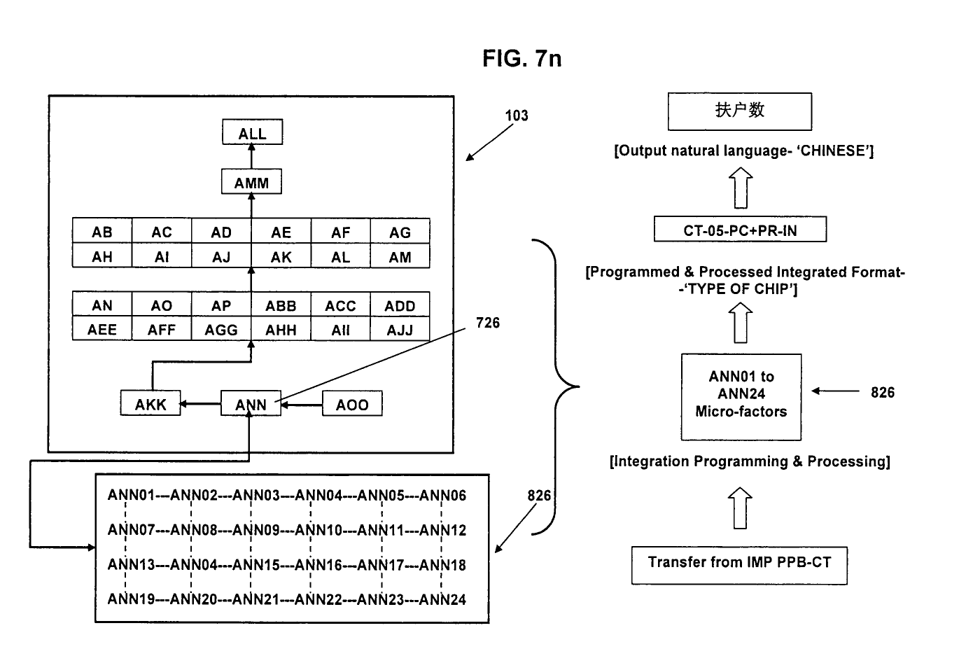

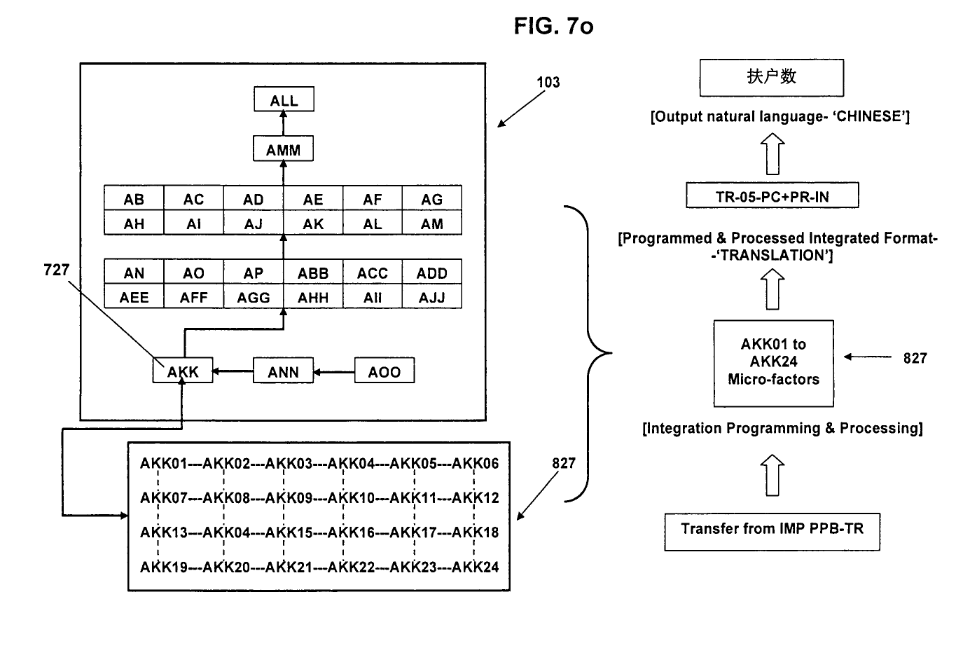

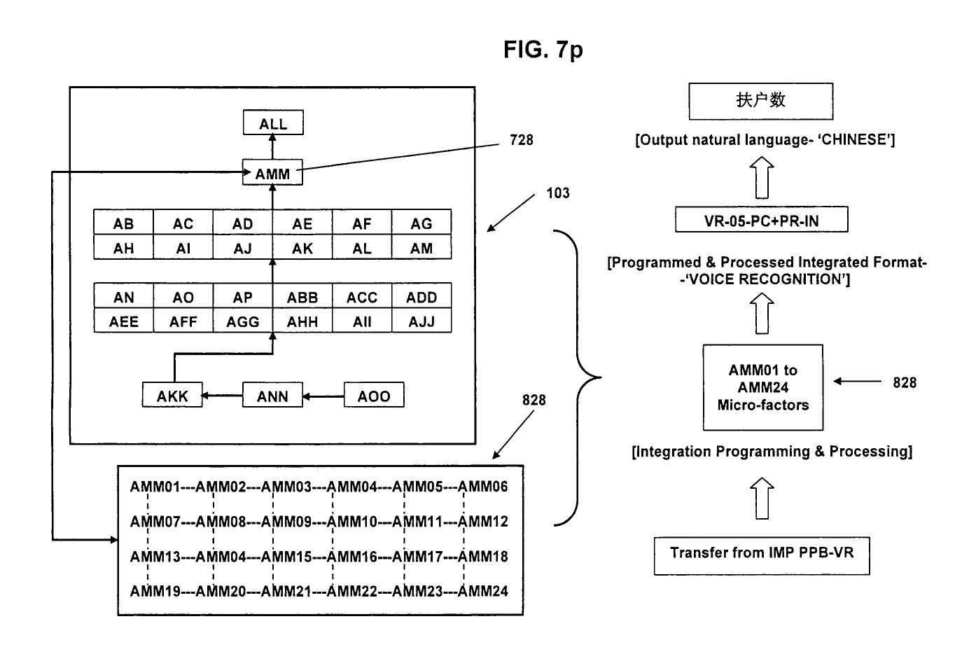

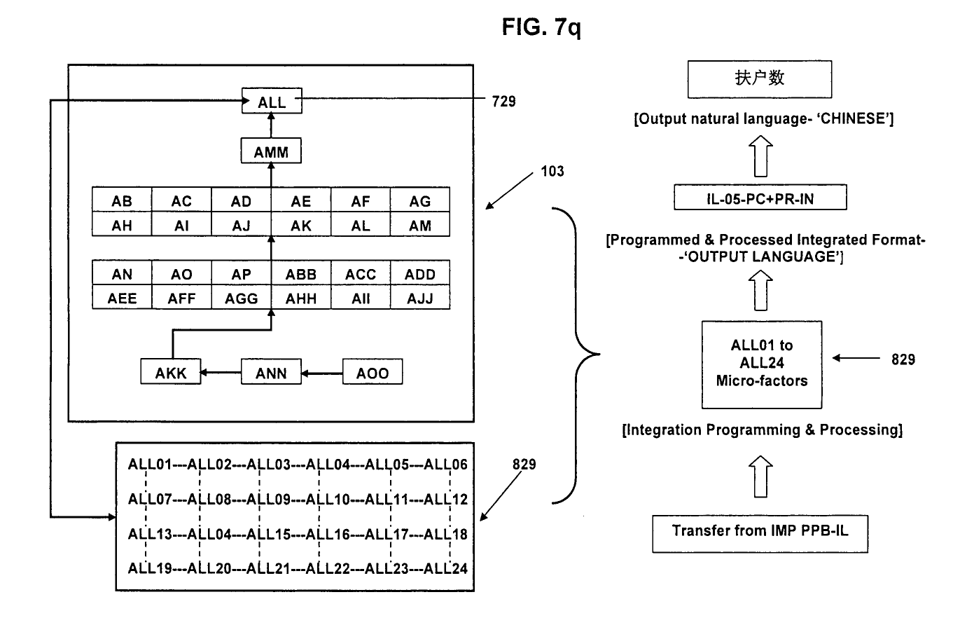

It shows the entire process of the Internal Micro Processor (IMP) 108 integration processing technology. To explain this, the output of entire integration processing and programming performed and explained in FIGS. 7a to 7q, i.e. integrated language factors of output language collectively produces the target language. The Internal Micro Processor (IMP) 108 is designed internally into five stages 501, 502, 503, 504, 505 of language translating processors to collectively process the twelve integrated language factors of output language. Such decoded global language integration format of output language further translated through these five stages 501, 502, 503, 504, 505 of decoded formats of Internal Micro Processor (IMP) 108, viz.
i) processor start reception format 501
ii) inter language translation format; 502
iii) renaming format; 503
iv) decoding format; and 504
v) ntegration devices format; 505
   by their respective sub-tools. After going through the five stages Internal Micro Processor (IMP) 108 integration processing, the entire digital translation output is transferred to integration programming and processing of natural language translation through micro factors.

FIG. 6a illustrates an explanatory diagram depicting the first stage 501 internal integration valuation processing of received input of the received global language integrated factors in the form of ‘decoded language format’ performed by language translating processor I (decoded reception of ‘global language format’) 501 of Internal Micro Processor (IMP) 106 according to an embodiment of the present invention.

Performance of first stage 501 internal integration processing of language translating processor I 501 of Internal Micro Processor (IMP) 108 can be understood by the explanatory illustration wherein operation begins when the input of twelve received global language integrated factors namely:
i) decoded global language ‘alphabet’ format;
ii) decoded global language ‘word’ format;
iii) decoded global language ‘sentence’ format;
iv) decoded global language ‘meaning’ format;
v) decoded global language ‘pronunciation’ format;
vi) decoded global language ‘accent’ format;
vii) decoded global language ‘vocabulary’ format;
viii) decoded global language ‘conversation’ format;
ix) decoded global language ‘application’ format;
x) decoded global language ‘operating system’ format;
xi) decoded global language ‘search engine’ format;
xii) decoded global language ‘colloquial language’ format;
   is received and further processed by natural language integration processing technology and language translation integration processing technology at this stage. Twelve decoded global language integrated factors on integration protocol panel board ‘A’ 911 of the global language machine are transferred to Internal Micro Processor (IMP) sub-tools 611 integration networking as depicted in FIG. 5a and processed into combination—A 21 of sub-tools ‘decoded reception format’ 501 by respective Internal Micro Processor (IMP) sub-tools valuation processors as listed in Table IV. These protocol panel boards (PPB) 911, 912, 913, 914, 915 are programmed with global language integration factors with necessary language integration translating processing as well as natural language integration processing for digital application of voice recognition input of absorbed integration factors of received natural language for inter language translation. The combination—A 21 of sub-tools ‘decoded reception format’ 501 is explained in Chart C.

Thereafter, combination—A 21 of sub-tools ‘decoded reception format’ is transferred to integration programming and processing of natural language translation through micro factors.

FIG. 6b illustrates an explanatory diagram depicting the second stage 502 internal integration valuation processing of received input of the received global language integrated factors in the form of ‘decoded language formats’ performed by language translating processor II (decoded inter language translation of ‘global language formats’) 502 of Internal Micro Processor (IMP) 106 according to an embodiment of the present invention.

Performance of second stage 502 internal integration processing of language translating processor II 502 of Internal Micro Processor (IMP) 108 can be understood by the explanatory illustration wherein operation begins when the input of twelve received global language integrated factors is received and further processed by natural language integration processing technology and language translation integration processing technology at this stage. Twelve decoded global language integrated factors on integration protocol panel board ‘B’ 912 of the global language machine are transferred to Internal Micro Processor (IMP) sub-tools 611 integration networking as depicted in FIG. 5a and processed into combination—B 22 of sub-tools ‘decoded inter language translation format’ 502 by respective Internal Micro Processor (IMP) sub-tools valuation processors as listed in Table IV. These protocol panel boards (PPB) 911, 912, 913, 914, 915 are programmed with global language integration factors with necessary language integration translating processing as well as natural language integration processing for digital application of voice recognition input of absorbed integration factors of received natural language for inter language translation. The combination—B 22 of sub-tools ‘decoded inter language translation format’ 502 is explained in Chart C.

Thereafter, combination—B 22 of sub-tools ‘decoded inter language translation format’ is transferred to integration programming and processing of natural language translation through micro factors.

FIG. 6c illustrates an explanatory diagram depicting the third stage 503 internal integration valuation processing of received input of the received global language integrated factors in the form of ‘decoded language formats’ performed by language translating processor III (decoded renaming process of ‘global language formats’) 503 of Internal Micro Processor (IMP) 106 according to an embodiment of the present invention.

Performance of third stage 503 internal integration processing of language translating processor III 503 of Internal Micro Processor (IMP) 108 can be understood by the explanatory illustration wherein operation begins when the input of twelve received global language integrated factors is received and further processed by natural language integration processing technology and language translation integration processing technology at this stage. Twelve decoded global language integrated factors on integration protocol panel board ‘C’ 913 of the global language machine are transferred to Internal Micro Processor (IMP) sub-tools 611 integration networking as depicted in FIG. 5a and processed into combination—C 23 of sub-tools ‘decoded renaming format’ 503 by respective Internal Micro Processor (IMP) sub-tools valuation processors as listed in Table IV. These protocol panel boards (PPB) 911, 912, 913, 914, 915 are programmed with global language integration factors with necessary language integration translating processing as well as natural language integration processing for digital application of voice recognition input of absorbed integration factors of received natural language for inter language translation. The combination—C 23 of sub-tools ‘decoded renaming format’ 503 is explained in Chart C.

Thereafter, combination—C 23 of sub-tools ‘decoded renaming format’ is transferred to integration programming and processing of natural language translation through micro factors.

FIG. 6d illustrates an explanatory diagram depicting the fourth stage 504 internal integration valuation processing of received input of the received global language integrated factors in the form of ‘decoded language formats’ performed by language translating processor IV (decoding process of ‘global language formats’) 504 of Internal Micro Processor (IMP) 106 according to an embodiment of the present invention.

Performance of fourth stage 504 internal integration processing of language translating processor IV 504 of Internal Micro Processor (IMP) 108 can be understood by the explanatory illustration wherein operation begins when the input of twelve received global language integrated factors is received and further processed by natural language integration processing technology and language translation integration processing technology at this stage. Twelve decoded global language integrated factors on integration protocol panel board ‘D’ 914 of the global language machine are transferred to Internal Micro Processor (IMP) sub-tools 611 integration networking as depicted in FIG. 5a and processed into combination—D 24 of sub-tools ‘decoding format’ 504 by respective Internal Micro Processor (IMP) sub-tools valuation processors as listed in Table IV. These protocol panel boards (PPB) 911, 912, 913, 914, 915 are programmed with global language integration factors with necessary language integration translating processing as well as natural language integration processing for digital application of voice recognition input of absorbed integration factors of received natural language for inter language translation. The combination—D 24 of sub-tools ‘decoding format’ 504 is explained in Chart C.

Thereafter, combination—D 24 of sub-tools ‘decoding format’ is transferred to integration programming and processing of natural language translation through micro factors.

FIG. 6e illustrates an explanatory diagram depicting the fifth stage 505 internal integration valuation processing of received input of the received global language integrated factors in the form of ‘decoded language formats’ performed by language translating processor V (decoded integration devices of ‘global language formats’) 505 of Internal Micro Processor (IMP) 106 according to an embodiment of the present invention.

Performance of fifth stage 505 internal integration processing of language translating processor V 505 of Internal Micro Processor (IMP) 108 can be understood by the explanatory illustration wherein operation begins when the input of twelve received global language integrated factors is received and further processed by natural language integration processing technology and language translation integration processing technology at this stage. Twelve decoded global language integrated factors on integration protocol panel board ‘E’ 915 of the global language machine are transferred to Internal Micro Processor (IMP) sub-tools 611 integration networking as depicted in FIG. 5a and processed into combination—E 25 of sub-tools ‘decoded integration devices format’ 505 by respective Internal Micro Processor (IMP) sub-tools valuation processors as listed in Table IV. These protocol panel boards (PPB) 911, 912, 913, 914, 915 are programmed with global language integration factors with necessary language integration translating processing as well as natural language integration processing for digital application of voice recognition input of absorbed integration factors of received natural language for inter language translation. The combination—E 25 of sub-tools ‘decoded integration devices format’ 505 is explained in Chart C.

Thereafter, combination—E 25 of sub-tools ‘decoded integration devices format’ is transferred to integration programming and processing of natural language translation through micro factors.

FIG. 7 is a block diagram of output natural language integration technology. The main object of output natural language integration technology is to integrate the output target natural language into twelve decoded language factors 105 from the receiving end. The twelve decoded language factors 105 of Internal Micro Processor (IMP) 106 transferred to integration programming and processing of natural language translation goes through micro factors and output target natural language factors are delivered as shown in Table VI for requested language translation.

TABLE VI

| Output language integration | Language factors (Output |
|---|---|
| processing decoded factors | Target Language) |
| Alphabet (AL-01) | ALPHABET |
| Word (WR-02) | WORD |
| Sentence (ST-03) | SENTENCE |
| Meaning (MN-04) | MEANING |
| Pronunciation (PR-05) | PRONUNCIATION |
| Accent (AC-06) | ACCENT |
| Vocabulary (VC-07) | VOCABULARY |
| Conversation (CN-08) | CONVERSATION |
| Application (AP-09) | APPLICATION |
| Operating System (OS-10) | OPERATING SYSTEM |
| Search Engine (SE-11) | SEARCH ENGINE |
| Colloquial Language (CL-12) | COLLOQUIAL LANGUAGE |

The output target natural language is received and processed through Integrated Chip (integration processing technology chip) 101 which comprises twenty nine micro chips 103 of different language integration factors of the technology, viz. a) twelve language programming factors; b) twelve language processing factors; and c) five primary processing factors; as explained hereunder:
a) Integration Internal Basic factors of language (programming and processing)
   i) Alphabets (AN/AB);
   ii) Words (AO/AC);
   iii) Sentences (AP/AD); and
   iv) Meaning (ABB/AE).
b) Integration Internal Speech processing factors of language—(programming and processing)
   i) Vocabulary (ACC/AF);
   ii) Accent (ADD/AG);
   iii) Pronunciation (AEE/AH); and
   iv) Conversation (AFF/AI).
c) Integration Internal Operating supporting factors of language—(programming and processing)
   i) Application (AGG/AJ);
   ii) Operating System (AHH/AK;)
   iii) Search engine (AII/AL); and
   iv) Colloquial language (AJJ/AM).
d) Integration Internal Primary programming and processing factors of language—
   i) Reception chip (AOO)
   ii) Type of chip and technology (ANN)
   iii) Translating chip (AKK);
   iv) Voice recognition chip (AMM); and
   v) Language chip (ALL).

These micro chips 103 have been designed with appropriate role of their function while processing the technology. Each microchip identified above has been designed for its allotted function while performing the natural language integration process. These microchips 103 are networked together to exchange functions collectively or individually to produce the target output natural language.

Output target natural language is produced by language integration decoding program and process performed by internal micro chips (e.g. AN/AB) and micro factors (e.g. AN01-AN24/AB01-AB24) of the respective language programming and processing micro chip employing the respective programming version commands and respective processing format commands of different micro systems and sub-systems of language format programming and processing formation of the technology to produce the target output natural language. Internal micro chip format of the natural language integration technology is designed and developed appropriately into twenty four respective micro factors for each micro chip. Internal micro factors operate and control the entire programming and processing systematically according to the protocol formation of the micro processing of the language factors. The main object of the micro factors is to achieve the accurate language translation for the given targets and commands for further navigation and processing of the input language according to the natural language integration technology. ‘CHART D’ details the role played by the internal micro factors by way of illustration of the ‘Alphabet format’ in the natural language integration technology.

FIG. 7a is an explanatory diagram depicting the integration of basic factors of alphabets from ‘decoded alphabet format’ performed by using language integration programming technology according to an embodiment of the present invention.

Performance of ‘Integration programming alphabet format chip’ 701 can be understood by the explanatory illustration wherein operation begins when coded format of the version “9”, “4”, “11” of the translated output natural language “ [symbol] ” (in Chinese language) transferred from Internal Micro Processor (IMP) 106 is absorbed and formed into integrated processed alphabet format in the form “9”, “4”, “11” by application of micro factors AN-01 to AN-24 801 using integration programming technology. This decoded alphabet format then transferred to alphabet processing for internal integration of language translation.

FIG. 7aa is an explanatory diagram depicting the integration of output natural language into basic processing factors—‘alphabet format’ performed by using language integration processing technology according to an embodiment of the present invention.

Integration processing technology chip (Integrated Chip) 101 consists of twenty nine micro chips 103 of different integration factors of the technology. These micro chips 103 have been designed with appropriate role of their function while processing the technology. ‘Integration alphabet format chip’ 702 is one of them which performs the processing of output natural language into alphabet format by using internal micro factors or functions, AB1 to AB24, 802 and produces the target output language. ‘Integration alphabet format chip’ 702 activates to start the functions of micro factors, AB1 to AB24, 802 to produce the output of target output natural language, which operates and controls the entire processing systematically according to the protocol formation of the alphabet processing factors. These factors 802 adjusted automatically to work either collectively or individually according to the situation. The main object of these alphabet processing factors 802 is to achieve the solution for the given targets and commands from the basic factors of the technology in order to receive the target output language. The entire process is organized and controlled by output processing format of alphabet microchip 702 and its micro factors or functions 802.

Performance of ‘Integration alphabet format chip’ 702 can be understood by the explanatory illustration wherein operation begins when a decoded output language “ [symbol] ” namely in CHINESE, is received. Output language basic factors processing is performed by using micro factors AB1 to AB24, 802 and alphabet format in the form “ [symbol] ”, “ [symbol] ”. “ [symbol] ” (in Chinese language) of the input natural language “HOW ARE YOU” (in English language) is produced as target output language.

FIG. 7b is an explanatory diagram depicting the integration of basic factors of words from ‘decoded word format’ performed by using language integration programming technology according to an embodiment of the present invention.

Performance of ‘Integration programming word format chip’ 703 can be understood by the explanatory illustration wherein operation begins when coded format of the version “9”, “4”, “11” of the translated output natural language “ [symbol] ” (in Chinese language) transferred from Internal Micro Processor (IMP) 106 is absorbed and formed into integrated processed word format in the form “9”, “4”, “11” by application of micro factors AO-01 to AO-24 803 using integration programming technology. This decoded word format then transferred to word processing for internal integration of language translation.

FIG. 7bb is an explanatory diagram depicting the integration of decoded output language into basic processing factors—‘word format’ performed by using language integration processing technology according to an embodiment of the present invention.

Integration processing technology chip (Integrated Chip) 101 consists of twenty nine micro chips 103 of different integration factors of the technology. These micro chips 103 have been designed with appropriate role of their function while processing the technology. ‘Integration word format chip’ 704 is one of them which performs the processing of decoded output language into word format by using internal micro factors or functions, AC1 to AC24, 804 and produces the target output language. ‘Integration word format chip’ 704 activates to start the functions of micro factors, AC1 to AC24, 804 to produce the output of target output natural language, which operate and control the entire processing systematically according to the protocol formation of the word processing factors. These factors 804 adjusted automatically to work either collectively or individually according to the situation. The main object of these 804 word processing factors is to achieve the solution for the given targets and commands from the basic factors of the technology in order to receive target output language. The entire process is organized and controlled by output processing format of word microchip 704 and its micro factors or functions 804.

Performance of ‘Integration word format chip’ 704 can be understood by the explanatory illustration wherein operation begins when a decoded output language “ [symbol] [symbol] ” namely in CHINESE, is received. Output language basic factors processing is performed by using micro factors AC1 to AC24, 804 and word format in the form “ [symbol] ” (in Chinese language) of the input natural language “HOW ARE YOU” (in English language) is produced as target output language.

FIG. 7c is an explanatory diagram depicting the integration of basic factors of sentence from ‘decoded sentence format’ performed by using language integration programming technology according to an embodiment of the present invention.

Performance of ‘Integration programming sentence format chip’ 705 can be understood by the explanatory illustration wherein operation begins when coded format of the version “9”, “4”, “11” of the translated output natural language “ [symbol] ” (in Chinese language) transferred from Internal Micro Processor (IMP) 106 is absorbed and formed into integrated processed sentence format in the form “9”, “4”, “11” by application of micro factors AP-01 to AP-24 805 using integration programming technology. This decoded sentence format then transferred to sentence processing for internal integration of language translation.

FIG. 7cc is an explanatory diagram depicting the integration of decoded output language into basic processing factors—‘sentence format’ performed by using language integration processing technology according to an embodiment of the present invention.

Integration processing technology chip (Integrated Chip) 101 consists of twenty nine micro chips 103 of different integration factors of the technology. These micro chips 103 have been designed with appropriate role of their function while processing the technology. ‘Integration sentence format chip’ 706 is one of them which performs the processing of decoded output language into sentence format by using internal micro factors or functions, AD1 to AD24, 806 and produces the target output language. ‘Integration sentence format chip’ 706 activates to start the functions of micro factors, AD1 to AD24, 806 to produce the output of target output natural language, which operate and control the entire processing systematically according to the protocol formation of the sentence processing factors. These factors 806 adjusted automatically to work either collectively or individually according to the situation. The main object of these sentence processing factors 806 is to achieve the solution for the given targets and commands from the basic factors of the technology in order to receive the target output language. The entire process is organized and controlled by output processing format of sentence microchip 706 and its micro factors or functions 806.

Performance of ‘Integration sentence format chip’ 706 can be understood by the explanatory illustration wherein operation begins when a decoded output language “ [symbol] ” namely in CHINESE, is received. Output language basic factors processing is performed by using micro factors AD1 to AD24, 806 and sentence format in the form “ [symbol] ” (in Chinese language) of the input natural language “HOW ARE YOU” (in English language) is produced as target output language.

FIG. 7d is an explanatory diagram depicting the integration of basic factors of words from ‘decoded meaning format’ performed by using language integration programming technology according to an embodiment of the present invention.

Performance of ‘Integration programming meaning format chip’ 707 can be understood by the explanatory illustration wherein operation begins when coded format of the version “05-(02+03)-04-01” of the translated output natural language “ [symbol] ” (in Chinese language) transferred from Internal Micro Processor (IMP) 106 is absorbed and formed into integrated processed meaning format in the form “05-(02+03)-04-01” by application of micro factors ABB-01 to ABB-24 807 using integration programming technology. This decoded meaning format then transferred to meaning processing for internal integration of language translation.

FIG. 7dd is an explanatory diagram depicting the integration of decoded output language into basic processing factors—‘meaning format’ performed by using language integration processing technology according to an embodiment of the present invention;

Integration processing technology chip (Integrated Chip) 101 consists of twenty nine micro chips 103 of different integration factors of the technology. These micro chips 103 have been designed with appropriate role of their function while processing the technology. ‘Integration meaning format chip’ 708 is one of them which performs the processing of decoded output language into meaning format by using internal micro factors or functions, AE1 to AE24, 808 and produces the target output language. ‘Integration meaning format chip’ 708 activates to start the functions of micro factors, AE1 to AE24, 808 to produce the output of target output natural language, which operate and control the entire processing systematically according to the protocol formation of the meaning processing factors. These factors 808 adjusted automatically to work either collectively or individually according to the situation. The main object of these meaning processing factors 808 is to achieve the solution for the given targets and commands from the basic factors of the technology in order to receive the target output language. The entire process is organized and controlled by output processing format of meaning microchip 708 and its micro factors or functions 808.

Performance of ‘Integration meaning format chip’ 708 can be understood by the explanatory illustration wherein operation begins when a decoded output language “CHINESE—05-01” namely in CHINESE, is received. Output language basic factors processing is performed by using micro factors AE1 to AE24, 808 and meaning format in the form “ [symbol] ” (in Chinese language) of the input natural language “HOW ARE YOU” (in English language) is produced target output language.

FIG. 7e is an explanatory diagram depicting the integration of basic factors of words from ‘decoded vocabulary format’ performed by using language integration programming technology according to an embodiment of the present invention.

Performance of ‘Integration programming vocabulary format chip’ 709 can be understood by the explanatory illustration wherein operation begins when coded format of the version “05-05-VC-IN” of the translated output natural language “ [symbol] ” (in Chinese language) transferred from Internal Micro Processor (IMP) 106 is absorbed and formed into integrated processed vocabulary format in the form “05-05-VC-IN” by application of micro factors ACC-01 to ACC-24 809 using integration programming technology. This decoded vocabulary format then transferred to vocabulary processing for internal integration of language translation.

FIG. 7ee is an explanatory diagram depicting the integration of decoded output language into speech processing factors—‘vocabulary format’ performed by using language integration processing technology according to an embodiment of the present invention;

Integration processing technology chip (Integrated Chip) 101 consists of twenty nine micro chips 103 of different integration factors of the technology. These micro chips 103 have been designed with appropriate role of their function while processing the technology. ‘Integration vocabulary format chip’ 710 is one of them which performs the processing of decoded output language into vocabulary format by using internal micro factors or functions, AF1 to AF24, 810 and produces the target output language. ‘Integration vocabulary format chip’ 710 activates to start the functions of micro factors, AF1 to AF24, 810 to produce the output of target output natural language, which operate and control the entire processing systematically according to the protocol formation of the vocabulary processing factors. These factors 810 adjusted automatically to work either collectively or individually according to the situation. The main object of these vocabulary processing factors 810 is to achieve the solution for the given targets and commands from the speech factors of the technology in order to receive the target output language. The entire process is organized and controlled by output processing format of vocabulary microchip 710 and its micro factors or functions 810.

Performance of ‘Integration vocabulary format chip’ 710 can be understood by the explanatory illustration wherein operation begins when a decoded output language ““VC-M R MACHINES—AMM”” namely in CHINESE, is received. Output language speech factors processing is performed by using micro factors AF1 to AF24, 810 and vocabulary format in the form “ [symbol] ” (in Chinese language) of the input natural language “HOW ARE YOU” (in English language) is produced as target output language.

FIG. 7f is an explanatory diagram depicting the integration of basic factors of words from ‘decoded accent format’ performed by using language integration programming technology according to an embodiment of the present invention.

Performance of ‘Integration programming accent format chip’ 711 can be understood by the explanatory illustration wherein operation begins when coded format of the version “05-06-ACC-IN” of the translated output natural language “ [symbol] ” (in Chinese language) transferred from Internal Micro Processor (IMP) 106 is absorbed and formed into integrated processed accent format in the form “05-06-ACC-IN” by application of micro factors ADD-01 to ADD-24 811 using integration programming technology. This decoded accent format then transferred to accent processing for internal integration of language translation.

FIG. 7ff is an explanatory diagram depicting the integration of decoded output language into speech processing factors—‘accent format’ performed by using language integration processing technology according to an embodiment of the present invention.

Integration processing technology chip (Integrated Chip) 101 consists of twenty nine micro chips 103 of different integration factors of the technology. These micro chips 103 have been designed with appropriate role of their function while processing the technology. ‘Integration accent format chip’ 712 is one of them which performs the processing of decoded output language into accent format by using internal micro factors or functions, AG1 to AG24, 812 and produces the target output language. ‘Integration accent format chip’ 712 activates to start the functions of micro factors, AG1 to AG24, 812 to produce the output of target output natural language, which operate and control the entire processing systematically according to the protocol formation of the accent processing factors. These factors 812 adjusted automatically to work either collectively or individually according to the situation. The main object of these accent processing factors 812 is to achieve the solution for the given targets and commands from the speech factors of the technology in order to receive the target output language. The entire process is organized and controlled by output processing format of accent microchip 712 and its micro factors or functions 812.

Performance of ‘Integration accent format chip’ 712 can be understood by the explanatory illustration wherein operation begins when a decoded output language “AC-VA MACHINES—AMM” namely in CHINESE, is received. Output language speech factors processing is performed by using micro factors AG1 to AG24, 812 and accent format in the form “ [symbol] ” (in Chinese language) of the input natural language “HOW ARE YOU” (in English language) is produced as target output language.

FIG. 7g is an explanatory diagram depicting the integration of basic factors of words from ‘decoded pronunciation format’ performed by using language integration programming technology according to an embodiment of the present invention.

Performance of ‘Integration programming pronunciation format chip’ 713 can be understood by the explanatory illustration wherein operation begins when coded format of the version “05-07-PN-IN” of the translated output natural language “ [symbol] ” (in Chinese language) transferred from Internal Micro Processor (IMP) 106 is absorbed and formed into integrated processed pronunciation format in the form “05-07-PN-IN” by application of micro factors AEE-01 to AEE-24 813 using integration programming technology. This decoded pronunciation format then transferred to pronunciation processing for internal integration of language translation.

FIG. 7gg is an explanatory diagram depicting the integration of decoded output language into speech processing factors—‘pronunciation format’ performed by using language integration processing technology according to an embodiment of the present invention;

Integration processing technology chip (Integrated Chip) 101 consists of twenty nine micro chips 103 of different integration factors of the technology. These micro 103 chips have been designed with appropriate role of their function while processing the technology. ‘Integration pronunciation format chip’ 714 is one of them which performs the processing of decoded output language into pronunciation format by using internal micro factors or functions, AH1 to AH24, 814 and produces the target output language. ‘Integration pronunciation format chip’ 714 activates to start the functions of micro factors, AH1 to AH24, 814 to produce the output of target output natural language, which operate and control the entire processing systematically according to the protocol formation of the pronunciation processing factors. These factors 814 adjusted automatically to work either collectively or individually according to the situation. The main object of these pronunciation processing factors 814 is to achieve the solution for the given targets and commands from the speech factors of the technology in order to receive the target output language. The entire process is organized and controlled by output processing format of pronunciation microchip 714 and its micro factors or functions 814.

Performance of ‘Integration pronunciation format chip’ 714 can be understood by the explanatory illustration wherein operation begins when a decoded output language “PR-VR MACHINES—AMM” namely in CHINESE, is received. Output language speech factors processing is performed by using micro factors AH1 to AH24, 814 and pronunciation format in the form “ [symbol] ” (in Chinese language) of the input natural language “HOW ARE YOU” (in Chinese language) is produced as target output language.

FIG. 7h is an explanatory diagram depicting the integration of basic factors of words from ‘decoded conversation format’ performed by using language integration programming technology according to an embodiment of the present invention.

Performance of ‘Integration programming conversation format chip’ 715 can be understood by the explanatory illustration wherein operation begins when coded format of the version “05-08-CN-IN” of the translated output natural language “ [symbol] ” (in Chinese language) transferred from Internal Micro Processor (IMP) 106 is absorbed and formed into integrated processed conversation format in the form “05-08-CN-IN” by application of micro factors AFF-01 to AFF-24 815 using integration programming technology. This decoded conversation format then transferred to conversation processing for internal integration of language translation.

FIG. 7hh is an explanatory diagram depicting the integration of decoded output language into speech processing factors—‘conversation format’ performed by using language integration processing technology according to an embodiment of the present invention;

Integration processing technology chip (Integrated Chip) 101 consists of twenty nine micro chips 103 of different integration factors of the technology. These micro chips 103 have been designed with appropriate role of its function while processing the technology. ‘Integration conversation format chip’ 716 is one of them which performs the processing of decoded output language into conversation format by using internal micro factors or functions, AI1 to AI24, 816 and produces the target output language. ‘Integration conversation format chip’ 716 activates to start the functions of micro factors, AI1 to AI24, 816 to produce the output of target output natural language, which operate and control the entire processing systematically according to the protocol formation of the conversation processing factors. These factors 816 adjusted automatically to work either collectively or individually according to the situation. The main object of these conversation processing factors 816 is to achieve the solution for the given targets and commands from the speech factors of the technology in order to receive the target output language. The entire process is organized and controlled by output processing format of conversation microchip 716 and its micro factors or functions 816.

Performance of ‘Integration conversation format chip’ 716 can be understood by the explanatory illustration wherein operation begins when a decoded output language “CN-VM MACHINES—AMM” namely in CHINESE, is received. Output language speech factors processing is performed by using micro factors AI1 to AI24, 816 and conversation format in the form “ [symbol] ” (in Chinese language) of the input natural language “HOW ARE YOU” (in English language) is produced as target output language.

FIG. 7i is an explanatory diagram depicting the integration of operating supporting factors of application from ‘decoded application format’ performed by using language integration programming technology according to an embodiment of the present invention.

Performance of ‘Integration programming application format chip’ 717 can be understood by the explanatory illustration wherein operation begins when coded format of the version “05-09-AP-IN” of the translated output natural language “ [symbol] ” (in Chinese language) transferred from Internal Micro Processor (IMP) 106 is absorbed and formed into integrated processed application format in the form “05-09-AP-IN” by application of micro factors AGG-01 to AGG-24 817 using integration programming technology. This decoded application format then transferred to application processing.

FIG. 7ii is an explanatory diagram depicting the integration of decoded output language into operating supporting processing factors—‘application format’ performed by using language integration processing technology according to an embodiment of the present invention;

Integration processing technology chip (Integrated Chip) 101 consists of twenty nine micro chips 103 of different integration factors of the technology. These micro chips 103 have been designed with appropriate role of its function while processing the technology. ‘Integration application format chip’ 718 is one of them which performs the processing of decoded output language into application format by using internal micro factors or functions, AJ to AJ24, 818 and produces the target output language. ‘Integration application format chip’ 718 activates to start the functions of micro factors, AJ1 to AJ24, 818 to produce the output of target output natural language, which operate and control the entire processing systematically according to the protocol formation of the application processing factors. These factors 818 adjusted automatically to work either collectively or individually according to the situation. The main object of these application processing factors 818 is to achieve the solution for the given targets and commands from the operating supporting factors of the technology in order to receive the target output language. The entire process is organized and controlled by output processing format of application microchip 718 and its micro factors or functions 818.

Performance of ‘Integration application format chip’ 718 can be understood by the explanatory illustration wherein operation begins when a decoded output language processed through “AP—PROCESSING TOOLS” namely in CHINESE, is received. Output language operating supporting factors processing is performed by using micro factors AJ1 to AJ24, 818 and application format in the form “ [symbol] ” (in Chinese language) of the input natural language “HOW ARE YOU” (in English language) is produced as target output language.

FIG. 7j is an explanatory diagram depicting the integration of operating supporting factors of application from ‘decoded operating system format’ performed by using language integration programming technology according to an embodiment of the present invention.

Performance of ‘Integration programming operating system format chip’ 719 can be understood by the explanatory illustration wherein operation begins when coded format of the version “05-10-OS-IN” of the translated output natural language “ [symbol] ” (in Chinese language) transferred from Internal Micro Processor (IMP) 106 is absorbed and formed into integrated processed application format in the form “05-10-OS-IN” by application of micro factors AHH-01 to AHH-24 819 using integration programming technology. This decoded operation system format then transferred to operation system processing.

FIG. 7jj is an explanatory diagram depicting the integration of decoded output language into operating supporting processing factors—‘operating system format’ performed by using language integration processing technology according to an embodiment of the present invention;

Integration processing technology chip (Integrated Chip) 101 consists of twenty nine micro chips 103 of different integration factors of the technology. These micro chips 103 have been designed with appropriate role of its function while processing the technology. ‘Integration operating system format chip’ 720 is one of them which performs the processing of decoded output language into operating system format by using internal micro factors or functions, AK to AK24, 820 and produces the target output language. ‘Integration operating system format chip’ 720 activates to start the functions of micro factors, AK1 to AK24, 820 to produce the output of target output natural language, which operate and control the entire processing systematically according to the protocol formation of the operating system processing factors. These factors 820 adjusted automatically to work either collectively or individually according to the situation. The main object of these operating system processing factors 820 is to achieve the solution for the given targets and commands from the operating supporting factors of the technology in order to receive the target output language. The entire process is organized and controlled by output processing format of operating system microchip 720 and its micro factors or functions 820.

Performance of ‘Integration operating system format chip’ 720 can be understood by the explanatory illustration wherein operation begins when a decoded output language processed through “OS—PROCESSING TOOLS” namely in CHINESE, is received. Output language operating supporting factors processing is performed by using micro factors AK1 to AK24, 820 and application format in the form “ [symbol] ” (in Chinese language) of the input natural language “HOW ARE YOU” (in English language) is produced as target output language.

FIG. 7k is an explanatory diagram depicting the integration of operating supporting factors of application from ‘decoded search engine format’ performed by using language integration programming technology according to an embodiment of the present invention.

Performance of ‘Integration programming search engine format chip’ 721 can be understood by the explanatory illustration wherein operation begins when coded format of the version “05-11-SE-IN” of the translated output natural language “ [symbol] ” (in Chinese language) transferred from Internal Micro Processor (IMP) 106 is absorbed and formed into integrated processed application format in the form “05-11-SE-IN” by application of micro factors AII-01 to AII-24 821 using integration programming technology. This decoded search engine format then transferred to search engine processing.

FIG. 7kk is an explanatory diagram depicting the integration of decoded output language into operating supporting processing factors—‘search engine format’ performed by using language integration processing technology according to an embodiment of the present invention;

Integration processing technology chip (Integrated Chip) 101 consists of twenty nine micro chips 103 of different integration factors of the technology. These micro chips 103 have been designed with appropriate role of its function while processing the technology. ‘Integration search engine format chip’ 722 is one of them which performs the processing of decoded output language into operating system format by using internal micro factors or functions, AL to AL24, 822 and produces the target output language. ‘Integration search engine format chip’ 722 activates to start the functions of micro factors, AL1 to AL24, 822 to produce the output of target output natural language, which operate and control the entire processing systematically according to the protocol formation of the search engine processing factors. These factors 822 adjusted automatically to work either collectively or individually according to the situation. The main object of these search engine processing factors 822 is to achieve the solution for the given targets and commands from the operating supporting factors of the technology in order to receive the target output language. The entire process is organized and controlled by output processing format of search engine microchip 722 and its micro factors or functions 822.

Performance of Integration Search Engine Format Chip 722 can be understood by the explanatory illustration wherein operation begins when a decoded output language processed through “SE—PROCESSING TOOLS” namely in CHINESE, is received. Output language search engine factors processing is performed by using micro factors AL1 to AL24, 822 and application format in the form “ [symbol] ” (in Chinese language) of the input natural language “HOW ARE YOU” (in English language) is produced as target output language.

FIG. 7l is an explanatory diagram depicting the integration of operating supporting factors of application from ‘decoded colloquial language format’ performed by using language integration programming technology according to an embodiment of the present invention.

Performance of ‘Integration programming colloquial language format chip’ 723 can be understood by the explanatory illustration wherein operation begins when coded format of the version “05-12-CL-IN” of the translated output natural language “ [symbol] ” (in Chinese language) transferred from Internal Micro Processor (IMP) 106 is absorbed and formed into integrated processed application format in the form “05-12-CL-IN”by application of micro factors AJJ-01 to AJJ-24 823 using integration programming technology. This decoded colloquial language format then transferred to colloquial language processing.

FIG. 7ll is an explanatory diagram depicting the integration of decoded output language into colloquial language processing factors—‘colloquial language format’ performed by using language integration processing technology according to an embodiment of the present invention;

Integration processing technology chip (Integrated Chip) 101 consists of twenty nine micro chips 103 of different integration factors of the technology. These micro chips 103 have been designed with appropriate role of their function while processing the technology. ‘Integration colloquial language format chip’ 724 is one of them which performs the processing of decoded output language into colloquial language format by using internal micro factors or functions, AM to AM24, 824 and produces the target output language. ‘Integration colloquial language format chip’ 724 activates to start the functions of micro factors, AL1 to AL24, 824 to produce the output of target output natural language, which operate and control the entire processing systematically according to the protocol formation of the colloquial language processing factors. These factors 824 adjusted automatically to work either collectively or individually according to the situation. The main object of these colloquial language processing factors 824 is to achieve the solution for the given targets and commands from the operating supporting factors of the technology in order to receive the target output language. The entire process is organized and controlled by output processing format of colloquial language microchip 724 and its micro factors or functions 824.

Performance of ‘Integration colloquial language format chip’ 724 can be understood by the explanatory illustration wherein operation begins when a decoded output language processed through “CL—PROCESSING TOOLS” namely in CHINESE, is received. Output language colloquial language factors processing is performed by using micro factors AM1 to AM24, 824 and application format in the form “ [symbol] ” (in Chinese language) of the input natural language “HOW ARE YOU” (in English language) is produced as target output language.

FIG. 7m is an explanatory diagram depicting the integration of decoded output language into primary processing factors ‘reception format’, which is processed and programmed into ‘decoded reception language format’ performed by using language integration processing and programming technology according to an embodiment of the present invention. Primary processing factors directly influence decoded translated output language processing with proper application of respective micro factors collectively or separately according to the situation. Performance of ‘Integration reception language format chip’ 725 can be understood by the explanatory illustration wherein operation begins when a decoded output language “TR-05-PC+PR-IN” namely in Chinese, is received. Processing and programming of decoded output language primary processing factors is performed by using micro factors AOO1 to AOO24, 825 and processed reception language format of the decoded output language “TR-05-PC+PR-IN” is absorbed and formed into decoding format of the version “ [symbol] ” (in Chinese language) using integration programming technology.

FIG. 7n is an explanatory diagram depicting the integration of decoded output language into primary processing factors ‘type of chip and technology processing format’, which is processed and programmed into ‘decoded type of chip and technology processing format’ performed by using language integration processing and programming technology according to an embodiment of the present invention. Primary processing factors directly influence decoded translated output language processing with proper application of respective micro factors collectively or separately according to the situation. Performance of ‘Integration type of chip and technology processing format chip’ 726 can be understood by the explanatory illustration wherein operation begins when a decoded output language “CT-05-PC+PR-IN” namely in Chinese, is received. Processing and programming of decoded output language primary processing factors is performed by using micro factors ANN1 to ANN24, 826 and processed Type of Chip and Technology language format of the decoded output language “CT-05-PC+PR-IN” is absorbed and formed into decoding format of the version “ [symbol] ” (in Chinese language) using integration programming technology.

FIG. 7o is an explanatory diagram depicting the integration of decoded output language into primary processing factors ‘translating format’, which is processed and programmed into ‘decoded translating language format’ performed by using language integration processing and programming technology according to an embodiment of the present invention. Primary processing factors directly influence decoded translated output language processing with proper application of respective micro factors collectively or separately according to the situation. Performance of ‘Integration translating format chip’ 727 can be understood by the explanatory illustration wherein operation begins when a decoded output language “TR-05-PC+PR-IN” namely in Chinese, is received. Processing and programming of decoded output language primary processing factors is performed by using micro factors AKK1 to AKK24, 827 and processed selective language format of the decoded output language “TR-05-PC+PR-IN” is absorbed and formed into decoding format of the version “ [symbol] ” (in Chinese language) using integration programming technology.

FIG. 7p is an explanatory diagram depicting the integration of decoded output language into primary processing factors ‘voice recognition format’, which is processed and programmed into ‘decoded voice recognition format’ performed by using language integration processing and programming technology according to an embodiment of the present invention. Primary processing factors directly influence decoded translated output language processing with proper application of respective micro factors collectively or separately according to the situation. Performance of ‘Integration voice recognition format chip’ 728 can be understood by the explanatory illustration wherein operation begins when a decoded output language “VR-05-PC+PR-IN” namely in Chinese, is received. Processing and programming of decoded output language primary processing factors is performed by using micro factors AMM1 to AMM24, 828 and processed language format of the decoded output language “VR-05-PC+PR-IN” is absorbed and formed into decoding format of the version “ [symbol] ” (in Chinese language) using integration programming technology.

FIG. 7q is an explanatory diagram depicting the integration of decoded output language into primary processing factors ‘language chip processing format’, which is processed and programmed into ‘decoded language chip processing format’ performed by using language integration processing and programming technology according to an embodiment of the present invention. Primary processing factors directly influence decoded translated output language processing with proper application of respective micro factors collectively or separately according to the situation. Performance of ‘Integration language chip processing format chip’ 729 can be understood by the explanatory illustration wherein operation begins when a decoded output language “IL-05-PC+PR-IN” namely in Chinese, is received. Processing and programming of decoded output language primary processing factors is performed by using micro factors ALL1 to ALL24, 829 and processed language format of the decoded output language “IL-05-PC+PR-IN” is absorbed and formed into decoding format of the version “ [symbol] ” (in Chinese language) using integration programming technology.

FIG. 8a is an explanatory diagram of a multilingual language chip 5 configured for natural language communication with maximum of four different languages interrelated to communicate simultaneously. The natural language translation technology chip consists of twenty nine micro chips of different language factors of the technology designed with appropriate role of their functions to translate input natural language into output natural language. ‘Multilingual language format chip’ 5 falls under the category of primary processing factors of language chip format, (LLL/ALL) 225, 729 which allows the users to communicate simultaneously in four interrelated different languages. Multi lingual chip 5 can be used for conferencing or face to face discussions or meetings as illustrated in fig.

FIG. 8b is an explanatory diagram of a selective language chip 6 configured for natural language communication from one main language to any three different languages, one at a time. The natural language translation technology chip consists of twenty nine micro chips of different language factors of the technology designed with appropriate role of their functions to translate input natural language into output natural language. ‘Selective language format chip’ 6 falls under the category of primary processing factors of language chip format, (LLL/ALL) 225, 729 which allows the user to communicate from one language to any three different languages. Selective chip 6 can be used in wireless telecommunication and also facilitated to use in headphones in face to face group discussions as illustrated in fig.

FIG. 8c is an explanatory diagram of a bilingual language chip 7 configured for natural language communication between any two different languages simultaneously. The natural language translation technology chip consists of 29 micro chips of different language factors of the technology designed with appropriate role of their functions to translate input natural language into output natural language. ‘Bilingual language format chip’ 7 falls under the category of primary processing factors of language chip format, (LLL/ALL) 225, 729 which allows the users to communicate from one language to any other different languages. Bilingual chip 7 can be used in wireless telecommunication as illustrated in fig.

FIG. 8d is an explanatory diagram of a lingual language chip 8 configured for natural language communication from any one language to a chosen other language. The natural language translation technology chip consists of 29 micro chips of different language factors of the technology designed with appropriate role of their functions to translate input natural language into output natural language. ‘Lingual language format chip’ 8 falls under the category of primary processing factors of language chip format, (LLL/ALL) 225, 729 which allows the user to communicate from one language to a chosen other language. Lingual chip 8 can be used in public addressing systems to address the public as illustrated in fig.

### Speech Processing Factors

The speech processing factors contribute significantly to make this invention a unique method and system for real-time spoken language translation. The speech processing factor includes namely i) vocabulary; ii) accent; iii) pronunciation; and iv) conversation factors configured for exact module recording, voice accuracy, voice recording and voice modulation of spoken speech of a user in one language from one end to the other end in the same manner and with the same effect after translating at least one source language into at least other target language. By using the method and apparatus of the present invention, a user can communicate in any language of the world from one end in his own unique voice, accent and feelings without any distortion at the other end which get modulated into the desired translated language in the exact same manner. The speech processing factors i.e., vocabulary, accent, pronunciation and conversation translate the input source language with same human feelings, sentiments, emotions and mannerism by using natural and exact module recording, voice accuracy, voice recording and voice modulation of Internal Micro Processor. Sounds and other expressions of a user are translated and exchanged among users by the use of conversation micro functions of language disintegration and integration processing of (speech processing) chip. Thus, the present invention indeed breaks the barriers of communication and enables the common man to communicate in his native language with communities of all over the world having different languages/dialects who speak and understand different languages.

Thus, a method and apparatus for a spoken language translation system have been provided. Although, the invention has been described with reference to specific examples, it would be appreciated by those skilled in the art that the invention may be embodied in many forms without departing from the broader spirit and scope of the invention as set forth in the invention. Preferred embodiments of this invention have been described herein, including the best mode known to the inventor for carrying out the invention. Variations of those preferred embodiments may become apparent to those of ordinary skill in the art upon reading the foregoing description. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. Accordingly, the specification and drawings are to be regarded in an illustrative rather than a restrictive sense.

What is claimed is:

1. A method for performing real time automatic translation of spoken natural language, comprising:
receiving at least one speech input comprising at least one source language;
recognizing at least one source expression of the at least one source language;
translating the recognized at least one source expression from the at least one source language to at least one target language wherein translating comprising:
processing the recognized at least one source expression through disintegration processing technology chip (Integrated chip) at one end;
disintegrating the recognized at least one source expression into at least twelve encoded language factors at one end;
transferring the twelve encoded language factors to Internal Micro Processor for at least five stages internal disintegration valuation processing performed by processors of Internal Micro Processor at one end;
generating the global language disintegration format at one end;
performing source language translation to target language whereby global language disintegrated format converted into global language integrated format at other end;
transferring the global language integrated format to Internal Micro Processor for at least five stages internal integration valuation processing performed by processors of Internal Micro Processor at other end;
integrating the recognized at least one target expression into at least twelve decoded language factors at other end;
processing the twelve decoded language factors of recognized at least one target expression through integration processing technology chip (Integrated Chip) at other end;
synthesizing at least one speech output from the translated at least one target language; and
providing the at least one speech output.

2. The method for performing real time automatic translation of spoken natural language of claim 1, wherein the method of language disintegration comprising:
processing the recognized at least one source expression through embedded disintegration processing technology chip of Integrated Chip of spoken natural language disintegration processing and programming formats;
disintegrating the recognized at least one source expression into at least twelve encoded language factors by at least twenty nine microchips;
each microchip further comprising at least twenty four micro factors for spoken natural language disintegration processing and programming formats.

3. The method for performing real time automatic translation of spoken natural language of claim 1, wherein the method of language disintegration comprising:
transferring the twelve encoded language factors to Internal Micro Processor for five stages internal disintegration valuation processing:
i) disintegration devices format;
ii) coding format;
iii) naming format;
iv) inter language translation format; and
v) processor end transmission format;
by sub-tools of Internal Micro Processor.

4. The method for performing real time automatic translation of spoken natural language of claim 1, wherein the method of language disintegration comprising:
transferring the five stages processed twelve encoded language factors through Internal Micro Processor to Global Language Machine (GLM) on disintegration protocol boards and converting processed twelve encoded language factors into encoded global language disintegration format.

5. The method for performing real time automatic translation of spoken natural language of claim 1, wherein the method of language integration comprising:
receiving encoded global language disintegration format on integration protocol boards of global language machine and converting into decoded global language integration format;
transferring the decoded global language integration format to Internal Micro Processor for five stages internal integration valuation processing:
i) processor start reception format;
ii) inter language translation format;
iii) renaming format;
iv) decoding format; and
v) integration devices format;
by sub-tools of Internal Micro Processor.

6. The method for performing real time automatic translation of spoken natural language of claim 1, wherein the method of language integration comprising:
transferring the five stages processed twelve encoded language factors to embedded integration processing technology chip of Integrated Chip of spoken natural language integration programming and processing formats;
integrating the recognized at least one target expression into at least twelve decoded language factors by at least twenty nine microchips;
each microchip further comprising at least twenty four micro factors for spoken natural language integration programming and processing formats;
synthesizing at least one speech output from the translated at least one target language; and
providing the at least one speech output.

7. The method of claim 1, wherein the twelve language factors comprising: speech processing factors including i) vocabulary; ii) accent; iii) pronunciation; and iv) conversation factors configured for exact module recording, voice accuracy, voice recording and voice modulation of spoken speech of a user in one language from one end to the other end in the same manner and with the same effect after translating at least one source language into at least other target language.

8. The method of claim 1, further comprising minimizing distortion of the recognized at least one source expression, wherein the distortion results from factors selected from a group comprising noise and speaker variation.

9. An apparatus for performing real time automatic translation of spoken natural language, comprising:
at least one Integrated Chip and an Internal Micro Processor;
an input coupled to the at least one Integrated Chip, the input capable of receiving speech signal comprising at least one source language, the at least one chip configured to translate the received speech signals by,
recognizing at least one source expression of the at least one source language;
processing the recognized at least one source expression through disintegration processing technology chip (Integrated Chip) at one end;
disintegrating the recognized at least one source expression into at least twelve encoded language factors at one end;
transferring the twelve encoded language factors to Internal Micro Processor for at least five stages internal disintegration valuation processing performed by processors of Internal Micro Processor at one end;
generating the global language disintegration format at one end;
performing source language translation to target language whereby global language disintegrated format converted into global language integrated format at other end;
transferring the global language integrated format to Internal Micro Processor for at least five stages internal integration valuation processing performed by processors of Internal Micro Processor at other end;
integrating the recognized at least one target expression into at least twelve decoded language factors at other end;
processing the twelve decoded language factors of recognized at least one target expression through integration processing technology chip (Integrated Chip) at other end;
synthesizing at least one speech output from the translated at least one target language; and
an output coupled to the at least one Integrated Chip, the output capable of providing the synthesized at least one speech output.

10. The apparatus of claim 9, wherein the Integrated Chip comprising embedded chips of spoken natural language disintegration and integration processing and programming formats.

11. The apparatus of claim 10, wherein each embedded chip comprising at least twenty nine microchips;
each microchip further comprising at least twenty four micro factors for spoken natural language disintegration and integration processing and programming formats.

12. The apparatus of claim 11, wherein twenty nine micro chips comprising speech processing factors including i) vocabulary; ii) accent; iii) pronunciation; and iv) conversation factors configured for exact module recording, voice accuracy, voice recording and voice modulation of spoken speech.

13. The apparatus of claim 9, wherein the twelve language factors transferred to Internal Micro Processor for at least five stages spoken natural language disintegration and integration valuation processing performed by processors of Internal Micro Processor.
